(19) United States
(12) Patent Application Publication
(10) Pub. No.: US 2009/0269103 A1
(43) Pub. Date: Oct. 29, 2009

(54) Photoreceptor, process cartridge and image forming apparatus

(75) Inventors: Yoshinori Inaba, Numazu-shi (JP); Hiroshi Ikuno, Yokoahama-shi (JP)

Correspondence Address: COOPER & DUNHAM, LLP, 30 Rockefeller Plaza, 20th Floor, NEW YORK, NY, 10112, US

(73) Assignee: Ricoh Company, Ltd.

(21) Appl. No.: 12/381,990

(22) Filed: Mar. 17, 2009

(30) Foreign Application Priority Data
Mar. 17, 2008 (JP) 2008-067930

(51) Int. Cl. G03G 15/00; G03G 5/04; G03G 21/16

(52) U.S. Cl. 399/159; 430/60; 430/64; 399/111

(57) ABSTRACT

A photoreceptor including an electroconductive substrate, an undercoating layer provided overlying the electroconductive substrate that includes a compound comprising an epoxy group and a straight chain alkyl skeleton, a cross-linked resin, and a hydrophilic particulate; and a photosensitive layer provided overlying the undercoating layer.

### BACKGROUND OF THE INVENTION

1. Field of the Invention

The present invention relates to a photoreceptor, a process cartridge and an image forming apparatus.

2. Discussion of the Background

A photoreceptor having a cylindrical substrate on which a photosensitive layer (organic photosensitive layer) using organic material as photoconductive material (charge generation material and/or charge transport material) is widely diffused in terms of low cost and high productivity as the photoreceptor for electrophotography. This photoreceptor is referred to as organic photoreceptor. An organic photoreceptor of a laminar photosensitive layer type in which a charge transport layer having a charge transport material such as a photoconductive polymer and a photoconductive compound having a low molecular weight is provided on a charge generation layer having a charge generation material such as a photoconductive dye and a photoconductive pigment is dominant among the organic photoreceptors.

An electric force and/or a mechanical force such as charging (primary charging), irradiation (image irradiation), development by toner, transfer to a transfer material such as paper and removing residual toner are directly applied to the surface of a photoreceptor. Therefore, the photoreceptor is required to have a sensitivity, electric characteristics, optical characteristics, mechanical characteristics and obtain image quality without image deficiency according to applied electrophotographic processes.

Typical image deficiencies are image streaks, black spots on white background, white spots on black characters and background fouling on white background. For example, when a digital photocopier and a laser beam printer using a laser diode as the light source performs irradiation, interference stripes (moire) may occur due to the surface form of the substrate or uneven layer thickness of the photoreceptor.

An undercoating layer (the bottom layer of a photoreceptor, that is, a layer between the electroconductive substrate and the charge generation layer) is provided as a method for preventing the image deficiency described above. Such an undercoating layer is required to have an electric blocking function to prevent charge infusion from an electroconductive substrate when a voltage is applied to a photoreceptor. Charge infusion from the electroconductive substrate causes deterioration of the charging power or image contrast, black spots on white background, and background fouling in the case of a reverse development system, which significantly degrades image quality.

On the other hand, when the electric resistance of the undercoating layer is too high, the charge generated in the photosensitive layer accumulates inside thereof. This causes a rise of the residual voltage and voltage fluctuation during repetitive use. Therefore, the electric resistance value of the undercoating layer is desired to be reduced in some degree in addition to the blocking function and the blocking function and the electric characteristics should not vary excessively.

As a technology to reduce the occurrence of background fouling of an organic photoreceptor, unexamined published Japanese patent application No. (hereinafter referred to as JOP) 2005-92216 describes a photoreceptor having a cured layer using metal alkoxide, aminoalkyl silane, or aminoalkoxy silane as an additive as a positive hole barrier layer or an undercoating layer.

U.S. Pat. No. 6,015,645 describes a photoreceptor having a cured layer using polyhalo alkylstyrene as an additive as a positive hole barrier layer.

JOP H08-220790 and U.S. Pat. No. 5,789,127 describe a photoreceptor using a cured layer formed by curing-polymerizing a polymer having an alkoxysilyl group, a combination of the polymer and an organic metal compound, or a combination of the polymer, an organic metal compound and a silane coupling agent by thermal energy as an undercoating layer.

In addition, JOP 2006-71665 and 2005-91981 describe a photoreceptor using a cured layer using a polyalkylene glycol or its derivative as an additive as an undercoating layer.

JOPs 2005-37480, JOP 2005-37583 and 2005-181678 describe a photoreceptor using a cured layer formed by curing-polymerizing an inorganic oxide forming a network structure, an organic compound forming a network structure which contains a metal atom and a binder network compound by thermal energy as an undercoating layer.

JOP 2006-47840 describes a technology to improve the effect of reducing the occurrence of the background fouling of a photoreceptor by causing the undercoating layer to contain ionic liquid.

In addition, JOPs S46-47344 and S52-100240 describe an undercoating layer formed of an organic polymer and JOPs S54-151843 and H01-118848 describe an undercoating layer in which a metal oxide or a metal nitride is dispersed in an organic polymer as the undercoating layer having an electric blocking function and suitable electric characteristics.

Furthermore, JOPs H05-27469, H09-319128, 2000-321805, H04-353858 and 2004-307809 describe a technology of causing an undercoating layer to contain a charge transport material.

As a technology of reducing the occurrence of background fouling, black spots, etc., JOP H08-262776 describes a photoreceptor which uses a cured layer using an additive such as an organic metal compound, a coupling agent or its reaction product as an undercoating layer.

In recent years, imparting electric blocking function and suitable electric characteristics to an undercoating layer has been established as a technology of improving the effect of reducing the occurrence of background fouling of an organic photoreceptor

However, development of the electrophotographic technology today is notable and a high level technology is demanded to satisfy the characteristics required for a photoreceptor. For example, the process speed increases year by year and accordingly improvement on the charging characteristics, sensitivity and stable durability is required. In particular, improvement on image quality especially related to colorization is demanded. This is because half tone images and solid images, e.g., photographs, are printed in color while monochrome images are mostly for letters and characters. In particular, improvement on image quality with regard to the density variance of a half tone image and a solid image during continuous and repetitive use are demanded more and more. Therefore, a technology to reduce such variance of image quality is desired.

With recent improvement on image quality and durability, improving electric characteristics and solving problems about background fouling etc. have been highly demanded in addition to the electric blocking function to provide an excellent photoreceptor. The technologies and the photoreceptors described in JOPs and U.S. patents mentioned above have merits of maintaining the electric blocking function but are not capable of sufficiently reducing a rise in the voltage at a light portion in some cases. Therefore, for example, developing a technology having a good combination of the electric blocking function and reduction in a rise of the voltage of a light portion is an imminent issue.

In addition, there is a technology using an oil soluble surface active agent having a hydrophilic group and an oleophilic group to disperse particulates in an undercoating layer.

However, such an oleophilic surface active agent does not have a portion in its molecule which contributes to a bonding to a binder resin, which creates a problem that the oleophilic surface active agent is melted into a liquid application for a layer provided above the undercoating layer when applying the liquid application to the surface of the undercoating layer. Thus, adding this oleophilic surface active agent is not suitable to maintain the electric blocking function or prevent deterioration of the electric characteristics and occurrence of background fouling.

Furthermore, JOP 2003-149849 describes a technology to improve dispersion stability of a particulate (filler) by adding a moistening dispersion agent having a hydrophilic group to a protective layer. However, this is to cause the moistening dispersion agent to attach to a polar group on the surface of the particulate functioning as a charge trap site and thus is basically different from the present invention in which a functional group of a cross-linked resin and the epoxy group of a compound having an epoxy group and an alkyl skeleton are bonded by moisture suitably contained in the resin to fix hydrophilic particulates in the cross-linked resin in a state in which the hydrophilic particulates are highly dispersed.

### SUMMARY OF THE INVENTION

Because of these reasons, the present inventors recognize that a need exists for a photoreceptor to which problems related to the electric characteristics and background fouling hardly occur and a process cartridge and an image forming apparatus using the photoreceptor.

Accordingly, an object of the present invention is to provide a photoreceptor to which problems related to the electric characteristics and background fouling hardly occur and a process cartridge and an image forming apparatus using the photoreceptor.

Briefly this object and other objects of the present invention as hereinafter described will become more readily apparent and can be attained, either individually or in combination thereof, by a photoreceptor including an electroconductive substrate, an undercoating layer provided overlying the electroconductive substrate that includes a compound having an epoxy group and a straight chain alkyl skeleton, a cross-linked resin, and a hydrophilic particulate, and a photosensitive layer provided overlying the undercoating layer.

It is preferred that, in the photoreceptor mentioned above, the compound comprising an epoxy group and a straight chain alkyl skeleton is represented by the following Chemical structure 1:

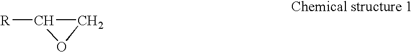

wherein R represents a straight chain alkyl skeleton.

It is still further preferred that, in the photoreceptor mentioned above, R in the Chemical structure 1 has 6 to 15 carbon atoms.

It is still further preferred that, in the photoreceptor mentioned above, the cross-linked resin is formed by curing at least one of a water soluble resin, an alcohol soluble resin and a curable resin capable of forming a three dimensional network structure.

It is still further preferred that, in the photoreceptor mentioned above, the curable resin capable of forming a three dimensional network structure is at least one of an alkyd resin and a melamine resin.

It is still further preferred that, in the photoreceptor mentioned above, the hydrophilic particulate is a first inorganic particulate.

It is still further preferred that, in the photoreceptor mentioned above, the first inorganic particulate is at least one compound selected from the group consisting of zinc oxide, tin oxide and titanium oxide.

It is still further preferred that, in the photoreceptor mentioned above, a charge blocking layer is provided between the electroconductive substrate and the undercoating layer.

It is still further preferred that, in the photoreceptor mentioned above, the charge blocking layer includes N-alkoxymethylated nylon.

It is still further preferred that, in the photoreceptor mentioned above, a protective layer is provided on the photosensitive layer.

It is still further preferred that, in the photoreceptor mentioned above, the protective layer comprises a second inorganic particulate.

It is still further preferred that, in the photoreceptor mentioned above, the second inorganic particulate is at least one compound selected from the group consisting of aluminum oxide, silicon oxide, and titanium oxide.

It is still further preferred that, in the photoreceptor mentioned above, the protective layer is a cross-linked protective layer formed by curing a radical polymerizable monomer having three or more functional groups with no charge transport structure and a radical polymerizable compound having a charge transport structure.

It is still further preferred that, in the photoreceptor mentioned above, the radical polymerizable monomer having three or more functional groups with no charge transport structure has at least one of an acryloyloxy group and a methacryloyloxy group.

It is still further preferred that, in the photoreceptor mentioned above, the radical polymerizable compound having a charge transport structure has an acryloyloxy group or a methacryloyloxy group.

It is still further preferred that, in the photoreceptor mentioned above, the radical polymerizable compound having a charge transport-structure has a triarylamine structure.

It is still further preferred that, in the photoreceptor mentioned above, the radical polymerizable compound having a charge transport structure comprises a compound represented by the following Chemical structure 2 or a compound represented by the following Chemical structure 3:

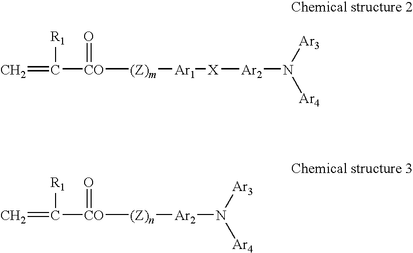

where R₁ represents hydrogen atom, a halogen atom, an alkyl group, an aralkyl group, an aryl group, a cyano group, a nitro group, an alkoxy group, —COOR₇, wherein R₇ represents hydrogen atom, a substituted or non-substituted alkyl group, a substituted or non-substituted aralkyl group or a substituted or non-substituted aryl group, a halogenated carbonyl group or CONR₈R₉, wherein R₈ and R₉ independently represent hydrogen atom, a halogen atom, a substituted or non-substituted alkyl group, a substituted or non-substituted aralkyl group or a substituted or non-substituted aryl group, Ar₁ and Ar₂ independently represent a substituted or non-substituted arylene group, Ar₃ and Ar₄ independently represent a substituted or non-substituted aryl group, X represents a single bond or a substituted or non-substituted alkylene group, a substituted or non-substituted cycloalkylene group, a substituted or non-substituted alkylene ether group, oxygen atom, sulfur atom or vinylene group, Z represents a substituted or non-substituted alkylene group, a substituted or non-substituted alkylene ether divalent group or an alkyleneoxy carbonyl divalent group, and m and n represent 0 or an integer of from 1 to 3.

It is still further preferred that, in the photoreceptor mentioned above, the radical polymerizable compound having a charge transport structure comprises a compound represented by the following structure 4:

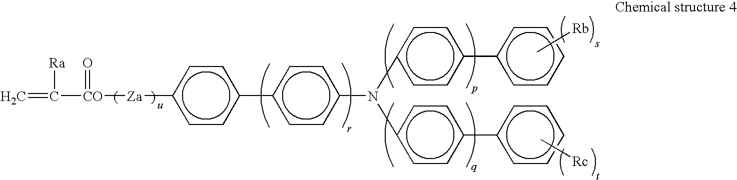

wherein, u, r, p, q independently represent 0 or 1, s and t independently represent 0 or an integer of from 1 to 3, Ra represents hydrogen atom or methyl group, each of Rb and Rc independently represents an alkyl group having 1 to 6 carbon atoms, and Za represents methylene group, ethylene group, —CH₂CH₂O—, —CHCH₃CH₂O—, or —C₆H₅CH₂CH₂

As another aspect of the present invention, an image forming apparatus is provided which includes the photoreceptor mentioned above, a charging device that charges the photoreceptor, an irradiation device that irradiates the photoreceptor with light to form a latent electrostatic image thereon, a developing device that develops the latent electrostatic image with a developing agent to form a developed image, and a transferring device that transfers the developed image to a recording medium.

As another aspect of the present invention, a process cartridge is provided which includes the photoreceptor mentioned above, and at least one device selected from the group consisting of a charging device, an irradiation device, a developing device, a cleaning device and a transfer device.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a cross section of an example of the photoreceptor of the present invention;

FIG. 2 is a diagram illustrating a cross section of another example of the photoreceptor of the present invention;

FIG. 3 is a diagram illustrating a cross section of another example of the photoreceptor of the present invention;

FIG. 4 is a diagram illustrating a cross section of another example of the photoreceptor of the present invention;

FIG. 5 is a diagram illustrating a cross section of another example of the photoreceptor of the present invention;

FIG. 6 is a diagram illustrating a cross section of another example of the photoreceptor of the present invention;

FIG. 7 is a diagram illustrating a cross section of an example of the image forming apparatus of the present invention;

FIG. 8 is a diagram illustrating a cross section of an example of the process cartridge of the present invention;

FIG. 9 is a diagram illustrating an X-ray diffraction spectrum of a titanylphthalocyanine; and

FIG. 10 is a diagram illustrating a model chart in the dispersion state in the present invention.

### DETAILED DESCRIPTION OF THE INVENTION

The present invention will be described below in detail with reference to several embodiments and accompanying drawings.

The mechanism of the present invention for achieving its objective is not clear but the present inventors infer the reasons as follows

The physical properties such as the charge transport property of particulates contained in an undercoating layer are controlled by particle diameter of the particulates and the distance between the particulates. In particular, designing and building up a fine structure freely is an extremely significant issue for an organic compound or inorganic compound having a fine structure in the magnitude of 10⁻¹ micron.

Structuring particulates is a chemical approach to satisfy these demands. Mutual action at the interface between particles and a substrate or the interface between particles is used for particulate structuring. If an organic ligand having different lengths with a functional group having a high hydrophilic property with the surface of particulates and a functional group capable of causing mutual action between ligands at both ends is imparted to particulates as (moistening) dispersion agent, highly structured particulates can be obtained using this mutual action between ligands.

For example, when a simple alkane compound is used as a compound to disperse hydrophilic particulates, such a simple alkane compound does not react with a cross-linked resin (binder resin: a basic resin and a cross-linking agent) contained in an undercoating layer because the simple alkane compound does not have reactive functional groups such as epoxy group. Therefore, the compound remains in the undercoating layer so that when a liquid application for a layer provided on the undercoating layer is applied thereto, the compound moves to the layer provided on the undercoating layer, which invites deterioration of the sensitivity and a rise in the residual voltage. Therefore, a simple alkane compound is not suitable as a compound to disperse hydrophilic particulates.

By contrast, in the case of the photoreceptor of the present invention, the distance between particulates can be controlled by imparting a compound having an epoxy group and a straight chain alkyl group to the surface of particulates as a compound to disperse hydrophilic particulates to change the length of the alkyl chain of the compound as the (moistening) dispersion agent. In addition, once an undercoating layer is formed, the compound is sufficiently sustained in the undercoating layer by (bonding with) the cross-linked resin. Therefore, the particulates are evenly dispersed in the cross-linked resin according to the length of the alkyl chain.

As a result, an undercoating layer having a fine structure in which particulates are highly dispersed in three dimensions is formed. This is effective to prevent leak of infusion of charges from the electroconductive substrate to the undercoating layer and reduce the number of charge traps existing in the charge conduction path, which leads to uniform layer formation. This is inferred to be the mechanism of preventing image quality deterioration caused by leak of charge and the rise in the residual voltage occurring during repetitive use.

That is, particulates are highly dispersed in three dimensions so that a rise in the voltage in a light portion is prevented and infusion of charges from the substrate does not occur. Consequently, the electric blocking function is improved so that a highly good combination of the electric blocking function and the electric characteristics are obtained.

The hydrophilic particulates in the undercoating layer for use in the present invention are thought to be fixed in the following way.

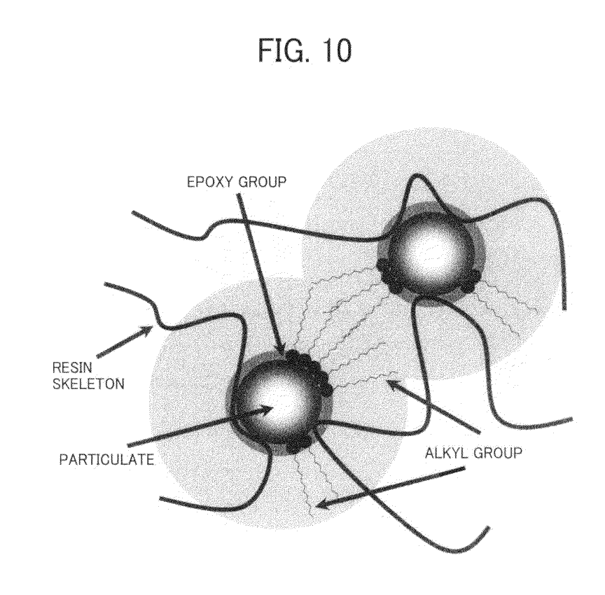

Particulates that are existent in a polymer have a significant impact not only on the direct interface but also on the characteristics of the polymer around the particulates. The affected polymer layer is referred to an interface intermediate layer. An intermediate layer model of the present invention is illustrated in FIG. 10. In the intermediate layer, the binder resin is attached to the surface of particulates and bound by the particulates so that the binder resin behaves differently from a typical binder resin. Agglomeration of particulates due to polymer cross-linking is caused by non-ion polymers or ion polymers. In both cases, the polymers and the surface of the particulates have strong affinity. Agglomeration occurs when the surface of the particulates is not saturatedly absorbed by the polymer. When one polymer is absorbed to the surface of two particulates, agglomeration occurs so that the probability of the agglomeration is in proportion to the product of the cover ratio of the absorption site by the polymer and the uncover ratio of the absorption site of the particulates matching the polymer. Furthermore, when a compound having an epoxy group and a straight chain alkyl skeleton is added to this system, the epoxy group of the compound having an epoxy group and a straight chain alkyl skeleton faces toward the particulate side and, the alkyl group, the solution side, at the uncovered portion at the absorption site when the surface of the particulate is hydrophilic. Therefore, the solvent affinity of the surface of the particulate increases, resulting in dispersion of the particulates. Particulates stabilized by an amphiphilic material such as the compound having an epoxy group and a straight chain alkyl skeleton is relatively stable due to the steric hindrance of the absorption layer in comparison with particulates stabilized by only charges.

In the present invention, an undercoating layer is formed by applying a liquid application containing a compound having at least an epoxy group and a straight chain alkyl skeleton, a cross-linked resin, and hydrophilic particulates to the electroconductive substrate which structures a photoreceptor. The photoreceptor of the present invention having the undercoating layer is described below.

The undercoating layer is a layer having a function of preventing the occurrence of a moiré image (interference stripes) caused by optical interference in the photosensitive layer when writing with a coherent beam such as a laser beam.

Basically, the undercoating layer has a function of causing optical scatter of the writing light. To demonstrate such a function, causing the undercoating layer to contain material having a large refraction index is effective. The undercoating layer has an organic particulate (P1) and a cross-linked resin (binder resin: basic resin and cross-linking agent) and a structure in which the organic particulate (P1) are dispersed in the cross-linked resin and is different from a charge blocking layer having no moiré prevention function.

The compound having an epoxy group and a straight chain alkyl skeleton has a portion by which the compound is strongly absorbed to the surface of the particulate, a portion by which the compound is bonded with the cross-linked resin and a solvent affinity portion having an affinity to a solvent. Therefore, this compound prevents attraction (agglomeration) between particulates.

A compound having a structure of epoxy group (an organic functional group having affinity) as the portion contributing to the absorption to the hydrophilic particulate and the bonding with the binder resin is used as the compound having an epoxy group and a straight chain alkyl skeleton.

That is, the epoxy group is strongly absorbed to the surface of the hydrophilic particulate due to the action such as physical absorption with the hydrophilic group such as hydroxy group present on the surface of the hydrophilic particulate and firmly combined with the cross-linked resin due to the action such as ring scission polymerization with a functional group of the binder resin by heating.

In addition, the solvent affinity portion is preferred to be hardly absorbed by the hydrophilic particulate, dissolved in a dispersion solvent and have a compatibility with the resin. In the present invention, a solvent affinity portion having a structure of a straight chain alkyl skeleton is used.

As describe above, the compound for use in dispersing the hydrophilic particulate is required to have an epoxy resin. The epoxy group has high reactivity with a functional group having an active hydrogen such as an amino group, carboxyl group, and hydroxy group. For example, when an alkyd resin having an amino group is used as the binder resin (basic resin) for an undercoating layer and a melamine resin having an amino group is used as the cross-linking agent for the undercoating layer, the epoxy group easily reacts particularly with the hydroxy group of the alkyd resin and the amino group of the melamine resin in the drying process of the liquid application for the undercoating layer by heating. Therefore, the compound having the group can be fixed in the undercoating layer and in addition the photoreceptor is effectively obtained.

A preferable compound having an epoxy group and a straight chain alkyl skeleton is represented by the following Chemical structure (1):

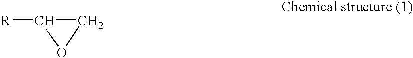

In the Chemical structure (1), R is preferably a straight chain alkyl skeleton having 6 to 15 carbon atoms and more preferably 8 to 14 carbon atoms.

Specific examples thereof include, but are not limited to, 1,2-epoxy hexane, 1,2-epoxy heptane, 1,2-epoxy octane, 1,2-epoxy nonane, 1,2-epoxy decane, 1,2-epoxy undecane, 1,2-epoxy dodecane, 1,2-epoxy tridecane, 1,2-epoxy tetradecane, and 1,2-epoxy pentadecane.

When the straight chain alkyl skeleton has at least 6 carbon atoms, the steric hindrance effect due to an oleophilic group (hydrocarbon chain) is great, which improves prevention effect of particulate agglomeration. When the straight chain alkyl skeleton has 15 carbon atoms or less, the hydrophobic mutual action between the oleophilic groups has a less impact than the absorption action by the hydrophilic group. As a result, the dispersion state of the hydrophilic particulate in the undercoating layer is stably maintained, which leads to improvement on the prevention effect for background fouling. These compounds can be used alone or in combination.

The content of the compound having an epoxy group and a straight chain alkyl skeleton contained in the undercoating layer for use in the present invention is from 0.01 to 50 parts by weight and preferably from 0.1 to 10 parts by weight based on 100 parts of the hydrophilic particulate. When the content of the compound having an epoxy group and a straight chain alkyl skeleton is too small, the surface of the hydrophilic particulate is not covered entirely. Therefore, agglomeration of the hydrophilic particulate tends to occur and thus the dispersion effect of the compound having an epoxy group and a straight chain alkyl skeleton for the hydrophilic compound is reduced. On the other hand, when the content of the compound having an epoxy group and a straight chain alkyl skeleton is too large, the residual voltage tends to rise.

Inorganic particulates and surface treated organic particulates can be used as the hydrophilic particulate contained in the undercoating layer.

The inorganic particulate has a relatively large refractive index. Therefore, the inorganic particulate is preferable to effectively prevent moiré from occurring when writing images with an interfering light beam such as a laser beam.

The surface of the hydrophilic particulate for use in the undercoating layer is hydrophilic and the compound having an epoxy group and a straight chain alkyl skeleton is absorbed to the surface. The first inorganic particulate is preferred as the hydrophilic particulates.

In addition, the undercoating layer is desired to obtain a suitable resistance to obtain anti-leak property.

When the inorganic particulate is contained in the undercoating layer, the volume resistance and the environment dependability of the undercoating layer is easily and surely controlled, which is preferable to improve both ant-leak property and electric characteristics.

Therefore, background fouling can be effectively prevented when using a thickened charge transport layer.

The charge transferring in the undercoating layer is mainly electron. Therefore, the first inorganic particulate is preferably an N type semiconductor particulate.

The undercoating layer containing an insulative binder resin containing an N type semiconductor particulate efficiently blocks the infusion of the positive holes from the electroconductive substrate and has a transportability for electrons from the photosensitive layer.

As a result, the rectifying property of the undercoating layer is improved so that occurrence of black spots and background fouling are prevented and the development property is improved. Thus, a clear and vivid image with fine gradation can be obtained.

The inorganic particulate preferably has a specific resistance of from 10⁷ to 10¹³Ω·cm. A specific resistance that is excessively large tends to cause the voltage at a light portion to rise while the prevention effect for the background increases. A specific resistance that is excessively small tends to decrease the prevention effect for the background.

Specific examples of the first inorganic particulate include, but are not limited to, zinc oxide, flake white, aluminum oxide, indium oxide, silicon oxide, zirconium oxide, tin oxide, titanium oxide, magnesium oxide, antimony oxide, bismuth oxide, indium oxide with which tin is doped, and tin with which antimony and/or tantalum are doped. Among these, zinc oxide, tin oxide and titanium oxide are preferably used.

Titanium oxide is especially preferable in terms of improving the sensitivity of a photoreceptor because titanium oxide hardly absorbs optical light and near infra red so that titanium oxide is white. In addition, titanium oxide has a relatively large refractive index so that titanium oxide can effectively prevent the production of abnormal images having an interfering stripe occurring when writing images with an interfering light beam such as a laser beam, which is preferable in terms of hiding power.

The inorganic particulate specified above can be used alone or in combination.

Titanium oxide has crystal type of rutile type, anatase type, bulkite type and any type of these can be used. Also, titanium oxide having needle crystal or particle crystal can be singly used or mixed. In the present invention, titanium oxide of rutile type is particularly preferred.

The primary average particle diameter of the first inorganic particulate contained in the undercoating layer is preferably from 0.05 to 1 μm and more preferably from 0.1 to 0.5 μm. When the primary average particle diameter of the first inorganic particulate is excessively outside this range, the dispersion property thereof to a binder resin easily decreases, which makes it difficult to have a good combination of anti-leak property and electric characteristics.

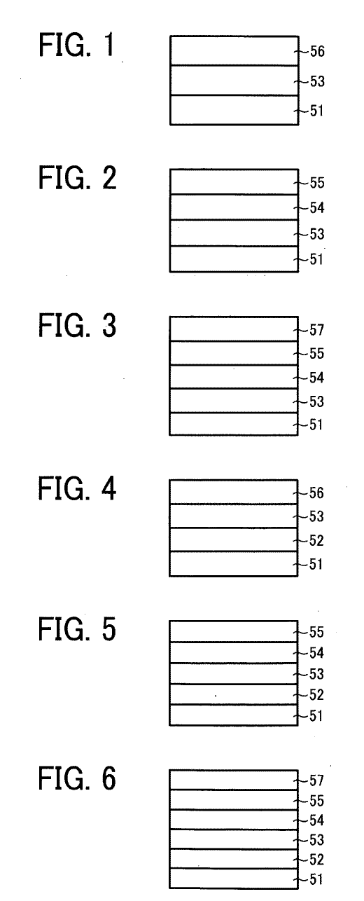

In addition, as apparent from FIGS. 1 to 6, the undercoating layer for use in the present invention preferably has at least a function of transferring charges having the same polarity as that of the charge on a photoreceptor in terms of prevention of a rise of the residual voltage. Therefore, when a negatively charged photoreceptor is used, imparting electron conductivity to the undercoating layer is preferable and thus using particulates having electron conductivity or electroconductivity is preferred. Also, the effect of the present invention is all the more significant by using material having electron conductivity (e.g., acceptor) in the undercoating layer.

The cross-linked resin for use in the undercoating layer is required not to melt or dissolve in a liquid application for a photosensitive layer considering that the photosensitive layer is provided on the undercoating layer.

The cross-linked resin preferably has a group having an active hydrogen such as hydroxy group, carboxyl group and an amino group. Specific examples of such resins include, but are not limited to, water-soluble resins such as polyvinyl alcohol and casein, alcohol-soluble resins such as copolymerized nylon, and curable resins forming such as melamine resins, phenol resins and alkyd-melamine resins which form a three-dimensional network structure.

Among these, alkyd resins are preferred because alkyd resin can impart an excellent anti-solvent property by using alone or in combination with a cross-liking agent and is hardly dependent on the resistance against the environment change.

In addition, since amino group has a relatively high reactivity (cross-linking property) to epoxy group in comparison with hydroxy group or carboxyl group, an alkyd resin having a hydroxy group or a carboxyl group can be singly used but is more preferably used in combination with, for example, a melamine resin having an amino group. The mixing ratio of the alkyd resin to the melamine resin has an impact on determining the structure and characteristics of the undercoating layer and is preferably from 5/5 to 8/2 by weight. When the melamine resin is too rich, the volume contraction tend to be significant during heat curing, which causes deficiency in layer formation or increases the residual voltage of a photoreceptor, which is not preferred. When the alkyd resin is too rich, the bulk resistance tends to be excessively low, which worsens background fouling, although the residual voltage is reduced. When a curable resin is used as the binder resin for use in the undercoating layer, the binder material contained in the liquid application for the undercoating layer is a monomer and/or an oligomer of the curable resin.

The undercoating layer optionally contains a cross-linking agent. The function group in an alkyd resin and the functional group in a cross-linking agent are chemically bonded to harden the resin, which improves layer formation property and adherence with the electroconductive substrate and the photosensitivity.

Specific examples of such cross-linking agents include, but are not limited to, blocked isocyanate compounds, melamine resins, and epoxy compounds. The functional groups for use in cross-linking are preferably used in just proportion. Among these, melamine resins are most suitable in terms of layer application performance (adherence, corrosion resistances, chemical resistance).

In the undercoating layer, the weight ratio of the metal oxide mentioned above and the cross-linking agent has an impact on determination of factors. Therefore, the weight ratio of the metal oxide and the cross-linking agent is preferably from 3/1 to 8/1. Although it depends on the volume weight ratio of the metal oxide, when the weight ratio of the metal oxide is too small, the transportability of the undercoating layer tends to deteriorate and the residual voltage easily increases during repetitive use, which leads to deterioration of optical response in some cases. When the weight ratio of the metal oxide is too small, the void in the undercoating layer tends to increase, which may result in occurrence of air bubble when a photosensitive layer is applied to the undercoating layer.

In addition, when the weight ratio of the metal oxide is too large, the binding power of the cross-linked resin tends to be inferior and the surface property deteriorates, which has an adverse impact on the layer formation property of a photosensitive layer provided on the undercoating layer. This impact may lead to a severe problem when a photosensitive layer is of a laminar type including a thin layer such as a charge generation layer. Furthermore, when the weight ratio of the metal oxide is too large, the binder resin may not be able to cover the entire surface of the inorganic particulate so that the inorganic particulate is brought into direct contact with a charge generation material, which increases the probability of generation of heat carriers. This has an adverse impact for background fouling.

In addition, the layer thickness of the undercoating layer is from 1 to 10 μm and preferably from 2 to 5 μm. A layer thickness that is too thin tends to reduce the effect of the undercoating layer. A layer thickness that is too thin tends to cause the residual voltage to accumulate, which is not preferable.

Wet application methods are employed to manufacture the undercoating layer and typical methods thereof are: blade application, dip (immersion) coating, spray coating, ring coating and beat coating.

Specific examples of solvents for use in liquid application for the undercoating layer include, but are not limited to, isopropanol, acetone, methylethyl ketone, cyclohexanone, tetrahydrofuran, dioxane, ethylcellosolve, ethyl acetate, methyl acetate, dichloromethane, dichloroethane, monochlorobenzene, cyclohexane, toluene, xylene, and ligroin. When a charge blocking layer is provided under the undercoating layer, a solvent that does not corrode the charge blocking layer is used.

The first inorganic particulate, the cross-linked resin, and solvent specified above are dispersed in a binder resin by a disperser of pulverization type using dispersion media such as a ball mill, vertical sand mill, horizontal sand mill, and paint conditioner, and also can be dispersed by an ultrasonic dispersion method, a roll mill, or an impact mill which are free from using dispersion media.

The ratio specified above is optimal with regard to the ratio of the hydrophilic particulate to the cross-liking resin (binder resin: basic resin and cross-linking agent) and in addition, the density of the solid portion based on the entire amount of the liquid application during dispersion is 50% by weight or less. The reason of this is not clear but it is inferred as follows: when the amount of the hydrophilic particulate and the cross-linked resin increases as a whole, the ratio of the primary particles increases in the hydrophilic particulate so that the solution state of the cross-linked resin is close to the saturation state about the solubility to the solvent; this easily causes re-crystallization of the cross-linked resin or re-agglomeration of primary particles thereof due to the condition of the pressure and the temperature; and therefore, the dispersion stability of the liquid application for the undercoating layer deteriorates and/or a large amount of non-dispersion material is created immediately after dispersion.

Adjusted liquid application is applied to the electroconductive substrate followed by drying to form the undercoating layer.

The layer structure of the photoreceptor of the present invention is described below in detail.

### Layer Structure of Photoreceptor

The photoreceptor of the present invention is described in detail with reference to drawings.

FIG. 1 is a diagram illustrating a cross section of a structure example of the photoreceptor in which an undercoating layer 53, and a photosensitive layer 56 are accumulated on an electroconductive substrate in this sequence. The photosensitive layer 56 has a structure illustrated in FIG. 2 which includes a charge generation layer 54 and a charge transport layer 55. In addition, a protective layer 57 is optionally provided on the photosensitive layer 56 as illustrated in FIG. 3.

Also, as illustrated in FIG. 4, a charge blocking layer 52 is optionally provided between the electroconductive substrate 51 and the undercoating layer 53.

FIG. 5 is a diagram illustrating a cross section of another structure example of the photoreceptor of the present invention. As in the examples specified above, the charge blocking layer 52, the undercoating layer 53, the charge generation layer 54, and the charge transport layer 55 are sequentially accumulated on the electroconductive substrate 51.

FIG. 6 is a diagram illustrating a cross section of another structure example of the photoreceptor of the present invention. As in the examples specified above, the charge blocking layer 52, the undercoating layer 53, the charge generation layer 54, the charge transport layer 55 and the protective layer 57 are sequentially accumulated on the electroconductive substrate 51.

Among the structures illustrated in FIG. 1 to FIG. 6, the photoreceptors having the structures of FIG. 3 to FIG. 6 are preferably used.

### Electroconductive Substrate

Materials having a volume resistance of not greater than 10¹⁰Ω·cm can be used as a material for the electroconductive substrate. For example, there can be used plastic or paper having a film form or cylindrical form covered with a metal such as aluminum, nickel, chrome, nichrome, copper, gold, silver, and platinum, or a metal oxide such as tin oxide and indium oxide by depositing or sputtering. Also a board formed of aluminum, an aluminum alloy, nickel, and a stainless metal can be used. Further, a tube which is manufactured from the board mentioned above by a crafting technique such as extruding and extracting and surface-treatment such as cutting, super finishing and grinding is also usable. In addition, endless nickel belt and endless stainless belt (for example, described in JOP S52-36016) can be used as the electroconductive substrate. The electroconductive substrate of the present invention can be formed by applying to the substrate mentioned above a liquid application in which electroconductive powder is dispersed in a suitable binder resin.

Specific examples of such electroconductive powder include, but are not limited to, carbon black, acetylene black, metal powder such as aluminum, nickel, iron, nichrome, copper, zinc and silver, and metal oxide powder such as electroconductive tin oxide, and indium tin oxide (ITO).

Specific examples of the binder resins which are used together with the electroconductive powder include, but are not limited to, thermoplastic resins, thermosetting resins, and optical curable resins such as a polystyrene, a styrene-acrylonitrile copolymer, a styrene-butadiene copolymer, a styrene-anhydride maleic acid copolymer, a polyester, a polyvinyl chloride, a vinyl chloride-vinyl acetate copolymer, a polyvinyl acetate, a polyvinylidene chloride, a polyarylate (PAR) resin, a phenoxy resin, polycarbonate, a cellulose acetate resin, an ethyl cellulose resin, a polyvinyl butyral, a polyvinyl formal, a polyvinyl toluene, a poly-N-vinyl carbazole, an acryl resin, a silicone resin, an epoxy resin, a melamine resin, an urethane resin, a phenol resin, and an alkyd resin. Such an electroconductive layer can be formed by dispersing the electroconductive powder and the binder resins mentioned above in a suitable solvent such as tetrahydrofuran (THF), dichloromethane (MDC), methyl ethyl ketone (MEK), and toluene and applying the resultant to a substrate.

Also, an electroconductive substrate formed by providing a heat contraction rubber tube on a suitable cylindrical substrate can be used as the electroconductive substrate of the present invention. The heat contraction tube is formed of a material such as polyvinyl chloride, polypropylene, polyester, polystyrene, polyvinylidene chloride, polyethylene, chloride rubber, and polytetrafluoroethylene based fluorine resin in which the electroconductive powder mentioned above is contained.

### Charge Blocking Layer

The charge blocking layer is provided under the undercoating layer to prevent occurrence of moire. The charge blocking layer can be formed of material different from those for the undercoating layer and thus imparts the free latitude of designing for image formation members. That is, the charge blocking layer bears a single function of preventing the occurrence of moire to avoid causing the undercoating layer to have multiple functions. Therefore, the charge blocking layer is preferably provided to improve the moire prevention effect.

The charge blocking layer is a layer having a function of preventing infusion of charges having a reverse polarity which are induced at the electrode (electroconductive substrate) during charging a photoreceptor from the electroconductive substrate to the photosensitive layer. The charge blocking layer prevents infusion of positive holes for negative charging and electrons for positive charging.

In addition, the charge blocking layer may have a function of reducing infusion of charges from an electroconductive substrate by adding an electroconductive polymer having rectification property and/or a resin or compound having acceptor (doner) property according to the charging electricity.

N-alkoxymethylated nylon for use in the charge blocking layer of the photoreceptor of the present invention is obtained by modifying polyamide 6, polyamide 12 or a copolymerized polymer containing polyamide 6 and polyamide 12 as components by, for example, the method proposed by T. L. Cairns (J. Am. Chem. Soc. 71. P651 in 1949). N-alkoxymethylated nylon is formed by substituting hydrogen in the amide bonding in a polyamide with an alkoxymethyl group and soluble in methyl alcohol, ethyl alcohol, or isopropyl alcohol. N-alkoxymethylated nylon is highly soluble in a lower alcohol so that such an alcohol can be used as a solvent for a liquid application. Therefore, N-alkoxymethylated nylon is preferred because N-alkoxymethylated nylon can form a charge blocking layer without being dissolved in a ketone solvent.

Among N-alkoxymethylated nylons for use in the present invention, N-alkoxymethylated nylon having an alkoxy group having 1 to 10 carbon atoms is preferably used because it is suitably dissolved in a solvent for adjusting a liquid application. Specific examples of N-alkoxymethylated nylons having an alkoxy group having 1 to 10 carbon atoms include, but are not limited to, methoxymethylized nylon, ethoxymethylized nylon and buthoxymethylized nylon. Among these, methoxymethylized nylon is most suitably used.

In addition, the substitution ratio is suitably selected from a wide range depending on the modification condition but preferably from 20 to 40 mol % to lower moisture absorption of the charge blocking layer and obtain the environment stability. Furthermore, when the substitution ratio is too small, the solubility of a resultant resin to a solvent tends to decrease so that application of the solvent application is difficult. The solubility in a lower alcohol (methanol, ethanol, etc.) extremely decreases in particular.

Alcohol based solvents such as methanol, ethanol, propanol, butanol or a mixture thereof are used as the solvent for a liquid application for the charge blocking layer since N-alkoxymethylated nylons are soluble in alcohol. Among these, methanol is most preferred as the alcohol based solvent because the solubility of the N-alkoxymethylated nylons for use in the present invention is the highest for methanol.

However, when methanol is used alone as the solvent for a liquid application, the evaporation speed of the solvent is high and the specific latent heat thereof is large, which causes filming deficiency referred to as brushing during surface drying after application. To avoid this filming deficiency, a combinational use of methanol with an alcohol based solvent having a slower evaporation speed than methanol is preferred (combination of at least two alcohol based solvents). With regard to an alcohol based solvent other than methanol, a solvent having a small number of carbon atoms except for methanol is not suitable to prevent brushing. Therefore, an alcohol based solvent having three or more carbon atoms is preferably used. Specific examples thereof include, but are not limited to, n-propanol, iso-propanol, n-butanol, iso-butanol, tert-butanol, and n-pentanol. When such an alcohol based solvent has an excessively large number of carbon atoms, the time to be taken for surface drying tends to be long and the solubility of N-alkoxymethylated nylon also decreases. Thus, the number of carbon atoms is suitably from six or less.

In addition, water is preferably mixed with the alcohol based solvent to improve the compatibility between N-alkoxymethylated nylon and the alcohol based solvent, which increases the stability of the liquid application over time. The content of water in a solvent is preferably from 5 to 20% by weight based on the total weight of all the solvents for use in the liquid application in terms of a good combination of filming property and stability of the solvent.

Tapped water can be used as the water in the present invention but distilled water or deionized water from which impurities are removed is preferred. Furthermore, distilled water or deionized water that has been filtered with a filter having a suitable opening size is more preferred.

In addition, particulates or additives such as electron acceptance material, a curing agent, and a dispersion agent can be added according to the design of the charge blocking layer formed by using this liquid application. Also, an organic solvent other than the alcohol based solvent can be added, if desired.

Furthermore, the layer thickness of the charge blocking layer 52 is from 0.1 to less than 2.0 μm and preferably from about 0.3 to about 1.0 μm. When the layer thickness of a charge blocking layer is too thick, the residual voltage significantly rises during repetitive charging and irradiation especially in a low temperature and low humid environment. When the layer thickness of a charge blocking layer is too thin, the charge blocking property thereof may be reduced. A charge blocking layer is formed on an electroconductive substrate by a known method such as a blade coating method, a dip coating method, a spray coating method, a beat coating method and a nozzle coating method. It is possible to add an agent, a solvent, an additive, and a promoter to help curing (cross-linking). After coating, the layer is dried or cured by a curing treatment such as drying, heating, or application of light.

### Photosensitive Layer

Next, the photosensitive layer is described. The photosensitive layer can have a laminate structure or a single layer structure.

The photosensitive layer is structured by a charge generation layer having a charge generation function and a charge transport layer having a charge transport function in a laminate structure. The photosensitive layer is a layer having both functions of charge generation and charge transport simultaneously.

Below are descriptions about the photosensitive layer of a laminate structure and of a single layer structure.

### Photosensitive Layer Formed of Charge Generation Layer and Charge Transport Layer

### Charge Generation Layer

The charge generation layer is a layer mainly formed of a charge generation material having a charge generation function with an optional binder resin. As the charge generation material, an inorganic material and an organic material can be used.

Specific examples of the inorganic material include, but are not limited to, crystal selenium, amorphous selenium, selenium-tellurium, selenium-tellurium-halogen, selenium-arsenic compounds and amorphous silicon. Also, amorphous silicon in which the dangling bonding is terminated by hydrogen atoms or halogen atoms, or boron atoms or phosphorous atoms are doped are suitably used.

On the other hand, known materials can be used as the organic materials. Specific examples thereof include, but are not limited to, phthalocyanine based pigments, for example, metal phthalocyanine and non-metal phthalocyanine, azulenium salt pigments, methine squaric acid pigments, azo pigments having carbazole skeleton, azo pigments having triphenyl amine skeleton, azo pigments having dibenzothiophene skeleton, azo pigments having fluorenone skeleton, azo pigments having oxadiazole skeleton, azo pigments having bis stilbene skeleton, azo pigments having distyryl oxadiazole skeleton, azo pigments having distyryl carbazole skeleton, perylene based pigments, anthraquinone based or polycyclic quinone pigments, quinone imine pigments, diphenyl methane based pigments, triphenyl methane based pigments, benzoquinone based pigments, naphthoquinone based pigments, cyanine based pigments, azomethine based pigments, indigoid based pigments, and bisbenzimidazole pigments. These charge generation materials can be used alone or in combination.

Specific examples of the optional binder resins for use in a charge generation layer include, but are not limited to, polyamides, polyurethanes, epoxy resins, polyketones, polycarbonates, silicone resins, acrylic resins, polyvinyl butyrals, polyvinyl formals, polyvinyl ketones, polystyrenes, polysulfones, poly-N-vinyl carbazoles, and polyacrylamides. These binder resins can be used alone or in combination. In addition to the binder resins mentioned as the binder resin for the charge generation layer, charge transport polymer materials having a charge transport function, for example, polymer materials, for example, polycarbonate resins, polyester resins, polyurethane resins, polyether resins, polysiloxane resins, and acryl resins which have arylamine skeleton, benzidine skeleton, hydrazone skeleton, carbazole skeleton, stilbene skeleton, pyrazoline skeleton, etc.; and polymer materials having polysilane skeleton, can be used as the binder resin.

A specific example of the materials having polysilane skeleton is a polysilylene polymer.

In addition, the charge generating layer can contain a charge transport material having a low molecular weight.

The charge transport material having a low molecular weight for use in the charge generating layer is typified into two types, which are a positive hole transport material and an electron transport material.

Specific examples of the charge transport materials include, but are not limited to, electron accepting materials, for example, chloroanyl, bromoanyl, tetracyanoethylene, tetracyano quinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitro dibenzothiophene-5,5-dioxide, and diphenoquinone derivatives. These can be used alone or in combination.

As the positive hole transport materials, the following electron donating materials can be suitably used.

Specific examples thereof include, but are not limited to, oxazole derivatives, oxadiazole derivatives, imidazole derivatives, monoaryl amine derivatives, diaryl amine derivatives, triaryl amine derivatives, stilbene derivatives, α-phenyl stilbene derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, bisstilbene derivatives, enamine derivatives and other known materials. These charge transport materials can be used alone or in combination.

As a method of forming a charge generating layer, it is possible to use a vacuum thin layer manufacturing method and a casting method from a solution dispersion system.

Specific examples of the vacuum thin layer manufacturing method include, but are not limited to, a vacuum deposition method, a glow discharging decomposition method, an ion plating method, a sputtering method, and a reactive sputtering method and a chemical vacuum deposition (CVD) method. Both inorganic materials and organic materials mentioned above can be used to form a charge transport layer.

When a casting method is used, it is possible to form a charge generation layer by applying a suitably diluted liquid dispersion obtained by dispersing the inorganic material or the organic material mentioned above in a solvent together with an optional binder resin using a dispersing device. Specific examples of the solvent include, but are not limited to, tetrahydrofuran, dioxane, dioxolan, toluene, dichloromethane, monochlorobenzene, dichloroethane, cyclohexanone, cyclopentanone, anisole, xylene, methylethylketone, acetone, ethyl acetate and butyl acetate. Specific examples of the dispersing device include, but are not limited to, a ball mill, an attritor, a sand mill, and a bead mill. In addition, if desired, a leveling agent, for example, dimethyl silicone oil and methylphenyl silicone oil, can be added to the liquid dispersion mentioned above. Furthermore, the application mentioned above is performed by a dip coating method, a spray coating method, a bead coating method and a ring coating method.

The thickness of the charge transport layer obtained as described above is preferably from 0.01 to 5 μm and more preferably from 0.05 to 2 μm.

### Charge Transport Layer

The charge transport layer is a layer having a charge transport function and the cross-linked protective layer having a charge transport structure for use in the present invention is suitably used as the charge transport layer. When the cross-linked protective layer is the entire charge transport layer, a liquid application containing the radical polymerizable composition (radical polymerizable monomer having no charge transport structure and a radical polymerizable compound having a charge transport structure) for use in the present invention is applied to the charge generation layer and dried, if desired, followed by curing reaction upon application of an external energy to form the cross-linked protective layer as described later in the method of manufacturing the cross-linked protective layer. The layer thickness of the cross-linked protective layer is from 10 to 30 μm and preferably from 10 to 25 μm. When the layer thickness is too thin, a sufficient charging voltage is not easily maintained. A layer thickness that is too thick tends to cause peeling-off from the layer provided under the cross-linked protective layer due to the volume contraction during curing.

In addition, when the cross-linked protective layer is formed on the surface portion of the charge transport layer having a laminate structure, the bottom layer portion of the charge transport layer is formed by dissolving or dispersing a charge transport material having a charge transport function and a binder resin in a suitable solvent and applying the liquid to the charge generation layer followed by drying. Thereafter, the liquid application of the radical polymerizable composition described above followed by cross-linking curing upon application of an external energy.

As the charge transport material, the charge transport materials, the positive hole transport materials and the charge transport polymers specified for the charge generation layer described above can be used. Especially, as described above, using the charge transport polymers is effective to reduce the solubility of a layer lying under the surface layer during application thereof.

Specific examples of the binder resins include, but are not limited to, thermal curable resins and thermal plastic resins such as polystyrenes, styrene-acrylonitrile copolymers, styrene-butadiene copolymers, styrene-maleic acid anhydride copolymers, polyesters, polyvinyl chlorides, vinyl chloride-vinyl acetate copolymers, polyvinyl acetates, polyvinyl vinylidenes, polyarylates resins, phenoxy resins, polycarbonates, cellulose acetate resins, ethyl cellulose resins, polyvinyl butyrals, polyvinyl formals, polyvinyl toluene, poly-N-vinylcarbazols, acrylic resins, silicone resins, epoxy resins, melamine resins, urethane resins, phenol resins, and alkyd resins.

The content of such a charge transport material is from 20 to 300 parts by weight and preferably from 40 to 150 parts by weight based on 100 parts by weight of a binder resin. When a charge transport polymer is used, the charge transport polymer can be used alone or in combination with a binder resin.

As the solvent for use in application of a charge transport layer, the same solvent as those specified for the charge generation layer can be used. Among those, the solvent that suitably dissolves the charge transport material and the binder resin is preferred. These solvents can be used alone or in combination. To form the bottom portion of the charge transport layer, the same method as those specified for the charge generation layer can be used.

Additives such as a plasticizer and a leveling agent can be optionally added. Specific examples of the plasticizers which can be added to the bottom layer portion of the charge transport layer include known resin plasticizers such as dibutyl phthalate and dioctyl phthalate. The content of the resin plasticizer in the charge transport layer is from 0 to about 30 parts by weight based on 100 parts of a binder resin.

### Photosensitive Layer of Single Layer Structure

The single layered photosensitive layer has both a charge generation function and a charge transport function simultaneously and the cross-linked protective layer having a charge transport structure of the present invention can be suitably used as the photosensitive layer of the single layered structure. As described in the casting method for the charge generation layer, the charge generation material is dispersed in a liquid application containing the radical polymerizable composition and applied to the charge generation layer and dried, if desired, followed by curing reaction upon an external energy to form the cross-linked protective layer. The charge generation material can be preliminarily dispersed in a solvent and then added to the liquid application of the cross-linked protective layer. The layer thickness of the cross-linked protective layer is from 10 to 30 μm and preferably from 10 to 25 μm. When the layer thickness is too thin, a sufficient charging voltage is not easily maintained. A layer thickness that is too thick tends to cause peeling-off from the undercoating layer or the electroconductive substrate due to the volume contraction during curing.

In addition, when the cross-linked protective layer occupies the photosensitive layer of a single layered structure, the bottom layer of the photosensitive layer can be formed by applying a liquid application in which a charge generation compound having a charge generation function, a charge transport compound having a charge transport function and a binder resin are dispersed or dissolved in a suitable solvent to an electroconductive substrate followed by optional drying. In addition, a plasticizing agent and/or a leveling agent can be added, if desired.

With regard to the dispersion method of a charge generation material, the charge generation compound (material), the charge transport compound (material), the plasticizing agent, and the leveling agent, the same as specified above for the charge generation layer and the charge transport layer can be used. With regard to the binder resin, in addition to the binder resins specified above for the charge transport layer, the binder resin for use in the charge generation layer can be mixed in combination. In addition, the charge transport polymers mentioned above can be also used. This is useful in light that mingling of the compositions of the bottom portion of the photosensitive layer with the cross-linked protective layer can be reduced. The layer thickness of the bottom portion of the photosensitive layer is suitably from about 5 to about 30 μm and preferably from about 10 to about 25 μm.

The content of the charge generation material contained in the photosensitive layer of a single layered structure is preferably from 1 to 30% by weight, the content of the binder resin contained in the lower layer portion of the photosensitive layer is from 20 to 80% by weight, and the content of the charge transport material is preferably from 10 to 70% by weight based on the total amount of the photosensitive layer.

### Protective Layer

In the photoreceptor of the present invention, a protective layer can be provided on the photosensitive layer to protect the photosensitive layer. In recent years, computers have been used in everyday life and a printer is required to print at a high speed and be small in size. Therefore, the photoreceptor of the present invention with a high sensitivity and no defects is suitably used by providing a protective layer to improve the durability.

Specific examples of the materials for use in the protective layer include ABS resins, ACS resins, olefin-vinyl monomer copolymers, chlorinated polyether, allyl resins, phenolic resins, polyacetal, polyamide, polyamideimide, polyallysulfone, polybutylene, polybutyleneterephthalate, polycarbonate, polyarylate, polyethersulfone, polyethylene, polyethyleneterephthalate, polyimide, acrylic resins, polymethylpentene, polypropylene, polyphenyleneoxide, polysulfone, polystyrene, AS resins, butadiene-styrene copolymers, polyurethane, polyvinyl chloride, polyvinylidene chloride, epoxy resins, etc. Among these resins, polycarbonate and polyarylate are preferably used.

### Protective Layer of Particulate Dispersion Type

In addition, to improve the anti-abrasion property of such a protective layer, fluorine-containing resins such as polytetrafluoroethylene, and silicone resins can be used therefor. Further, combinations of such resins and the second inorganic particulate such as titanium oxide, aluminum oxide, tin oxide, zinc oxide, zirconium oxide, magnesium oxide, potassium titanate and silica or an organic particulate can also be used for the protective layer.

In addition, organic and inorganic particulates can be used in the protective layer. Suitable organic particulates include, but are not limited to, powder of fluorine-containing resins such as polytetrafluoroethylene, silicone resin powder, amorphous carbon powder, etc. Specific examples of the second inorganic particulate include, but are not limited to, powder of metals such as copper, tin, aluminum and indium; metal oxides such as alumina, silicon dioxid, tin oxide, zinc oxide, titanium oxide, aluminum oxide, zirconia, indium oxide, antimony oxide, bismuth oxide, calcium oxide, tin oxide doped with antimony, indium oxide doped with tin; potassium titanate, etc. In terms of the hardness of particulates, the inorganic particulates are preferred. In particular, silicon dioxide, titanium oxide and aluminum oxide are preferred.

The content of the particulate in the protective layer is determined depending on the species of the particulate used and the application conditions of the resultant photoreceptor, but the content of the particulate on the uppermost surface side of the protective layer is preferably not less than 5% by weight, more preferably from about 10 to about 50% by weight, and even more preferably from about 10 to about 30% by weight, based on the total weight of the solid portion.

The particulate included in the protective layer preferably has a volume average particle diameter of from 0.1 to 2 μm, and more preferably from 0.3 to 1 μm. When the average particle diameter is too small, the anti-abrasion property of the resultant photoreceptor is not satisfactory. In contrast, when the average particle diameter is too large, the surface of the resultant protective layer significantly becomes irregular or a protective layer is not formed.

The average particle diameter of the particulate described in the present invention represents a volume average particle diameter unless otherwise specified, and is measured using an ultracentrifugal automatic particle size measuring device (CAPA-700, manufactured by Horiba Ltd.). Therein, the cumulative 50% particle diameter (i.e., the median particle diameter) is defined as the average particle diameter. In addition, the standard deviation of the particle diameter distribution curve of the particulate used for the protective layer is preferably not greater than 1 μm. When the standard deviation is too large (i.e., when the particulate has an excessively broad particle diameter distribution), the effect of the present invention may not be obtained.

Among these particulate, α-aluminum oxide, which has a high insulating property, a high heat stability and an anti-abrasion property due to its hexagonal close-packed structure, is particularly preferred in terms of prevention of formation of blurred images and improvement of anti-abrasion property of the resultant photoreceptor.

These particulates can be subject to surface treatment using at least one surface treatment agent to improve the dispersion property of the particulates in a protective layer. When a particulate is poorly dispersed in a protective layer, the following problems occur.

(1) the residual potential of the resultant photoreceptor increases;
(2) the transparency of the resultant protective layer decreases;
(3) coating defects occur in the resultant protective layer;
(4) the anti-abrasion property of the protective layer deteriorates;
(5) the durability of the resultant photoreceptor deteriorates; and
(6) the image qualities of the images produced by the resultant photoreceptor deteriorate.

Suitable surface treatment agents include known surface treatment agents. Among these, surface treatment agents which can maintain the highly insulative property of a particulate used are preferred.

As the surface treatment agents, titanate coupling agents, aluminum coupling agents, zircoaluminate coupling agents, higher fatty acids, combinations of these agents with a silane coupling agent, Al₂O₃, TiO₂, ZrO₂, silicones, aluminum stearate, and the like, can be preferably used to improve the dispersibility of particulates and to prevent formation of blurred images. These materials can be used alone or in combination.

When a particulate treated with a silane coupling agent is used, the resultant photoreceptor tends to produce blurred images. However, when a silane coupling agent is used in combination with one of the surface treatment agents mentioned above, the affect of the silane coupling is possibly restrained.

The coating weight of a surface treatment agents is preferably from 3 to 30% by weight, and more preferably from 5 to 20% by weight, based on the weight of the treated particulate although the weight is determined depending on the average primary particle diameter of the particulate.

When the content of the surface treatment agent is too low, the dispersibility of the particulate is not improved. In contrast, when the content is too high, the residual potential of the resultant photoreceptor significantly increases. These filler materials can be used alone or in combination. The amount of surface treatment of the particulate is defined by the weight ratio of a surface treatment agent used for the amount of the particulate as described above.

The particulate material can be dispersed using a proper dispersion machine. In this case; the particulate is preferably dispersed to an extent that the agglomerated particles are dissociated and primary particles of the particulate are dispersed to improve the transparency of the resultant protective layer.

In addition, a charge transport material can be contained in the protective layer to enhance the photo-responsive property and to reduce the residual potential of the resultant photoreceptor. The charge transport materials mentioned above for use in the charge transport layer can also be used for the protective layer.

When a low molecular weight charge transport material is used in a protective layer, the concentration of the charge transport material may be gradated in the thickness direction of the protective layer with the surface side being thinner. Specifically, it is preferred to reduce the concentration of the charge transport material at the surface portion of the protective layer to improve the anti-abrasion property of the resultant photoreceptor. The concentration of the charge transport material means the ratio of the weight of the charge transport material to the total weight of the protective layer.

It is extremely advantageous to use a charge transport polymer in the protective layer in order to improve the durability of the photoreceptor.

As a method of forming the protective layer, a method is preferred in which the content of the solvent is small and the contact time with the solvent is short during coating. To be specific, a spray coating method, or a ring coating method regulating the amount of a liquid application is particularly preferred.

### Cross-Linked Protective Layer

In addition, as another form of the protective layer, the cross-linked protective layer having a charge transport structure is effectively used. When the cross-linked protective layer having a charge transport structure is used, an increase in the intensity of the electric field is efficiently reduced, which leads to reduction of background fouling. In addition, the anti-damage property of the surface of the photoreceptor is good. Thus, filming hardly occurs. That is, the occurrence of image deficiency is reduced. The cross-linked protective layer is effective and useful to impart a high durability. Furthermore, in comparison with the protective layer of particulate dispersion type, the cross-linked protective layer is advantageous to form a uniform layer. Thus, abrasion on the surface of the photoreceptor by a cleaning member is uniform and in addition the electrostatic characteristics of the photoreceptor in minute areas are uniform so that the cross-linked protective layer is more effective than the protective layer of particulate dispersion type. Since the protective layer provided on the photosensitive layer in the present invention is a cross-linked protective layer formed by curing a radical polymerizable monomer having three or more functional groups with no charge transport structure and a radical polymerizable compound having a charge transport structure, the photoreceptor of the present invention has a high durability and produces quality images for an extended period of time.

In the photoreceptor of the present invention, a radical polymerizable monomer having three or more functional groups is used in the surface layer to develop a three dimensional network structure. Thus, a hard surface layer having an extremely high cross-linking density is obtained, resulting in high anti-abrasion property. In contrast, when only a radical polymerizable monomer having one or two functional monomer is used, the cross-linking bonding in a cross-linked protective layer tends to be thin so that drastic improvement on the antiabrasion property is not obtained. When a polymer is contained in the cross-linked protective layer, the development of a three dimensional network structure is hindered so that the degree of the cross-linking decrease. Thus, a suitable anti-abrasion property is not obtained in comparison with the present invention. Furthermore, a contained polymer is not compatible with cured material resulting from curing reaction among a radical polymerizable composition (a radical polymerizable monomer or a compound having a charge transport structure) and thus local abrasion occurs due to phase separation, resulting in scar on the surface. Furthermore, the liquid application for use in the cross-linked protective layer of the present invention includes a radical polymerizable monomer having a charge transport structure, which is taken into the cross-linking bonding when the radical polymerizable monomer having three or more functional groups is cured. In contrast, when a low molecule weight charge transport material having no functional group is contained in the cross-linked protective layer, the low molecule weight charge transport material precipitates or causes crowd phenomenon due to its low compatibility, which leads to deterioration of the mechanical strength of the cross-linked protective layer. When a charge transport compound having two or more functional groups is used as the main component, the compound is fixed in the cross-linking structure by multiple bondings. However, the charge transport structure is extremely bulky, which causes distortion in the cured resin so that the internal stress in the cross-linked protective layer increases. This leads to frequent occurrence of cracking and scar on the surface due to carrier attachment.

Furthermore, the photoreceptor of the present invention has good electric characteristics so that the quality of images is maintained for an extended period of time. This derives from that fact that a radial polymerizable compound having a charge transport structure is fixed between the cross-linking reaction in a pendant manner. As described above, a charge transport material having no functional group causes precipitation and/or crowd phenomenon, resulting in deterioration such as deterioration of sensitivity and a rise in the residual voltage during repetitive use. When a charge transport compound having two or more functional groups is used as the main component, the compound is fixed in the cross-linking structure by multiple bondings. Thus, the intermediate structure (cation radical) is not stabilized during charge transportation, which causes deterioration of sensitivity due to charge trap and a rise in the residual voltage. Such deterioration in the electric characteristics results in production of images having a thin image density, thinned lines, etc.

Below is a description about the composition materials of the liquid of application for use in forming the cross-linked protective layer of the present invention.

The radical polymerizable monomer having three functional groups without having a charge transport structure represents a monomer having at least three radical polymerizable functional groups and not having a positive hole structure such as triaryl amine, hydrazone, pyrazoline, and carbazole, nor an electron transport structure such as condensed polycyclic quinone, diphenoquinone and electron absorbing aromatic ring having a cyano group, a nitro group, etc. Any radical polymerizable functional group having one or more carbon-carbon double linkages and performing radical polymerization can be used. For example, 1-substituted ethylene functional groups and 1,1-substituted ethylene functional groups can be used as suitable radical polymerizable functional groups.
(1) A specific example of 1-substituted ethylene functional groups is the functional group represented by the following Chemical structure (5):

CH₂═CH—X₁— Chemical structure (5),

wherein X₁ represents a substituted or non-substituted phenylene group, an arylene group such as a naphthylene group, a substituted or non-substituted alkenylene group, —CO—, —COO—, —CON(R₁₀) (wherein, R₁₀ represents hydrogen, an alkyl group such as methyl group and ethylene group, an aralkyl group such as benzyl group, naphthyl methyl group, and phenethyl group, and an aryl group such as phenyl group and naphthyl group), or —S—.

Specific examples of such functional groups include vinyl group, styryl group, 2-methyl-1,3-butadienyl group, vinyl carbonyl group, acryloyloxy group, acryloyl amide group, and vinylthio ether group.

A specific example of 1,1-substituted ethylene functional groups is the functional group represented by the following chemical structure (6):

CH₂═C(Y)—X₂- Chemical structure(6)

Wherein Y represents a substituted or non-substituted alkyl group, a substituted or non-substituted aralkyl group, a substituted or non-substituted phenyl group, an aryl group such as naphthylene group, a halogen atom, cyano group, nitro group, an alkoxy group such as methoxy group and ethoxy group, —COOR₁₁ (R₁₁ represents hydrogen atom, an alkyl group such as a substituted or non-substituted methyl group or ethyl group, an aralkyl group such as a substituted or non-substituted benzyl group and phenyl group, an aryl group such as substituted or non-substituted phenyl group and naphtyl group or —CONR₁₂R₁₃ (R₁₂ and R₁₃ independently represent a hydrogen atom, an alkyl group such as a substituted or non-substituted methyl group or ethyl group, an aralkyl group such as a substituted or non-substituted benzyl group, naphthyl methyl group, and phenethyl group, or an aryl group such as substituted or non-substituted phenyl group and naphtyl group). X₂ represents the same substitution group as X₁, or an alkylene group. At least one of Y and X₂ is an oxycarbonyl group, cyano group, an alkenylene group and an aromatic ring.

Specific examples of these functional groups include α-cyanoacryloyloxy group, methacryloyloxy group, α-cyanoethylene group, α-cyanoacryloyloxy group, α-cyanophenylene group and methacryloyl amino group.

Specific examples of substitution groups further substituted to the substitution groups of X₁, X₂ and Y include a halogen atom, nitro group, cyano group, an alkyl group such as methyl group and ethyl group, an alkoxy group such as methoxy group and ethoxy group, aryloxy group such as phenoxy group, aryl group such as phenyl group and naphtyl group, and an aralkyl group such as benzyl group and phenetyl group.

Among these radical polymerizable functional groups, acryloyloxy group, and methacryloyloxy group are particularly suitable. A compound having at least three acryloyloxy groups can be obtained by performing ester reaction or ester conversion reaction using, for example, a compound having at least three hydroxy groups therein and an acrylic acid (salt), a halide acrylate and an ester of acrylate. Similarly, a compound having at least three methacryloyloxy groups can be obtained. In addition, the radical polymerizable functional groups in a monomer having at least three radical polymerizable functional groups can be the same or different from each other.

The radical polymerizable monomer having three functional groups without having a charge transport structure are specifically the following compounds but not limited thereto.

Specific examples of the radical polymerizable monomer mentioned above for use in the present invention include trimethylol propane triacrylate (TMPTA), trimethylol propane trimethacrylate, trimethylol propane alkylene modified triacrylate, trimethylol propane ethyleneoxy modified (hereinafter referred to as EO modified) triacrylate, trimethylol propane propyleneoxy modified (hereinafter referred to as PO modified) triacrylate, trimethylol propane caprolactone modified triacrylate, trimethylol propane alkylene modified triacrylate, pentaerythritol triacrylate, pentaerythritol tetra acrylate (PETTA), glycerol triacrylate, glycerol epichlorohydrin modified (hereinafter referred to as ECH modified) triacrylate, glycerol EO modified triacrylate, glycerol PO modified triacrylate, tris (acryloxyrthyl) isocyanulate, dipenta erythritol hexaacrylate (DPHA), dipenta erythritol caprolactone modified hexaacrylate, dipenta erythritol hydroxyl dipenta acrylate, alkalized dipenta erythritol tetraacrylate, alkalized dipenta erythritol triacrylate, dimethylol propane tetraacrylate (DTMPTA), penta erythritol ethoxy tetraacrylate, phosphoric acid EO modified triacrylate, and 2,2,5,5-tetrahydroxy methyl cyclopentanone tetraacrylate. These can be used alone or in combination.

In addition, the radical polymerizable monomer having three functional groups without having a charge transport structure for use in the present invention preferably has a ratio (molecular weight/the number of functional groups) of the molecular weight to the number of functional groups in the monomer is not greater than 250 to form a dense cross-linking in a cross-linked protective layer. Further, since a cross-linked protective layer formed of such a monomer is slightly soft, when the ratio (molecular weight/the number of functional groups) is too large, the anti-abrasion property thereof tends to deteriorate. Therefore, among the monomers mentioned above, it is not preferred to singly use a monomer having an extremely long modified (EO, PO, caprolactone modified) group. In addition, the content ratio of the radical polymerizable monomer having three functional groups without having a charge transport structure is from 20 to 80% by weight and preferably from 30 to 70% by weight based on the total weight of a cross-linked protective layer. Substantially, it depends on the ratio of the radical polymerizable monomer having three or more functional groups in the solid portion in the liquid application. When the monomer content ratio is too small, the density of three-dimensional cross-linking in a cross-linked protective layer tends to be small. Therefore, the anti-abrasion property thereof is not drastically improved in comparison with a case in which a typical thermal plastic binder resin is used. When the monomer content ratio is too large, the content of a charge transport compound decreases, which may cause deterioration of the electric characteristics. Desired electric characteristics and anti-abrasion property vary depending on the process and the layer thickness of the cross-linked protective layer for use in the present invention varies. Therefore, it is difficult to jump to any conclusion but considering the balance, the range of from 30 to 70% by weight is preferred.

The radical polymerizable monomer having a charge transport structure for use in the cross-linked protective layer for use in the present invention represents a monomer having a radical polymerizable functional group which has a positive hole structure such as triaryl amine, hydrazone, pyrazoline, and carbazole, or an electron transport structure such as condensed polycyclic quinone, diphenoquinone and electron absorbing aromatic ring having a cyano group, a nitro group, etc. As the radical polymerizable functional group, the radical polymerizable functional group represented by the Chemical formulae (5) and (6) illustrated above can be used. To be specific, the monomers specified in the radical polymerizable monomer mentioned above can be suitably used. Among these, acryloyloxy group and methacryloyloxy group are especially suitable. In addition, a triaryl amine structure is high effective as charge transport structure. Among these, when a compound having the structure represented by the following Chemical structures (2) or (3) is used, the electric characteristics such as sensitivity and residual voltage are preferably maintained

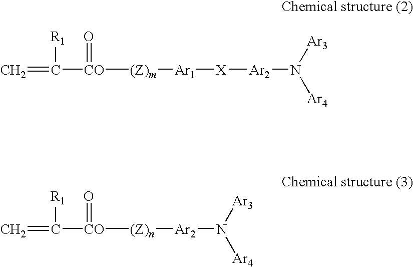

wherein, R₁ represents hydrogen atom, a halogen atom, an alkyl group, an aralkyl group, an aryl group, a cyano group, a nitro group, an alkoxy group, —COOR₇, wherein R₇ represents hydrogen atom, a halogen atom, an alkyl group, an aralkyl group or an aryl group, a halogenated carbonyl group or CONR₆R₉, wherein R₈ and R₉ independently represent hydrogen atom, a halogen atom, an alkyl group, an aralkyl group or an aryl group, Ar₁ and Ar₂ independently represent an arylene group, Ar₃ and Ar₄ independently represent an aryl group, X represents a single bond or an alkylene group, a cycloalkylene group, an alkylene ether group, oxygen atom, sulfur atom or a vinylene group, Z represents an alkylene group, an alkylene ether divalent group or an alkyleneoxy carbonyl divalent group, and m and n represent an integer of from 0 to 3.

Specific examples of the structure represented by the Chemical structures (2) and (3) are as follows.

In the Chemical structures (2) and (3), the alkyl group of R₁ is, for example, methyl group, ethyl group, propyl group, and butyl group. The aryl group thereof is, for example, phenyl group and naphtyl group. The aralkyl group thereof is, for example, benzyl group, phenethyl group, naphtyl methyl group. The alkoxy group thereof is, for example, methoxy group, ethoxy group and propoxy group. These can be substituted by a halogen atom, nitrogroup, cyano group, an alkyl group such as methyl group and ethyl group, an alkoxy group such as methoxy group and ethoxy group, an aryloxy group such as phenoxy group, an aryl group such as phenyl group and naphtyl group and an aralkyl group such as benzyl group and phenethyl group.

Among these substitution groups for R₁, hydrogen atom and methyl group are especially preferred.

Ar₃ and Ar₄ represent a substituted or non-substituted aryl group. Specific examples of the aryl group include, but are not limited to, condensed polycyclic hydrocarbon groups, non-condensed ring hydrocarbon groups and heterocyclic groups.

Specific examples of the condensed polycyclic hydrocarbon groups include a group in which the number of carbons forming a ring is not greater than 18 such as pentenyl group, indenyl group, naphtyl group, azulenyl group, heptalenyl group, biphenylenyl group, as-indacenyl group, s-indacenyl group, fluorenyl group, acenaphthylenyl group, pleiadenyl group, acenaphthenyl group, phenalenyl group, phenanthryl group, anthryl group, fluoranthenyl group, acephenantrirenyl group, aceantrirenyl group, triphenylene group, pyrenyl group, chrysenyl group, and naphthacenyl group.

Specific examples of the non-condensed ring hydrocarbon groups include a single-valent group of monocyclic hydrocarbon compounds such as benzene, diphenyl ether, polyethylene diphenyl ether, diphenylthio ether and phenylsulfone, a single-valent group of non-condensed polycyclic hydrocarbon compounds such as biphenyl, polyphenyl, diphenyl alkane, diphenyl alkene, diphenyl alkyne, triphenyl methane, distyryl benzene, 1,1-diphenyl cycloalkane, polyphenyl alkane and polyphenyl alkene or a single-valent group of ring aggregated hydrocarbon compounds such as 9,9-diphenyl fluorene.

Specific examples of the heterocyclic groups include a single-valent group such as carbazol, dibenzofuran, dibenzothiophene, oxadiazole, and thiadiazole.

The aryl groups represented by Ar₃ and Ar₄ can have a substitution group. Specific examples thereof are as follows:
(1) a halogen atom, cyano group, and nitro group;
(2) an alkyl group, preferably a straight chained or side chained alkyl group having 1 to 12, more preferably 1 to 8 and furthermore preferably from 1 to 4 carbons. These alkyl groups can have a fluorine atom, a hydroxy group, an alkoxy group having 1 to 4 carbons, a phenyl group or a phenyl group substituted by a halogen atom, an alkyl group having 1 to 4 carbon atoms or an alkoxy group having 1 to 4 carbon atoms. Specific examples thereof include methyl group, ethyl group, n-butyl group, I-propyl group, t-butyl group, s-butyl group, n-propyl group, trifluoromethyl group, 2-hydroxy ethyl group, 2-ethoxyethyl group, 2-cyanoethyl group, 2-methoxyethyl group, benzyl group, 4-chlorobenzyl group, 4-methyl benzyl group and 4-phenyl benzyl group;
(3) an alkoxy group (—OR₂), wherein R₂ is the alkyl group represented in (2). Specific examples thereof include methoxy group, ethoxy group, n-propoxy group, i-propoxy group, t-butoxy group, n-butoxy group, s-butoxy group, i-butoxy group, 2-hydroxy ethoxy group, benzyl oxy group and trifluoromethoxy group;
(4) an aryloxy group. As an aryl group, phenyl group, and naphtyl group are included. These can contain an alkoxy group having 1 to 4 carbon atoms, an alkyl group having a 1 to 4 carbon atoms or a halogen atom as a substitution group. Specific examples include phenoxy group, 1-naphthyloxy group, 2-naphtyloxy group, 4-methoxyphenoxy group, and 4-methylphenoxy group;
(5) an alkyl mercapto group or an aryl mercapto group. Specific examples thereof include methylthio group, ethylthio group, phenylthio group, and p-methylphenylthio group;
(6)

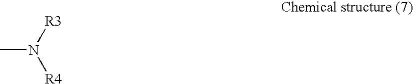

In the Chemical structure (7), R₃ and R₄ independently represent a hydrogen atom, the alkyl group defined in (2), or an aryl group. Specific examples of the aryl groups include phenyl group, biphenyl group, or naphtyl group. These can contain an alkoxy group having 1 to 4 carbon atoms, an alkyl group having 1 to 4 carbon atoms or a halogen atom as a substitution group. R₃ and R₄ can form a ring together.
Specific examples thereof include amino group, diethyl amino group, N-methyl-N-phenyl amino group, N,N-diphenyl amino group, N,N-di(tril) amino group, dibenzyl amino group, piperidino group, morpholino group, and pyrrolidino group;
(7) an alkylene dioxy group or an alkylene dithio such as methylene dioxy group and methylene dithio group; and
(8) a substituted or non-substituted styryl group, a substituted or non-substituted β-phenyl styryl group, diphenyl aminophenyl group, ditril aminophenyl group, etc.

The arylene groups represented by Ar₁ and Ar₂ are divalent groups derived from the aryl group represented by Ar₃ and Ar₄ mentioned above.

The X in the Chemical structure (2) represents a single bond, a substituted or non-substituted alkylene group, a substituted or non-substituted cycloalkylene group, a substituted or non-substituted alkylene ether group, an oxygen atom, a sulfur atom, or a vinylene group. When m is zero, X is not preferably a single bond.

Specific examples of the substituted or non-substituted alkylene groups include a straight chained or side chained alkylene group having 1 to 12, more preferably 1 to 8 and furthermore preferably from 1 to 4 carbons. These alkylene groups can further have a fluorine atom, a hydroxy group, an alkoxy group having 1 to 4 carbons, a phenyl group or a phenyl group substituted by a halogen atom, an alkyl group having 1 to 4 carbon atoms or an alkoxy group having 1 to 4 carbon atoms. Specific examples thereof include methylene group, ethylene group, n-butylene group, i-propylene group, t-butylene group, s-butylene group, n-propylene group, trifluoromethylene group, 2-hydroxy ethylene group, 2-ethoxyethylene group, 2-cyanoethylene group, 2-methoxyethylene group, benzylidene group, phenyl ethylene group, 4-chlorophenyl ethylene group, 4-methylphenyl ethylene group, and 4-biphenyl ethylene group.

Specific examples of the substituted or non-substituted cycloalkylene groups include cyclic alkylene group having 5 to 7 carbon atoms. These cyclic alkylene groups can have a fluorine atom, a hydroxy group, an alkyl group having 1 to 4 carbon atoms, and an alkoxy group having 1 to 4 carbon atoms. Specific examples thereof include cyclohexylidene group, cyclohexylene group, and 3,3-dimethyl cyclohexylidene group.

Specific examples of the substituted or non-substituted alkylene ether groups include ethyleneoxy, propyleneoxy, ethyleneglycol, propylene glycol, diethylene glycol, tetraethylene glycol, and tripropylene glycol. These alkylene ether groups can have a substitution group such as hydroxy group, methyl group and ethyl group.

The vinylene group is represented by the following chemical structures (8) or (9):

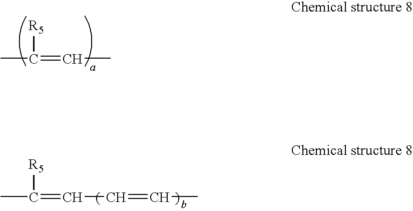

wherein, R₅ represents hydrogen or an alkyl group (the same as the alkylene groups defined in (2)) and a represents 1 or 2 and b is an integer of from 1 to 3.

Z in the Chemical structures (2) and (3) represents a substituted or non-substituted alkylene group, a substituted or non-substituted alkylene ether divalent group. Specific examples of the substituted or non-substituted alkylene group and the substituted or non-substituted alkylene ether divalent groups include, but are not limited to, the same as those specified for the X mentioned above.

A specific example of the alkyleneoxy carbonyl divalent group is a caprolactone modified divalent group.

The compound represented by the following chemical structure (4) as a further suitably preferred radical polymerizable compound having a charge transport structure:

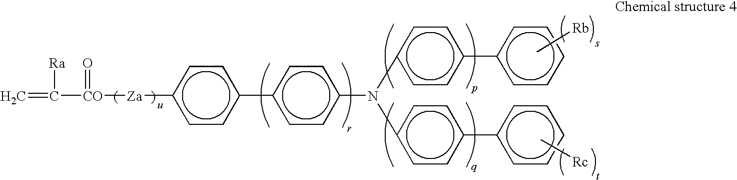

u, r, p, q represent 0 or 1, s and t represent an integer of from 0 to 3, Ra represents hydrogen atom or methyl group, Rb and Rc independently represent an alkyl group having 1 to 6 carbon atoms, and Za represents methylene group, ethylene group, —CH₂CH₂O—, —CHCH₃CH₂O—, or —C₆H₅CH₂CH₂—.

The compound represented by the chemical structure (4) illustrated above is especially preferably a compound having methyl group or ethyl group as a substitution group of Rb and Rc.

The radical polymerizable compound having a functional group with a charge transport structure for use in the present invention represented by the chemical structures (2), (3) and (4) is polymerized in a manner that both sides of the carbon-carbon double bond are open. Therefore, the radical polymer compound does not constitute an end of the structure and is set in a chained polymer. The radical polymerizable compound having a functional group is present in the main chain of a polymer in which cross-linking is formed by polymerization with a radical polymerizable monomer having 3 functional groups or a cross-linking chain between the main chains. There are two kinds of the cross-linking chains. One is the cross-linking chain between a polymer and another polymer and the other is the cross-linking chain formed by cross-linking a portion in the main chain present in a folded state in a polymer and a moiety deriving from a monomer polymerized away from the portion. Whether a radical polymerizable compound having a functional group with a charge transport structure is present in a main chain or in a cross-linking chain, the triaryl amine structure suspends from the chain portion. The triaryl amine structure has at least three aryl groups disposed in the radial directions relative to the nitrogen atom therein. Such a triaryl amine structure is bulky but does not directly bind with the chain portion and suspends from the chain portion via the carbonyl group, etc. That is, the triaryl amine structure is stereoscopically fixed in a flexible state. Therefore, these triaryl amine structures can be adjacent to each other with a moderate space. Therefore, the structural distortion is slight in a molecule. In addition, when the structure is used in the surface layer of an photoreceptor, it can be deduced that the internal molecular structure can have a structure in which there are relatively few disconnections in the charge transport route.

Below are the specific examples of the radical polymerizable compounds having one functional group with a charge transport structure of the present application. But the radical polymerizable compounds are not limited thereto.

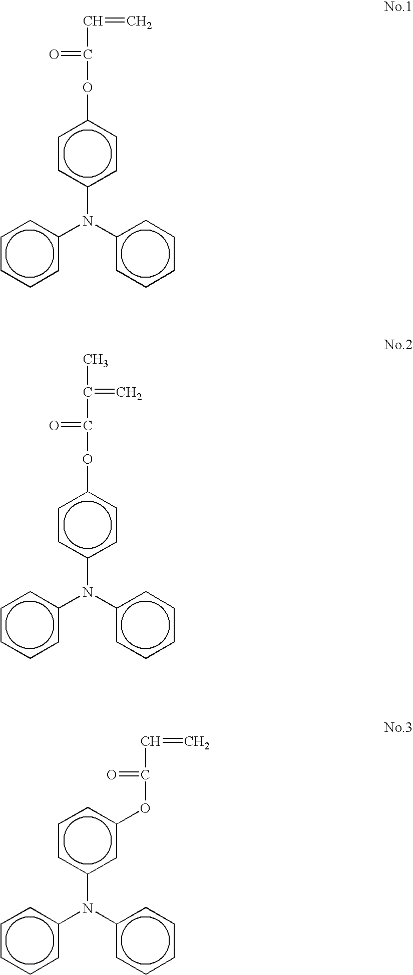

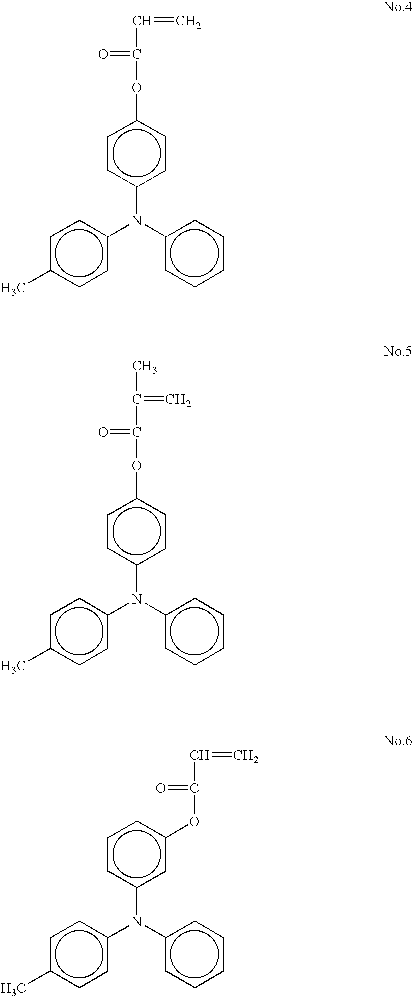

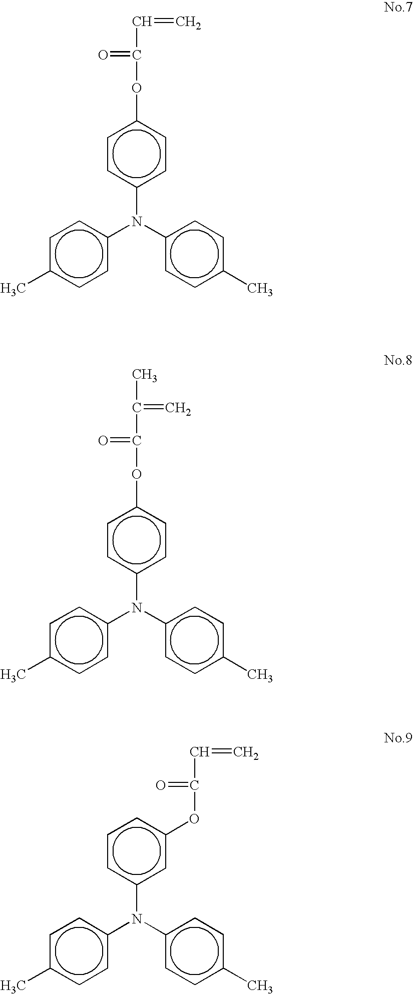

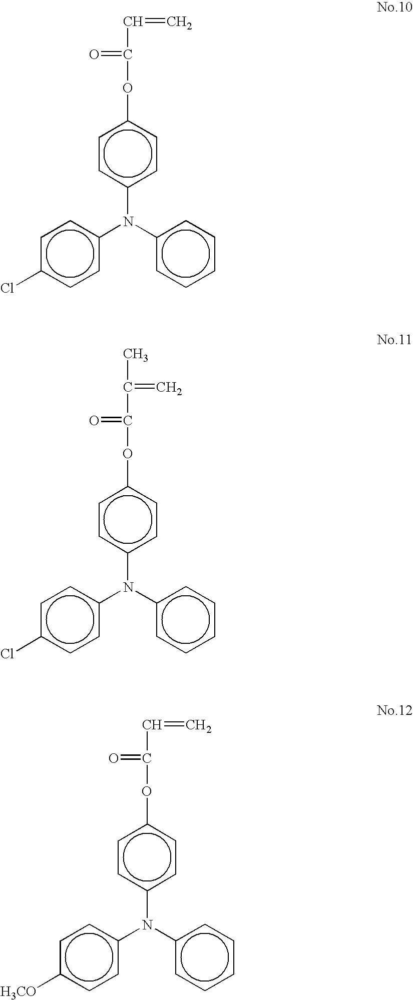

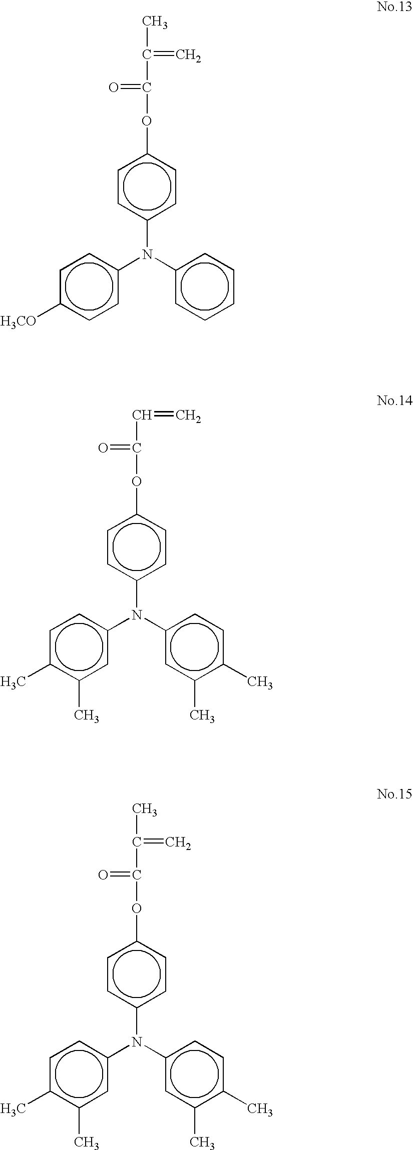

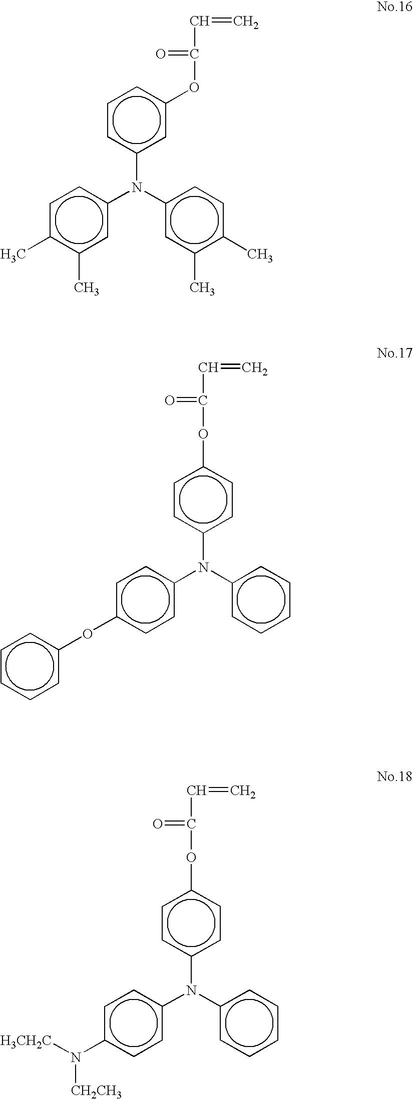

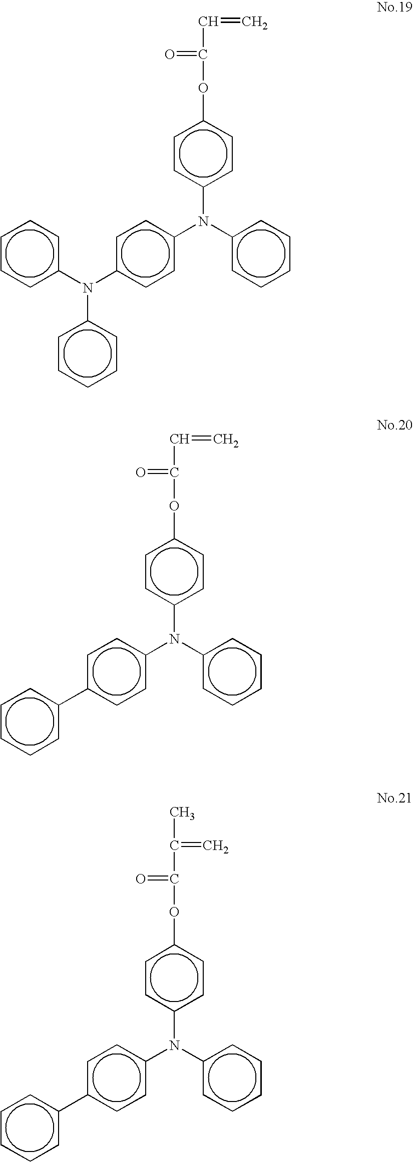

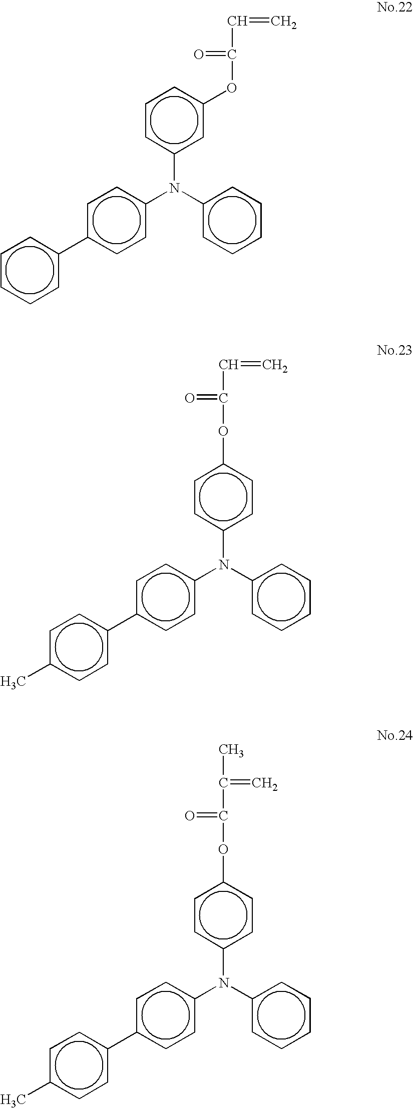

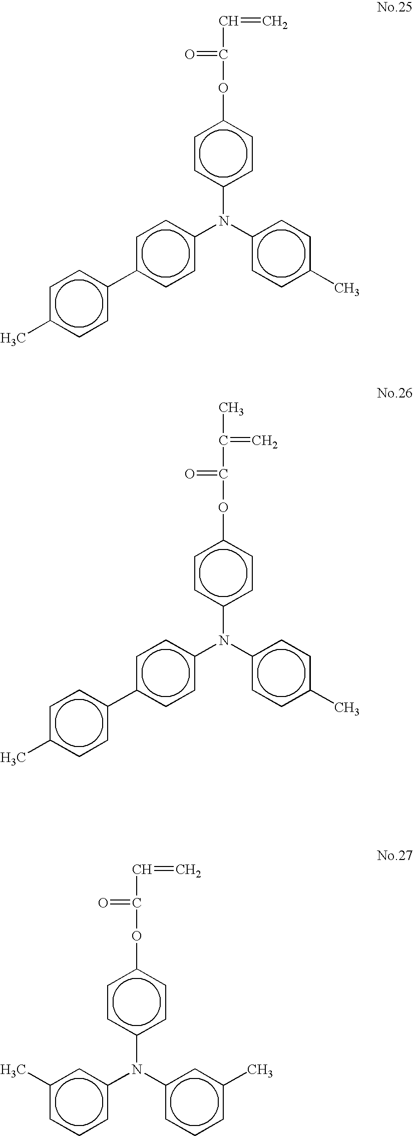

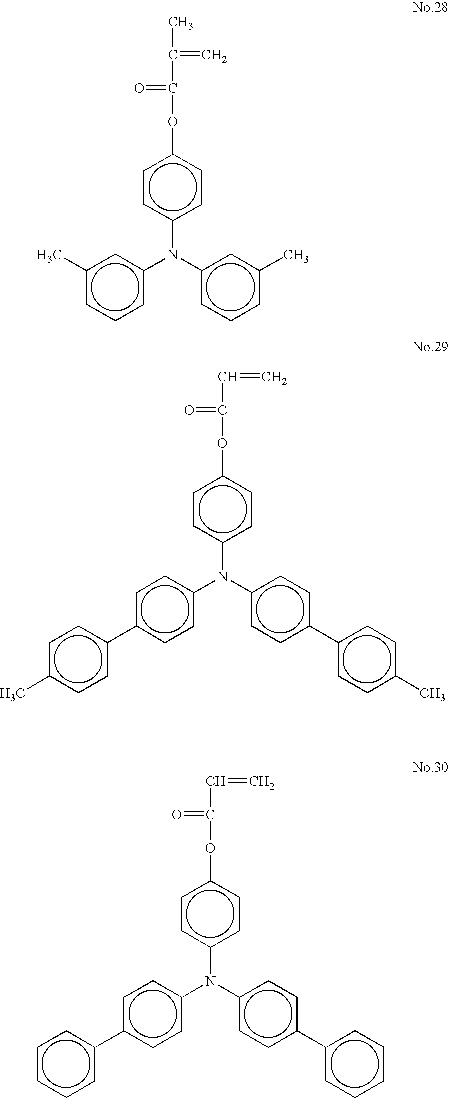

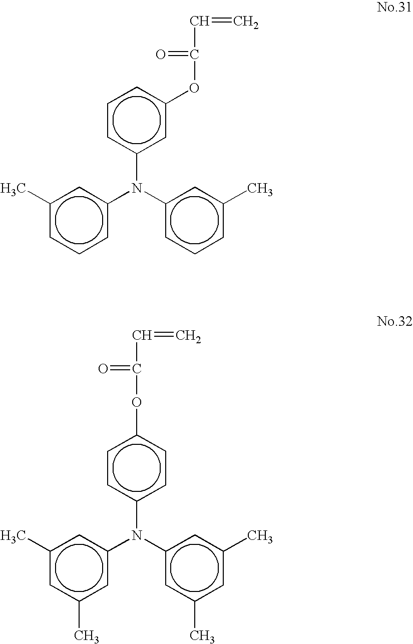

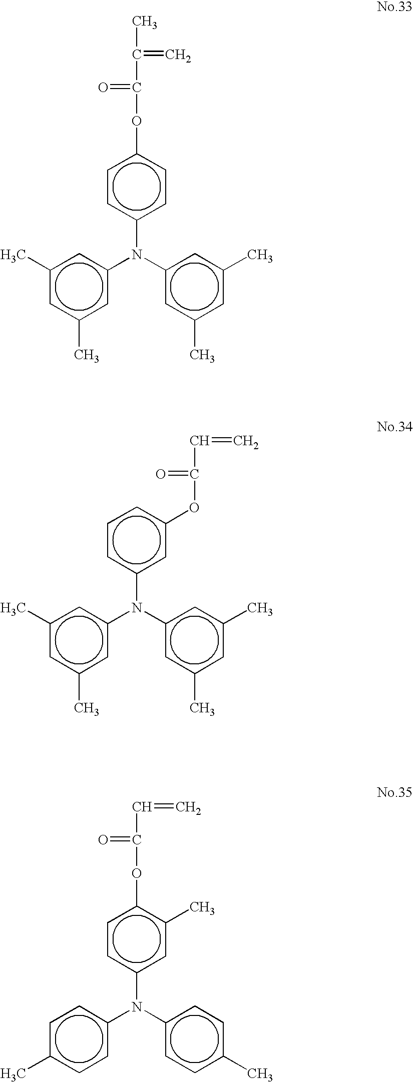

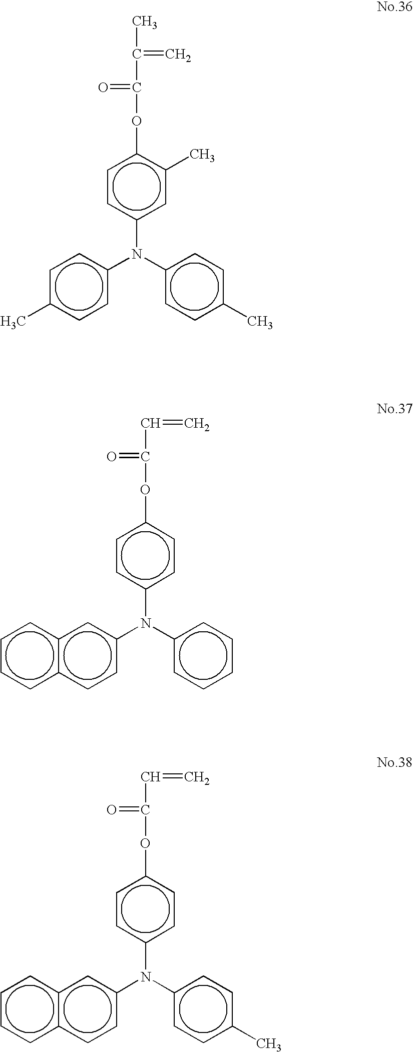

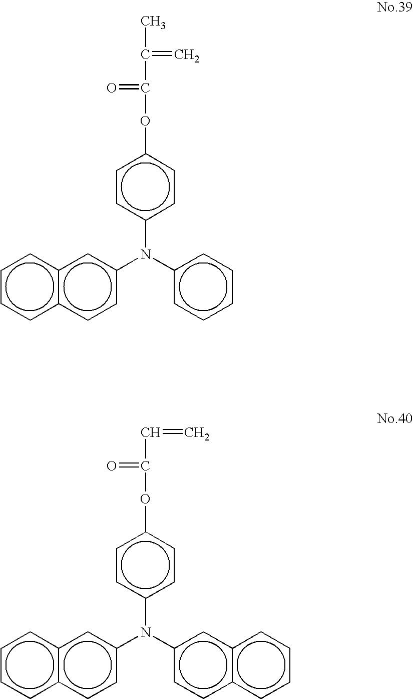

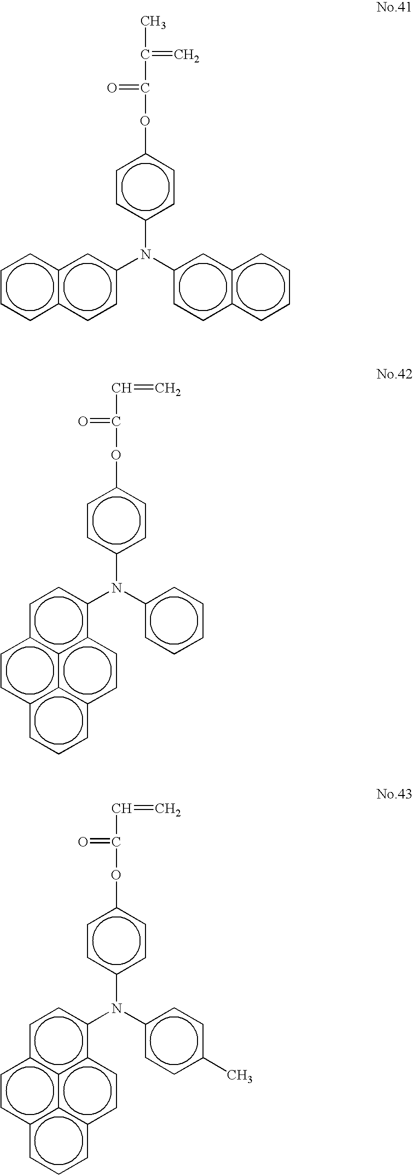

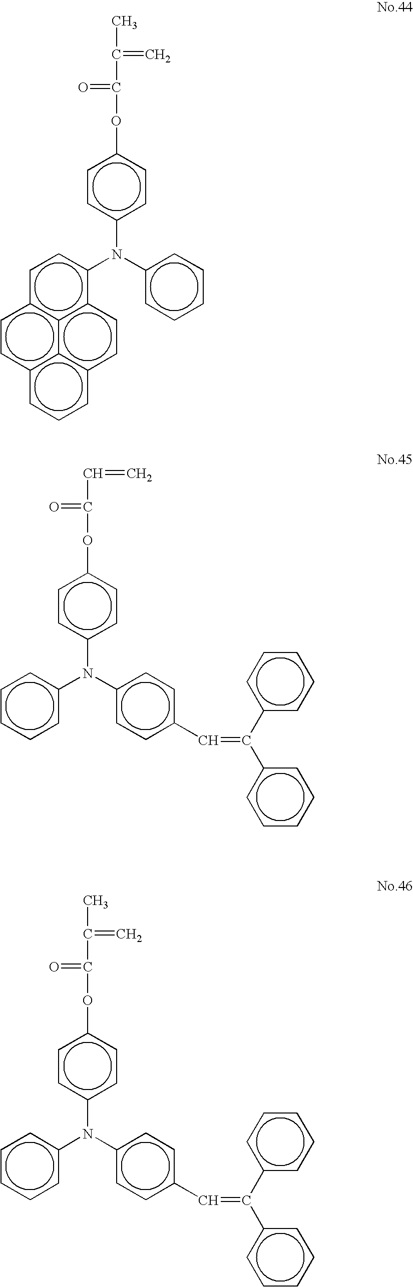

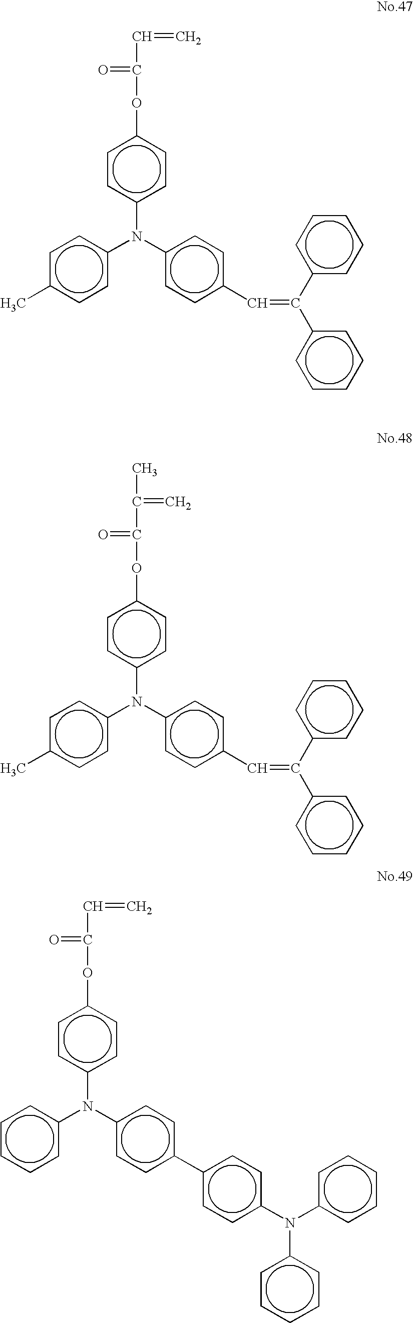

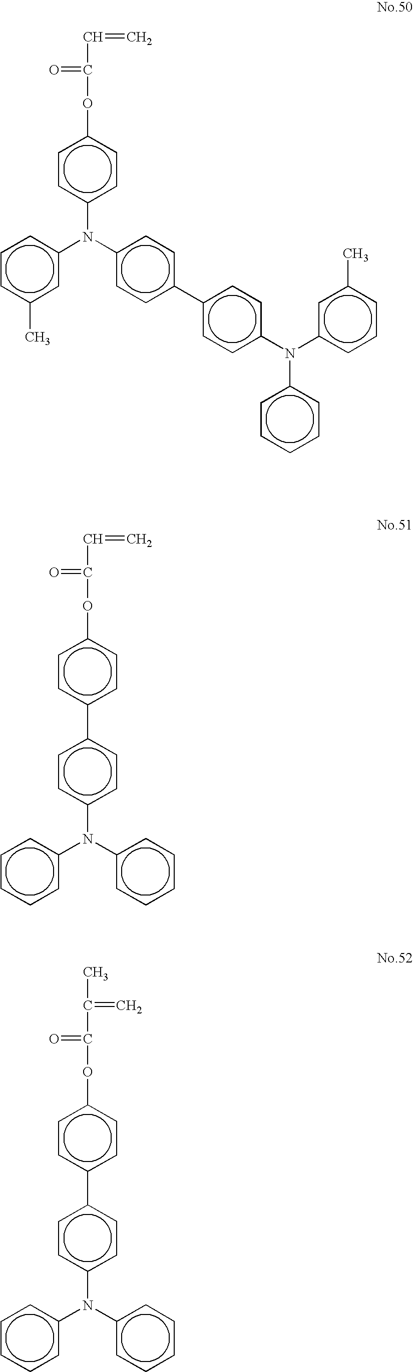

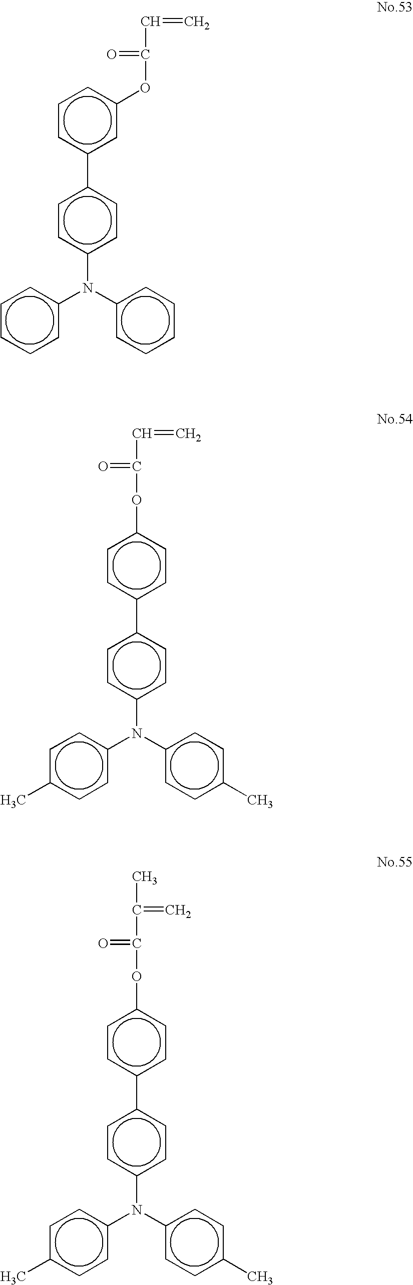

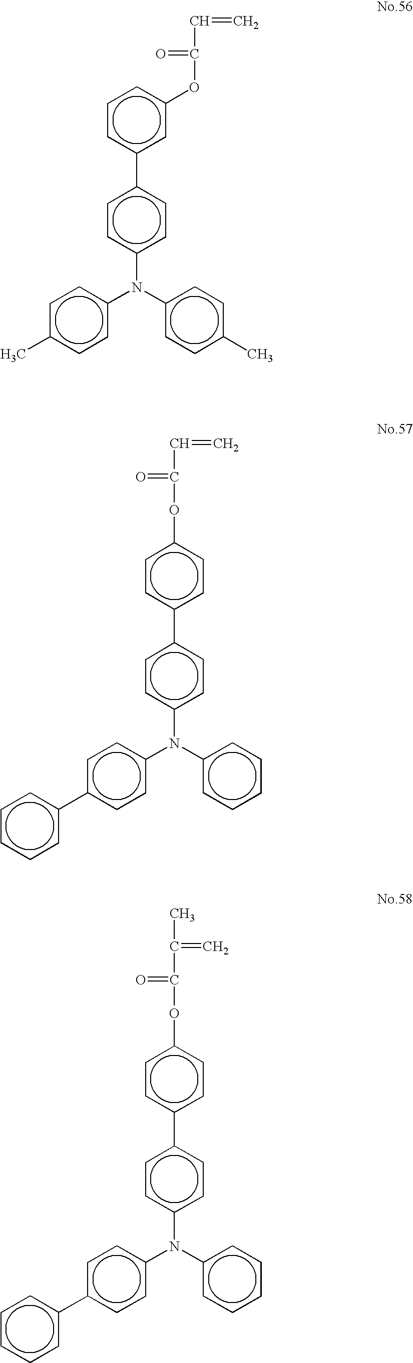

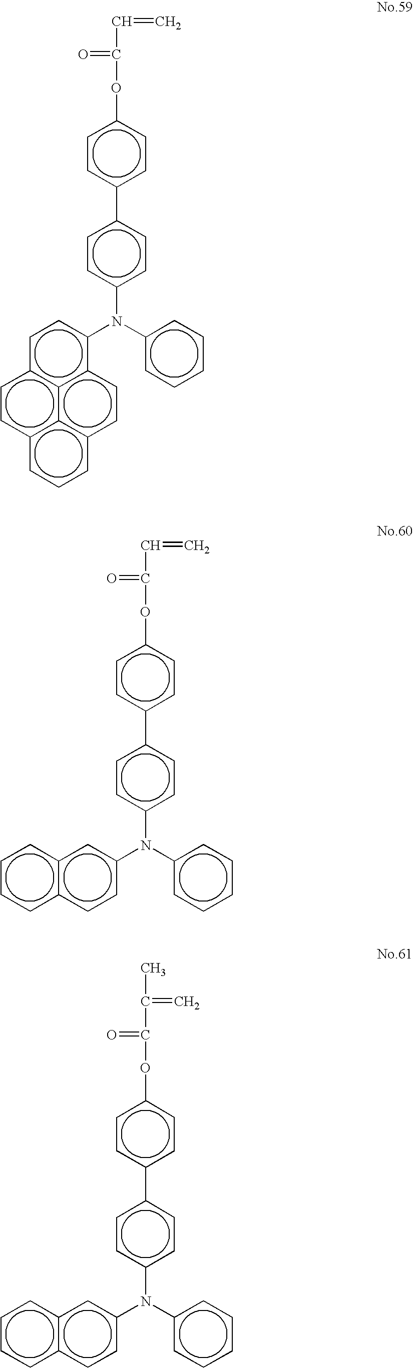

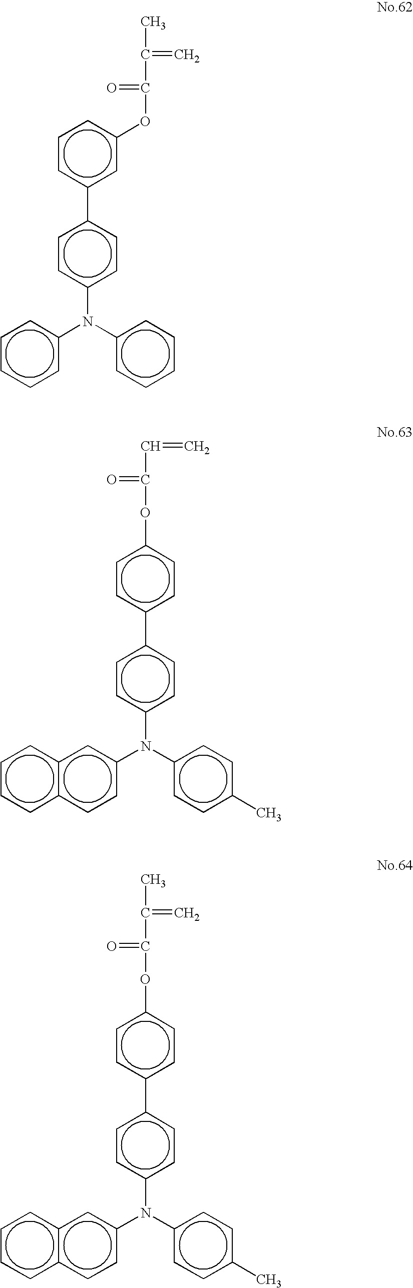

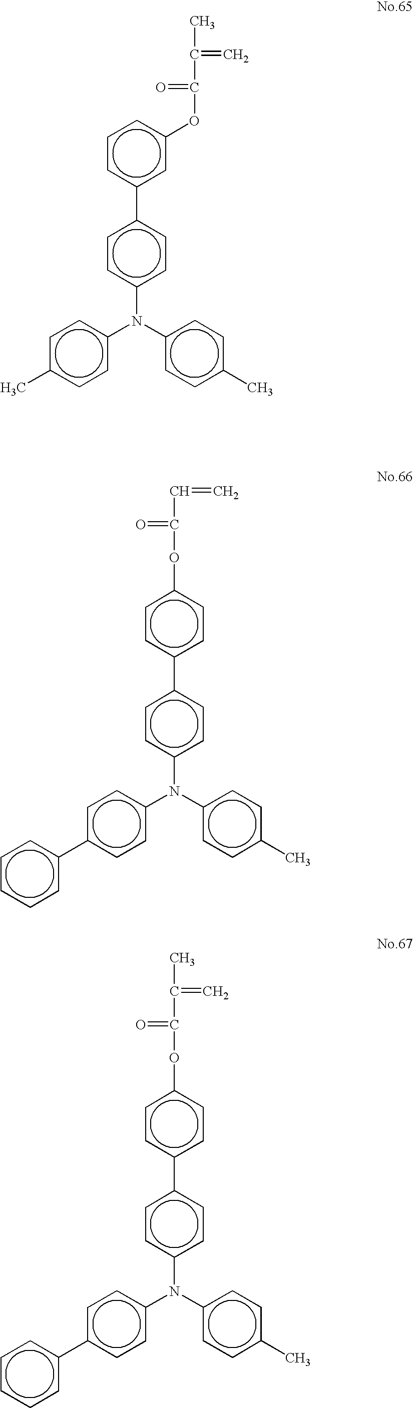

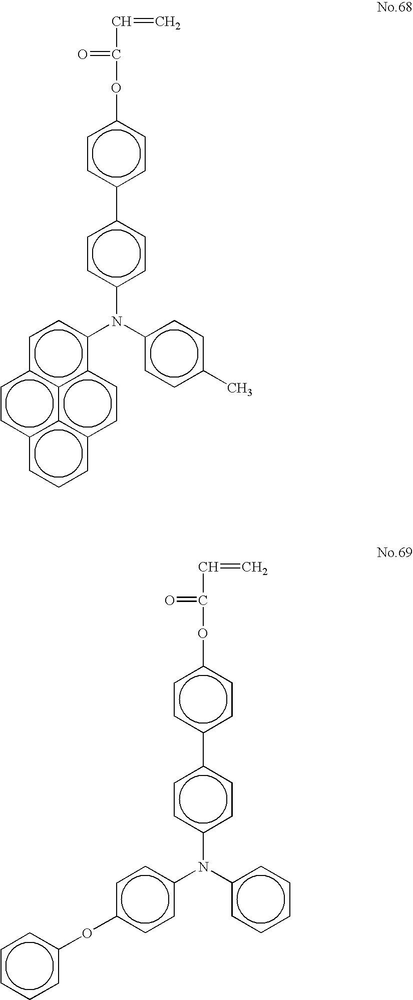

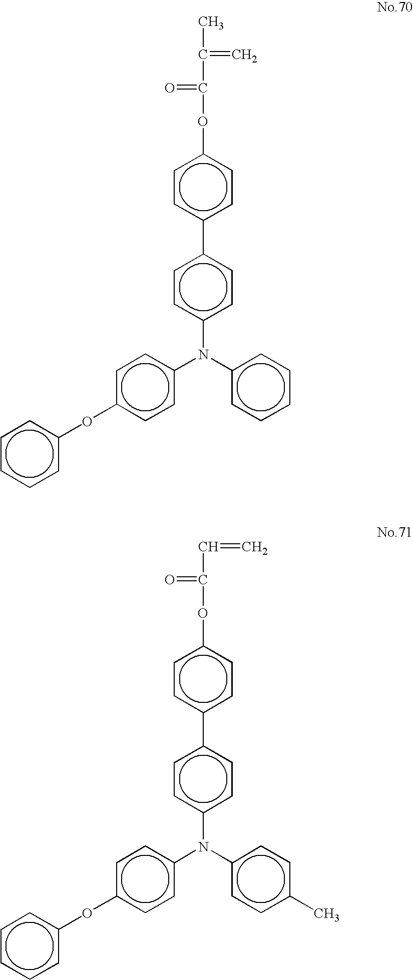

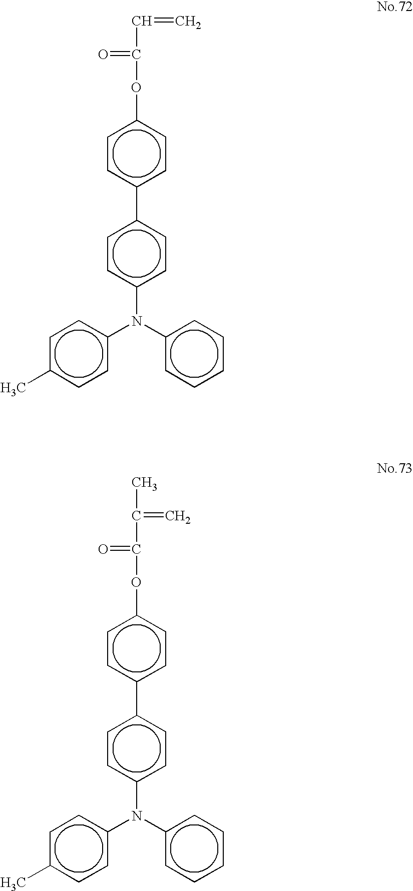

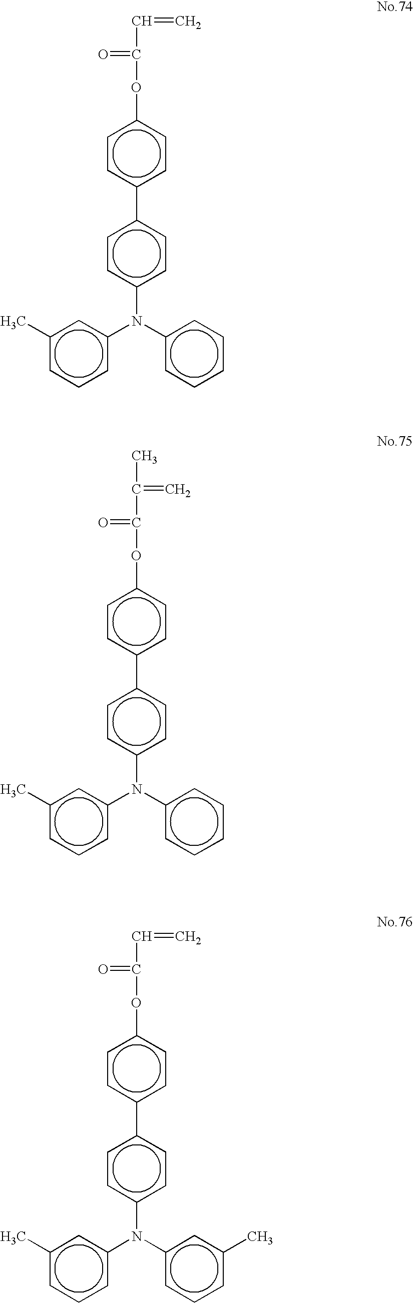

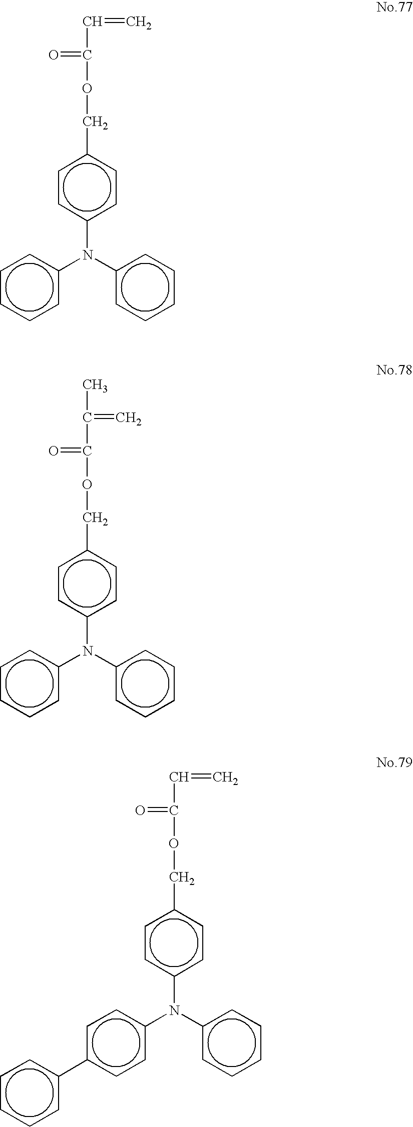

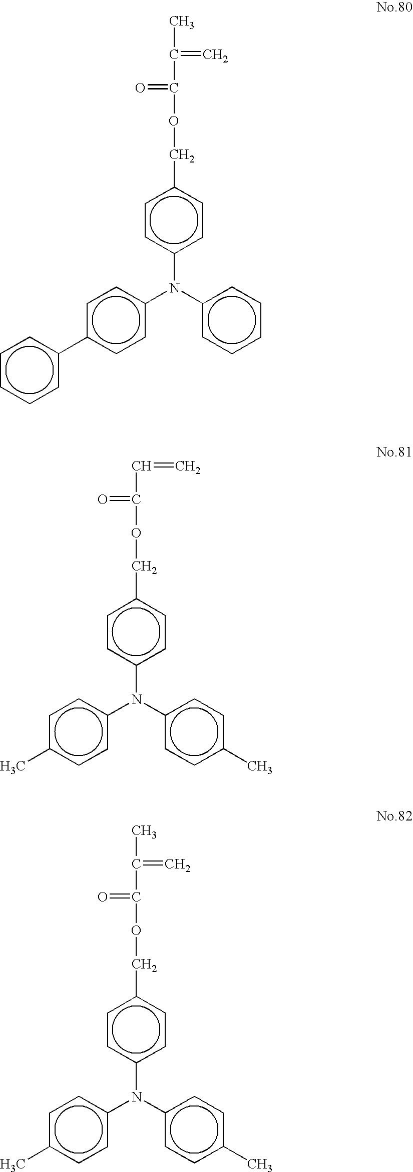

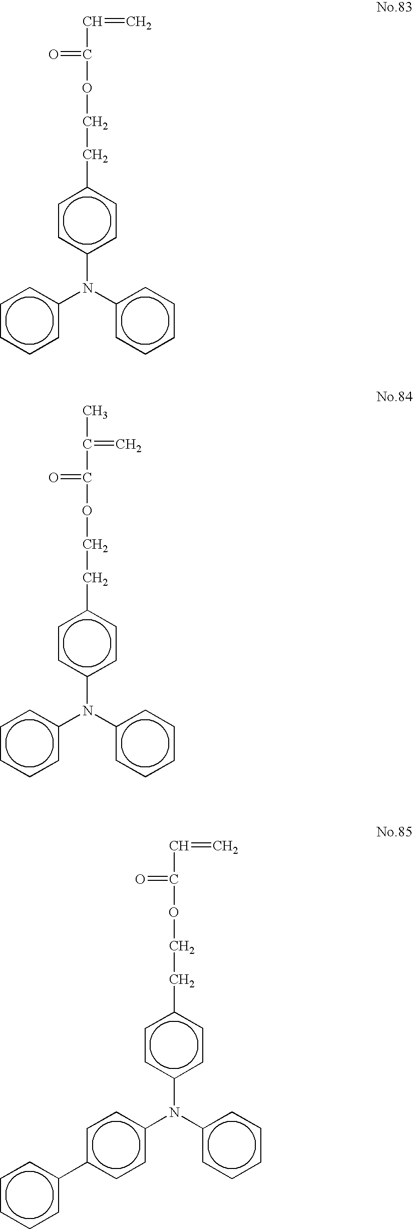

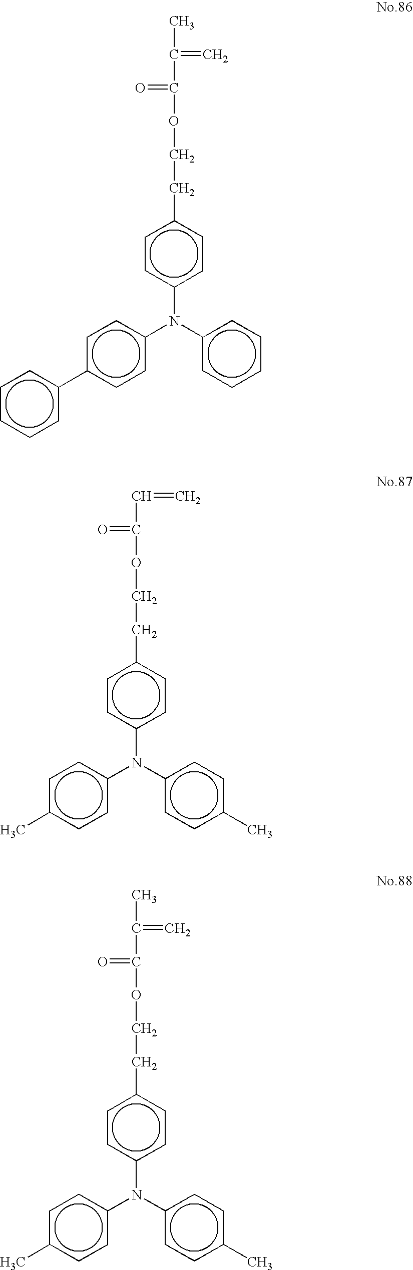

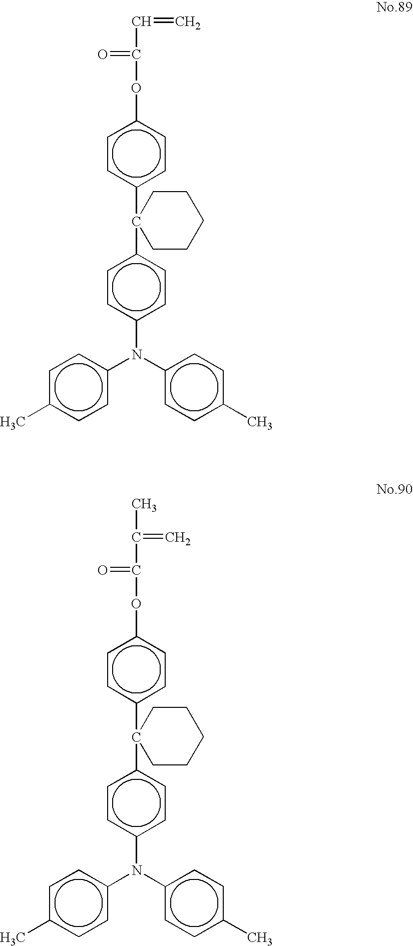

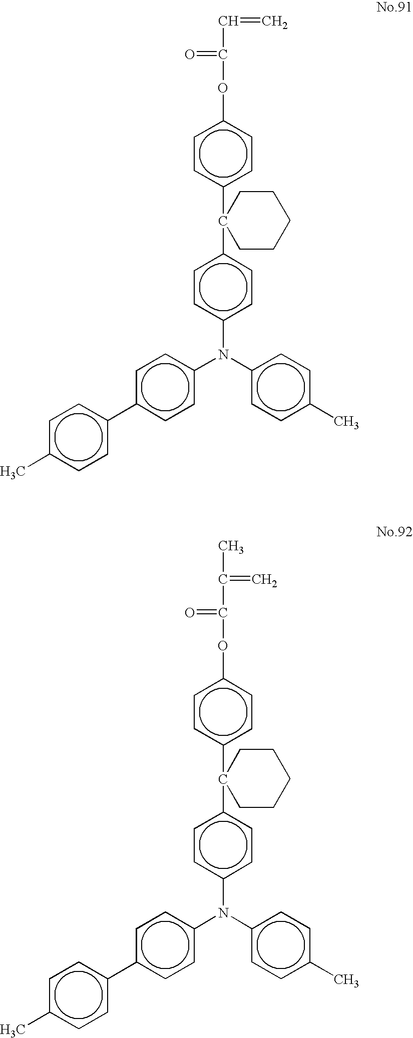

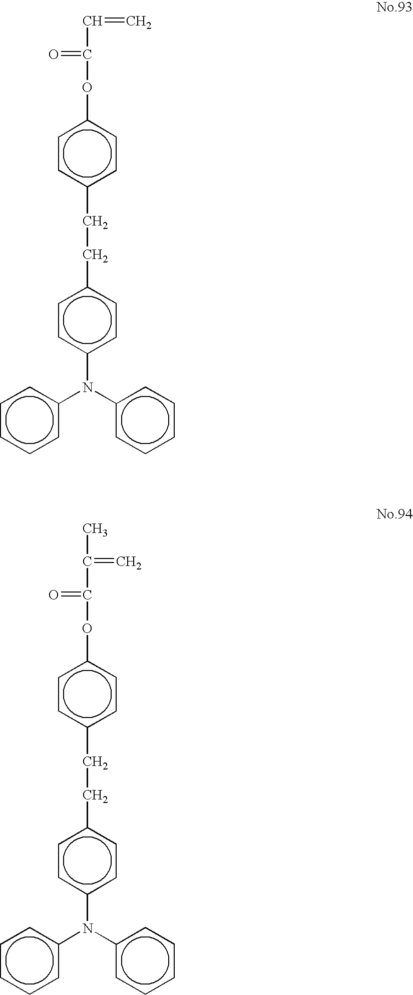

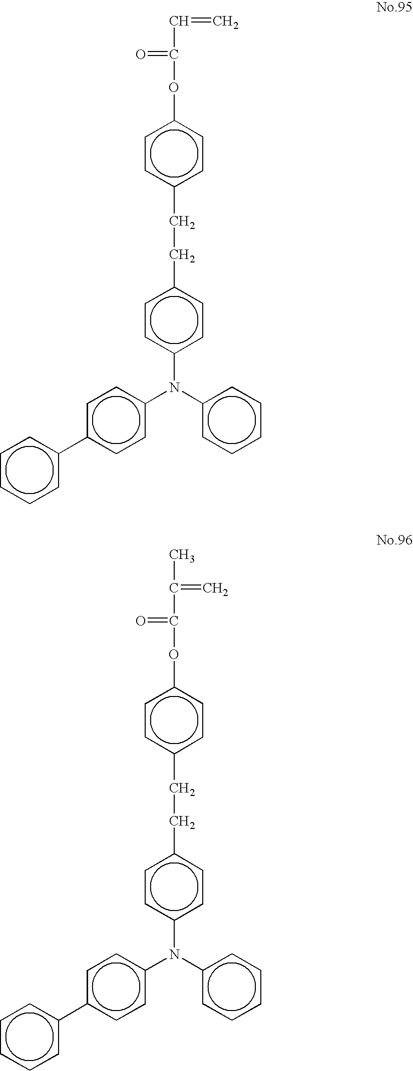

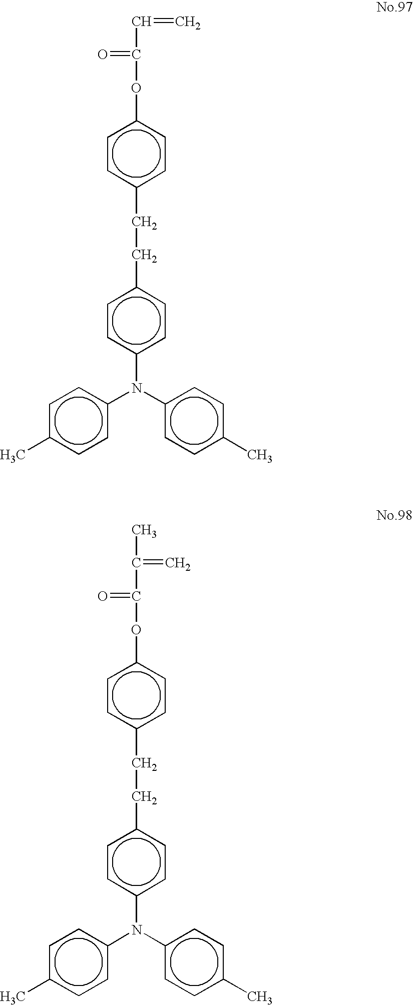

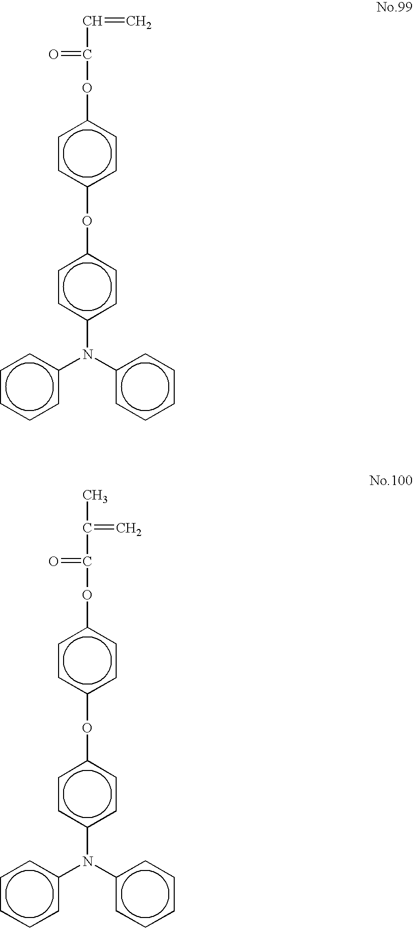

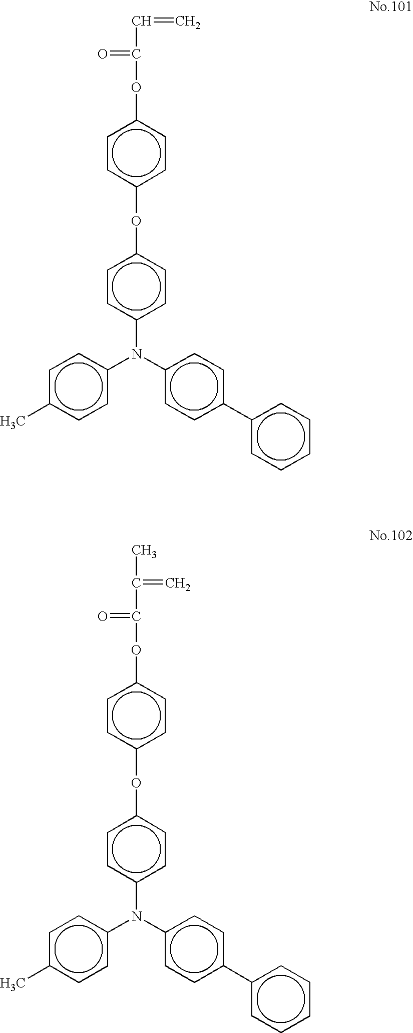

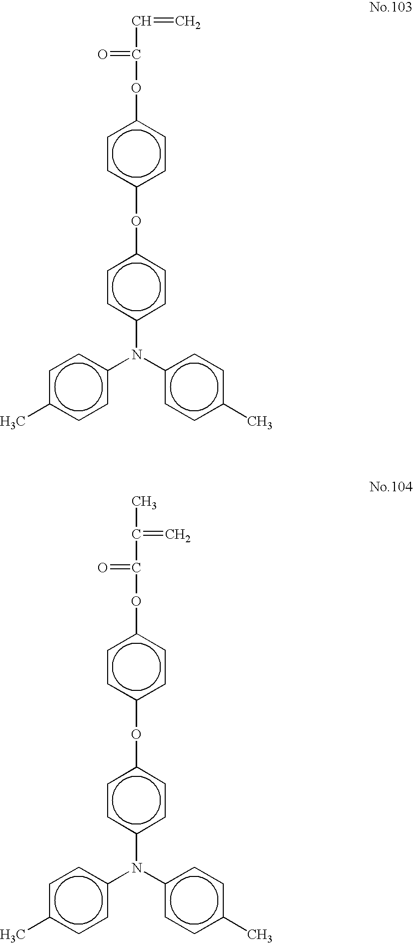

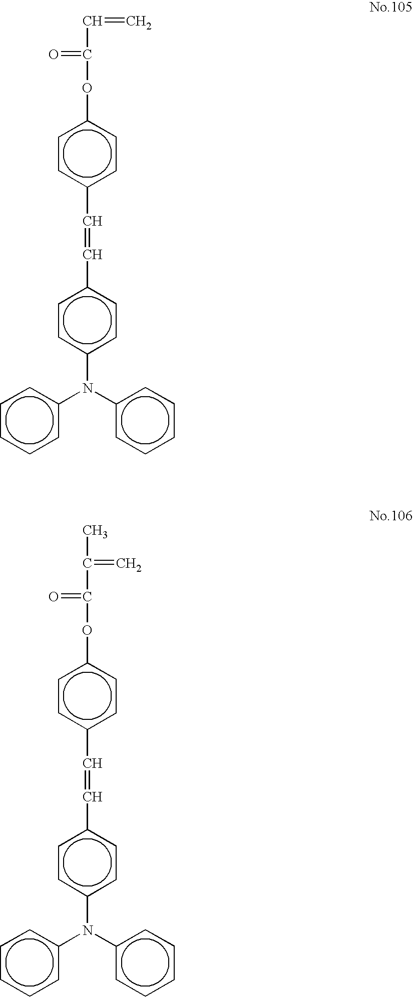

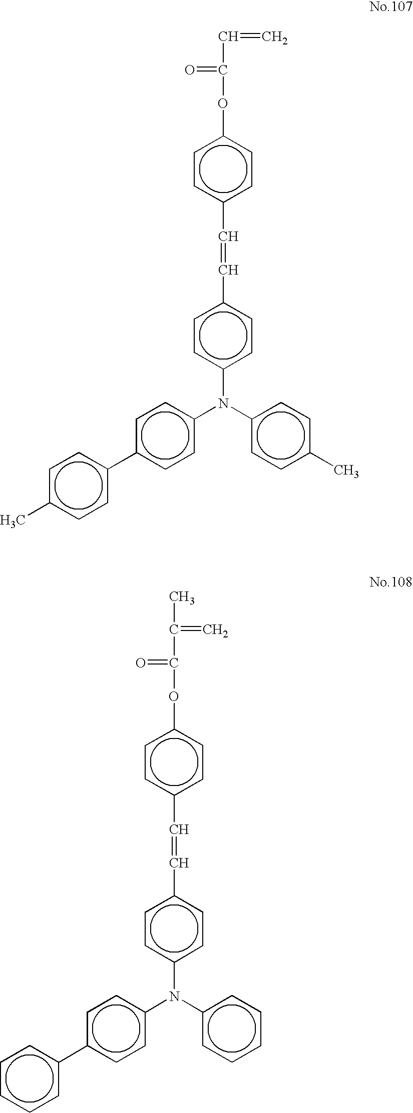

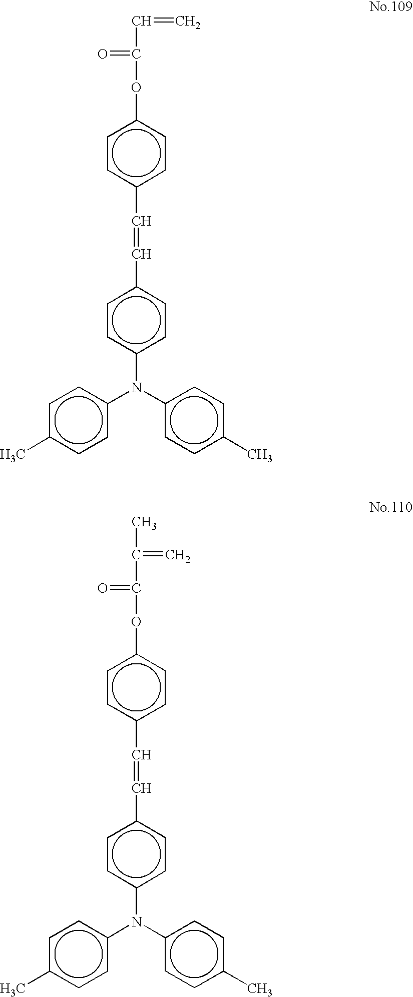

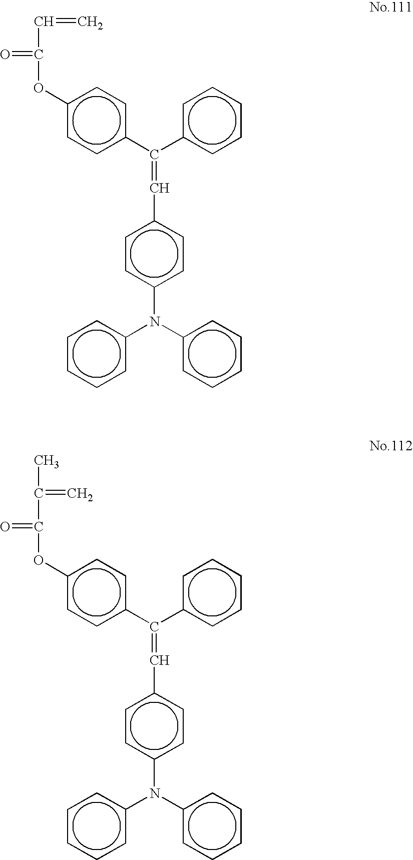

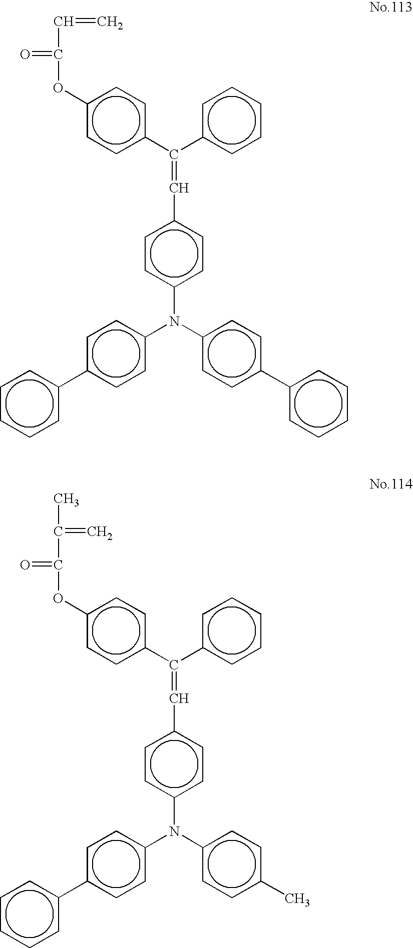

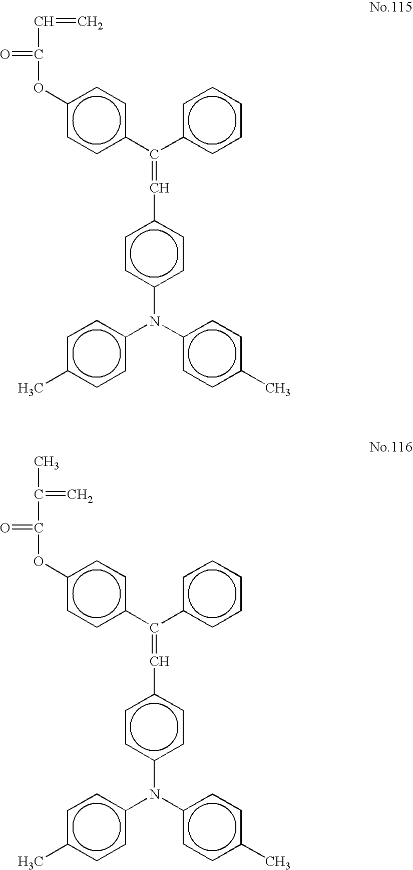

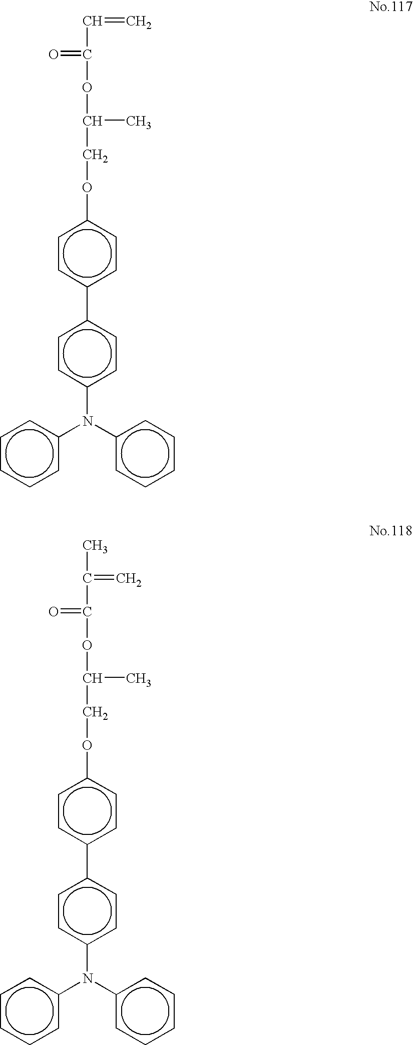

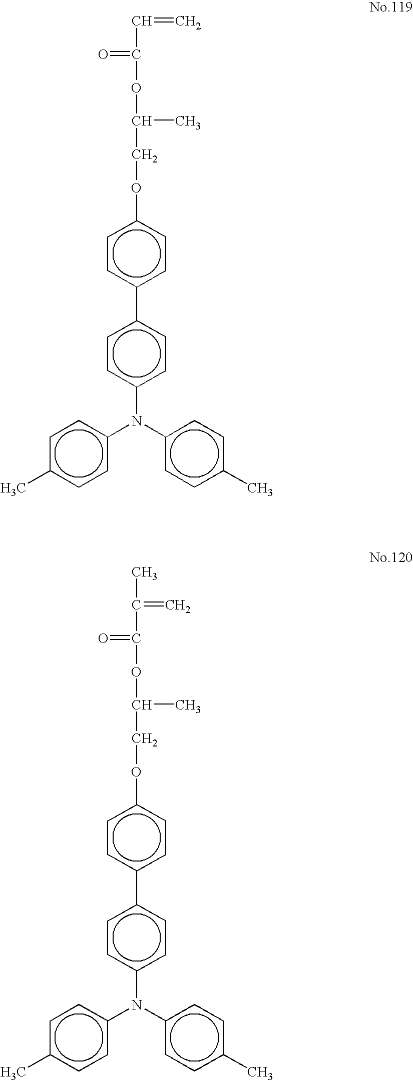

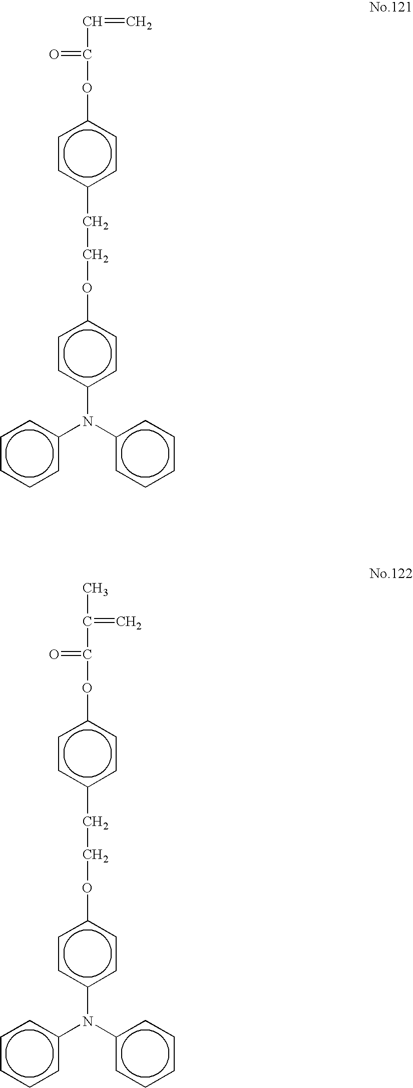

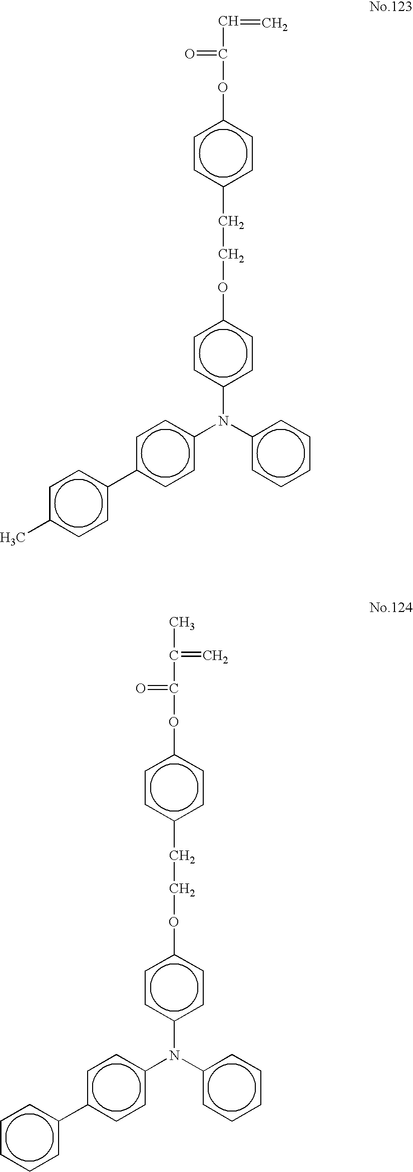

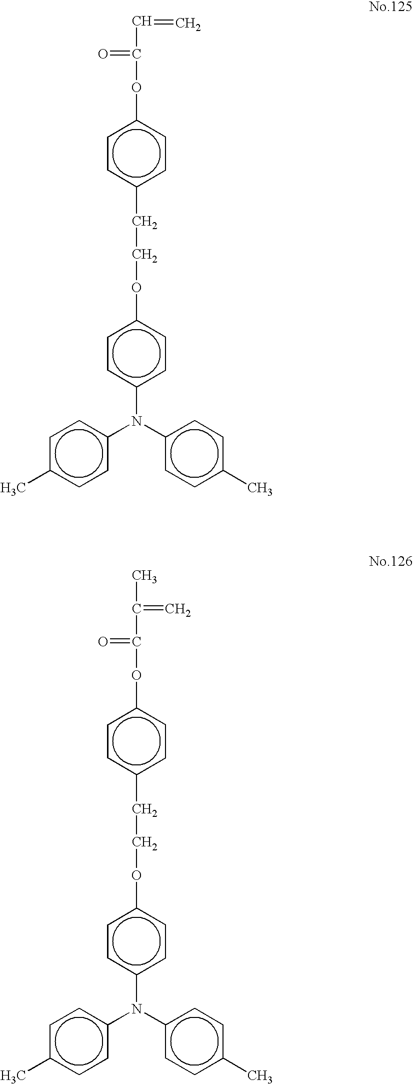

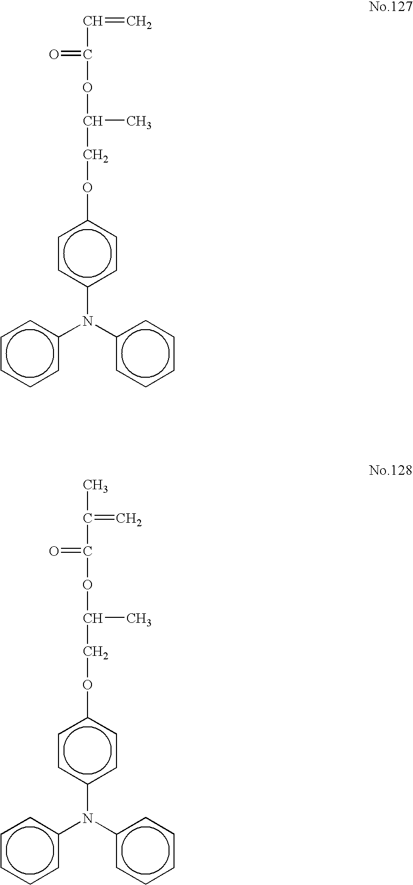

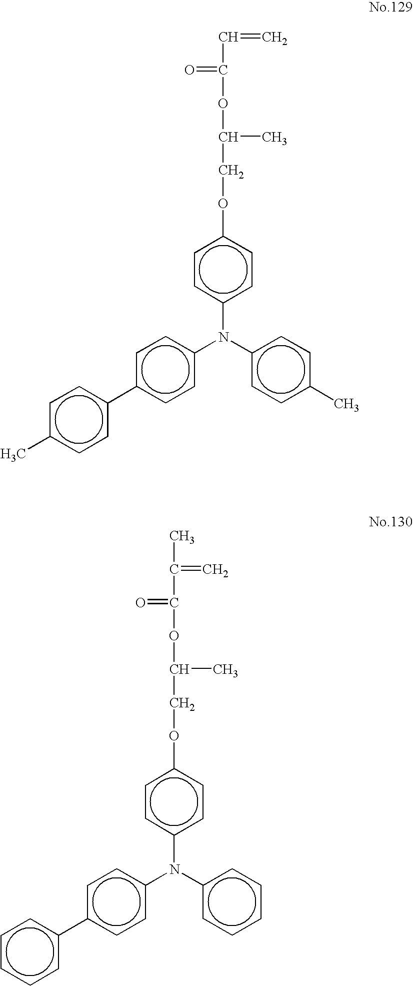

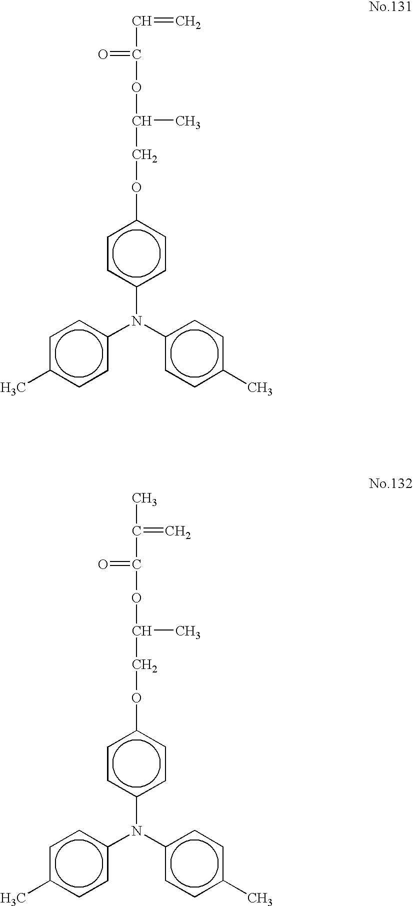

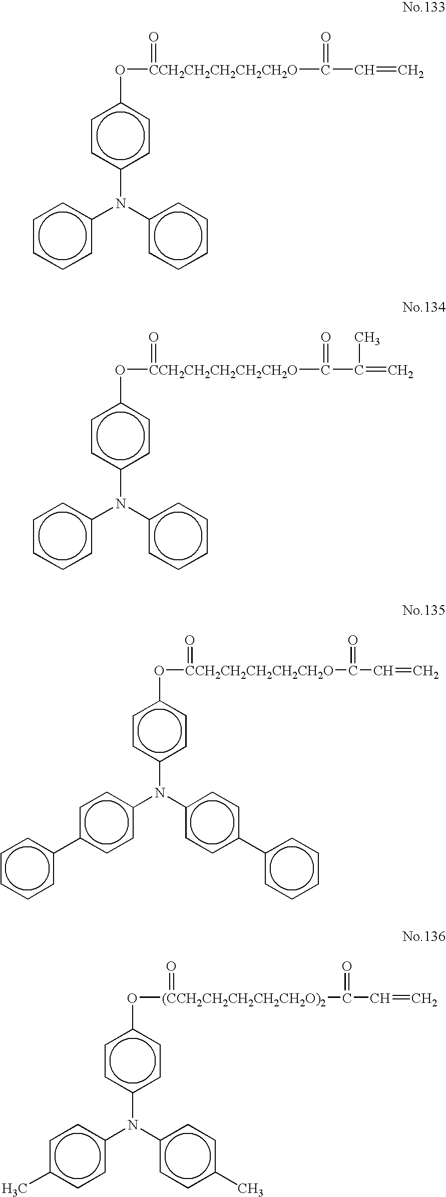

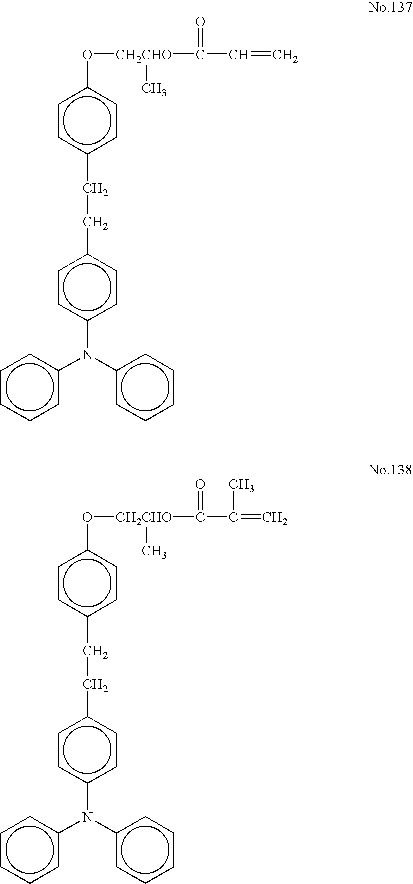

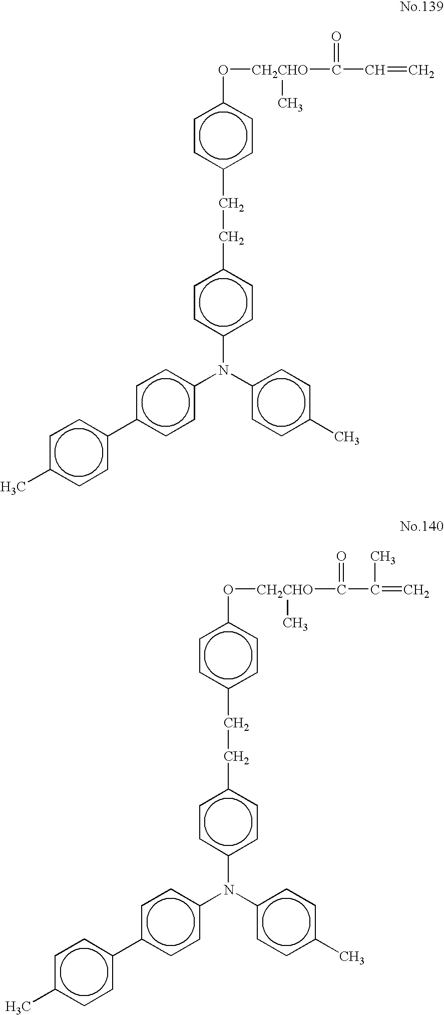

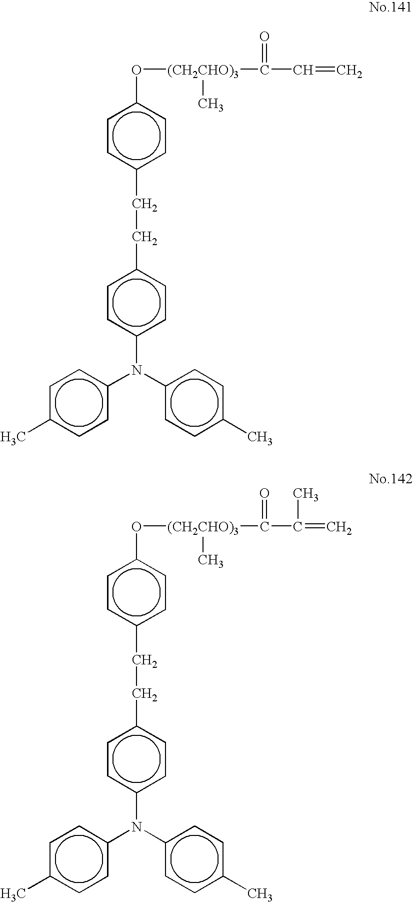

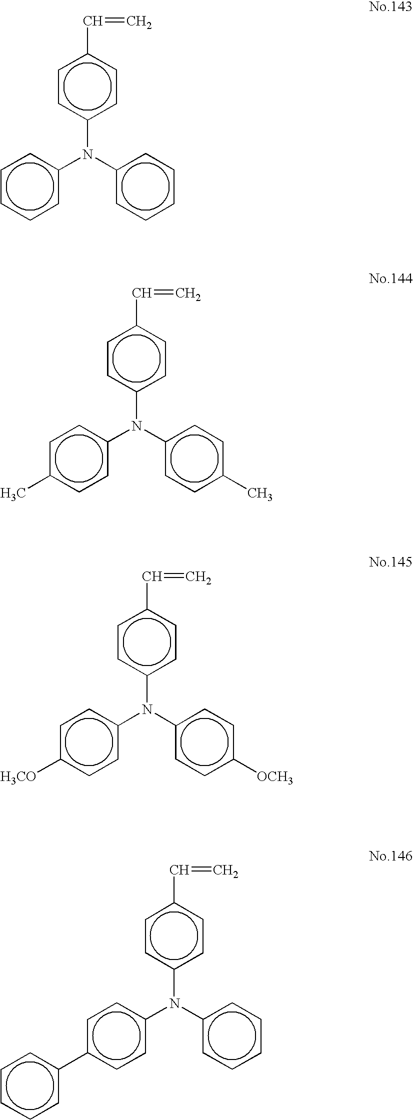

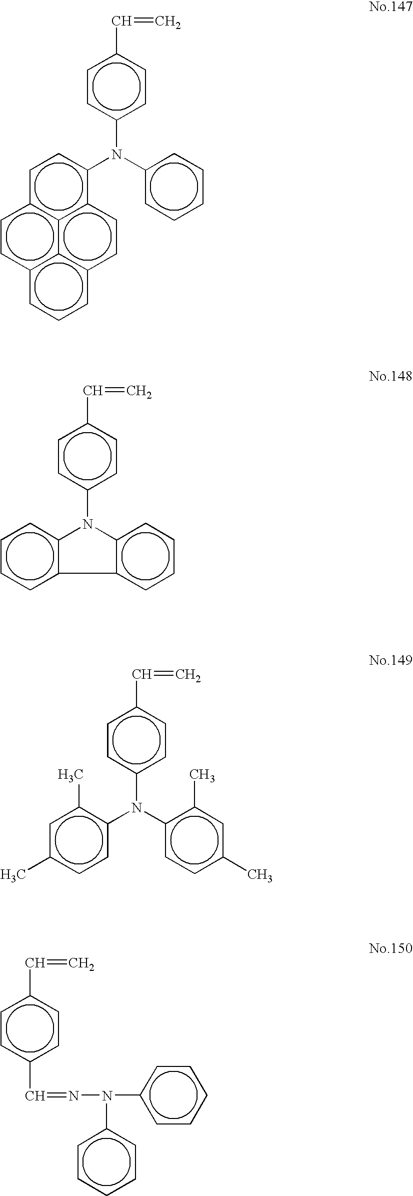

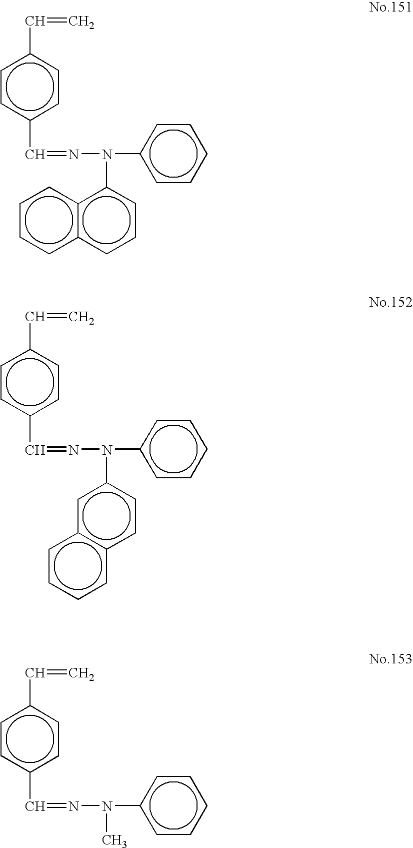

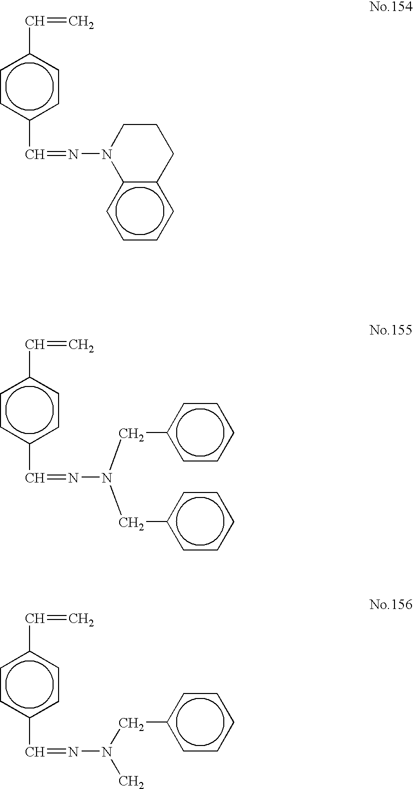

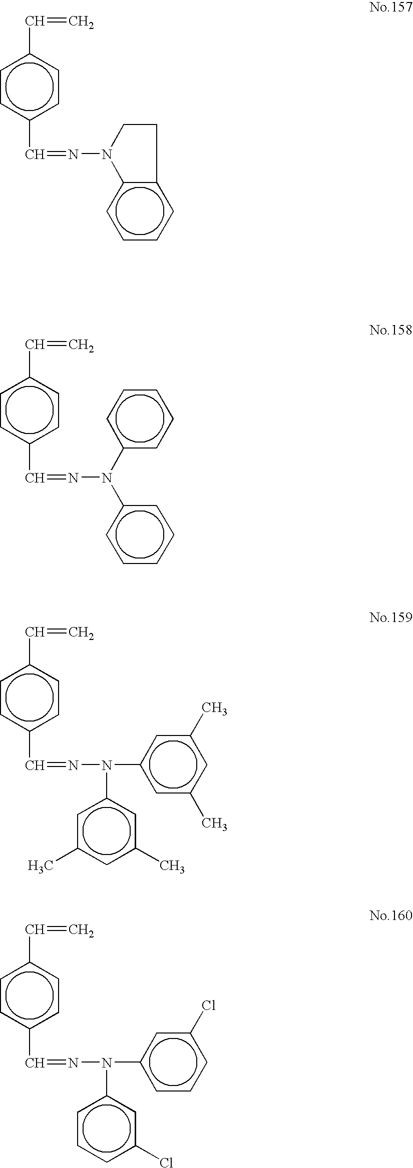

Specific examples of the radical polymerizable compounds having two functional groups with a charge transport structure include, but are not limited to, include the following:

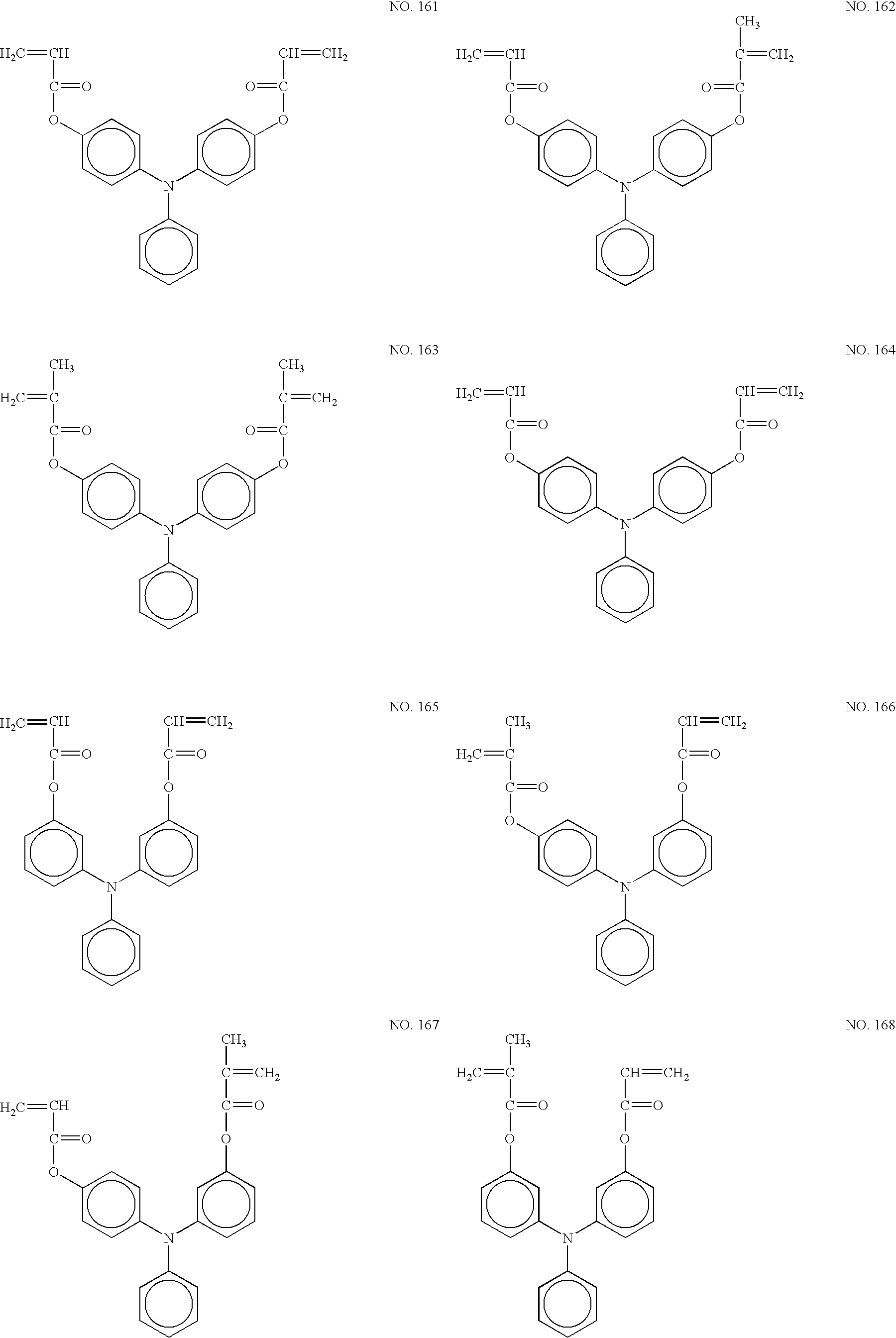

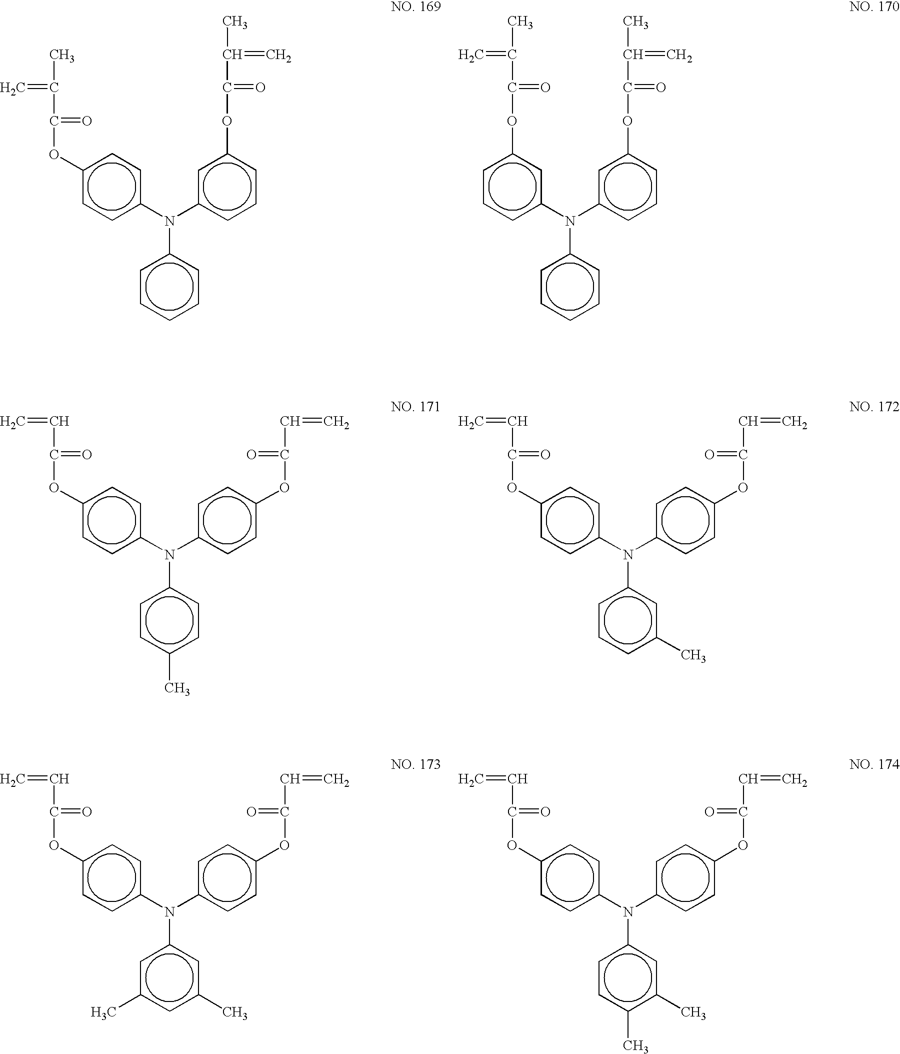

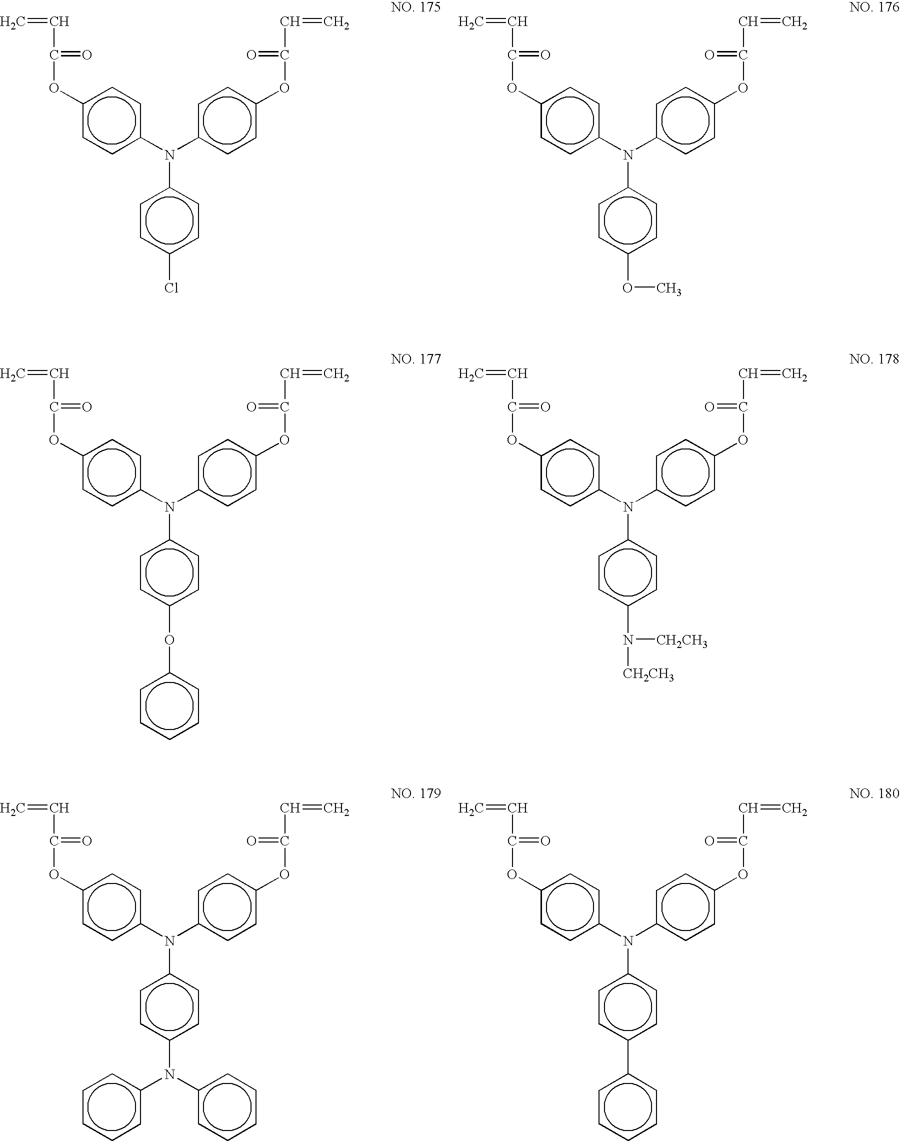

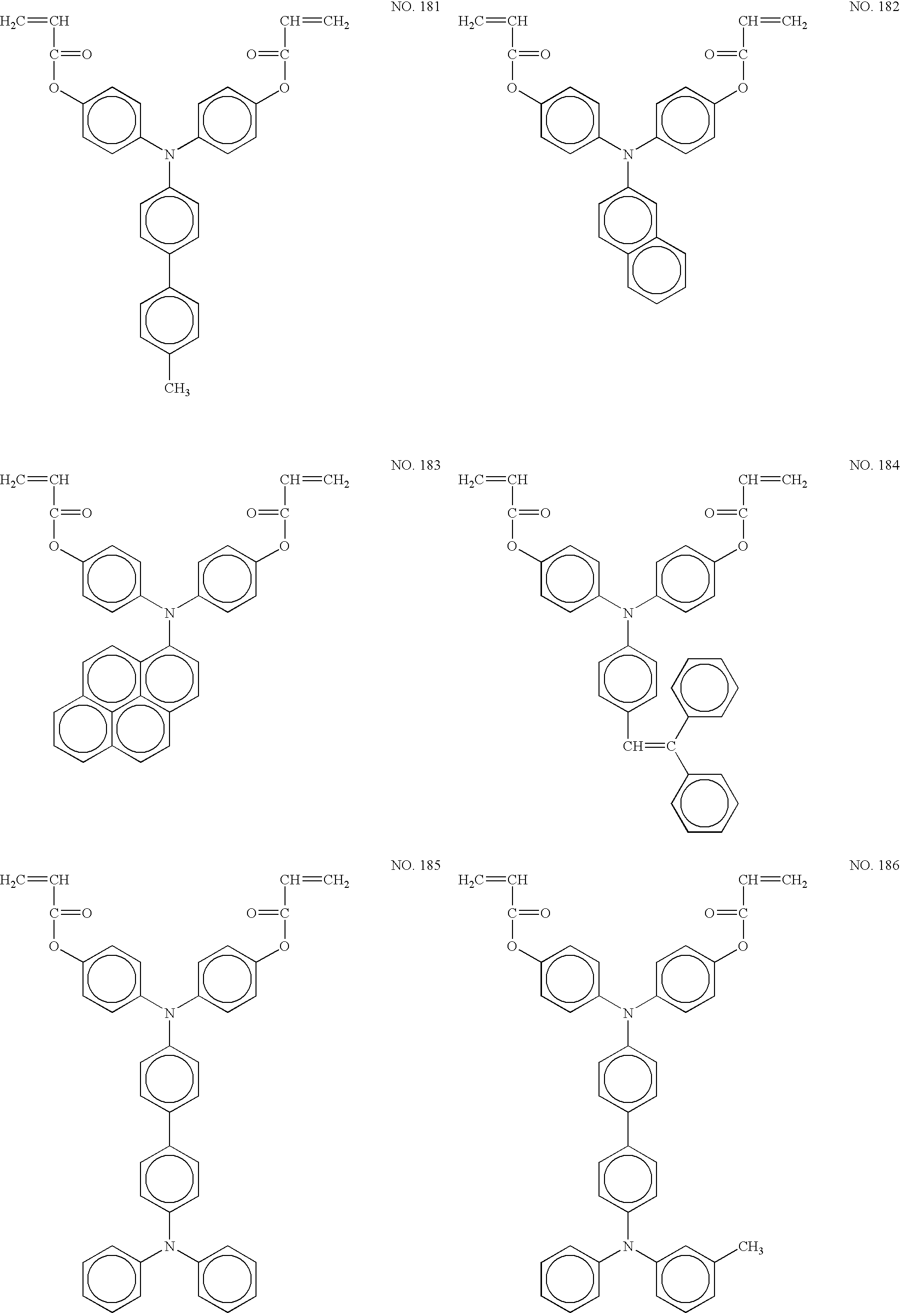

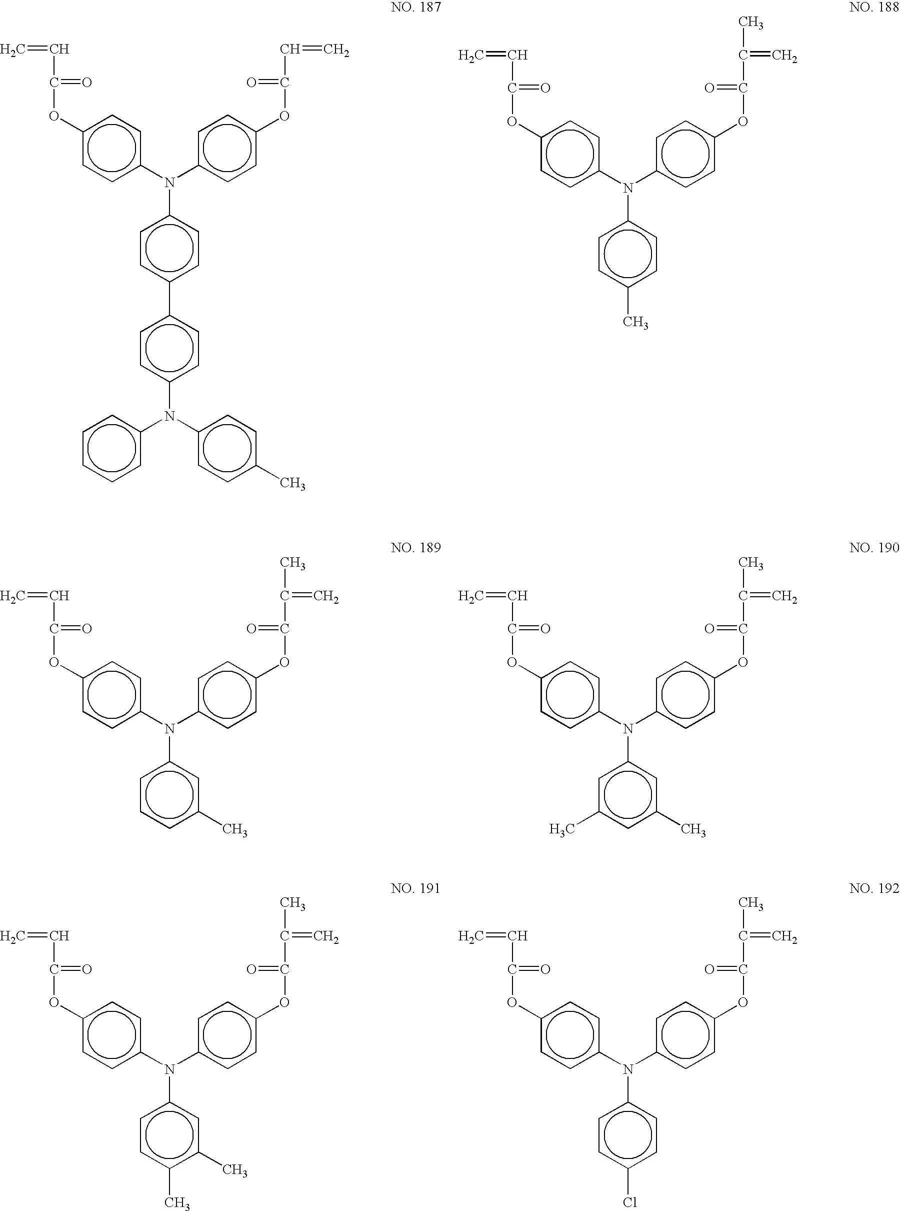

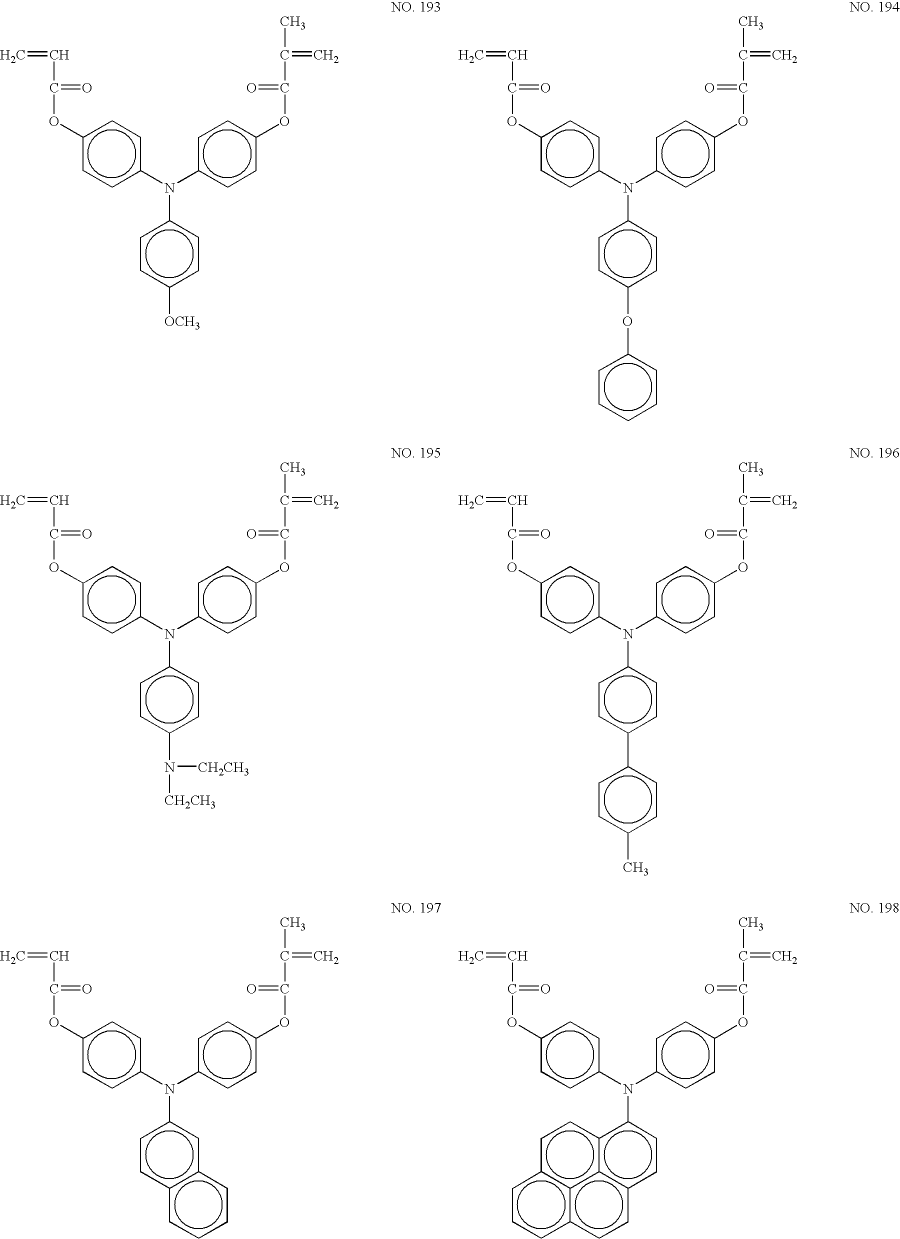

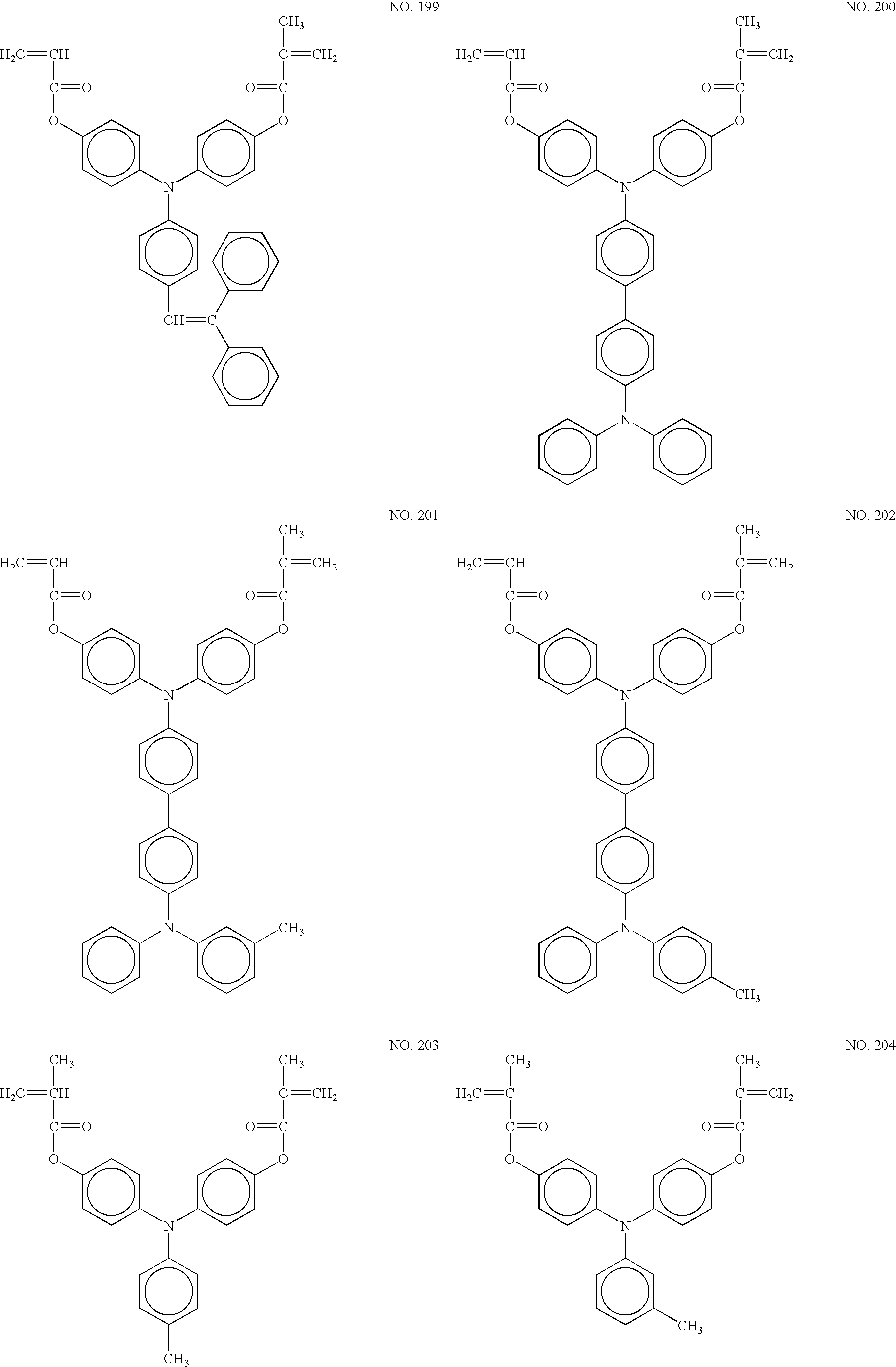

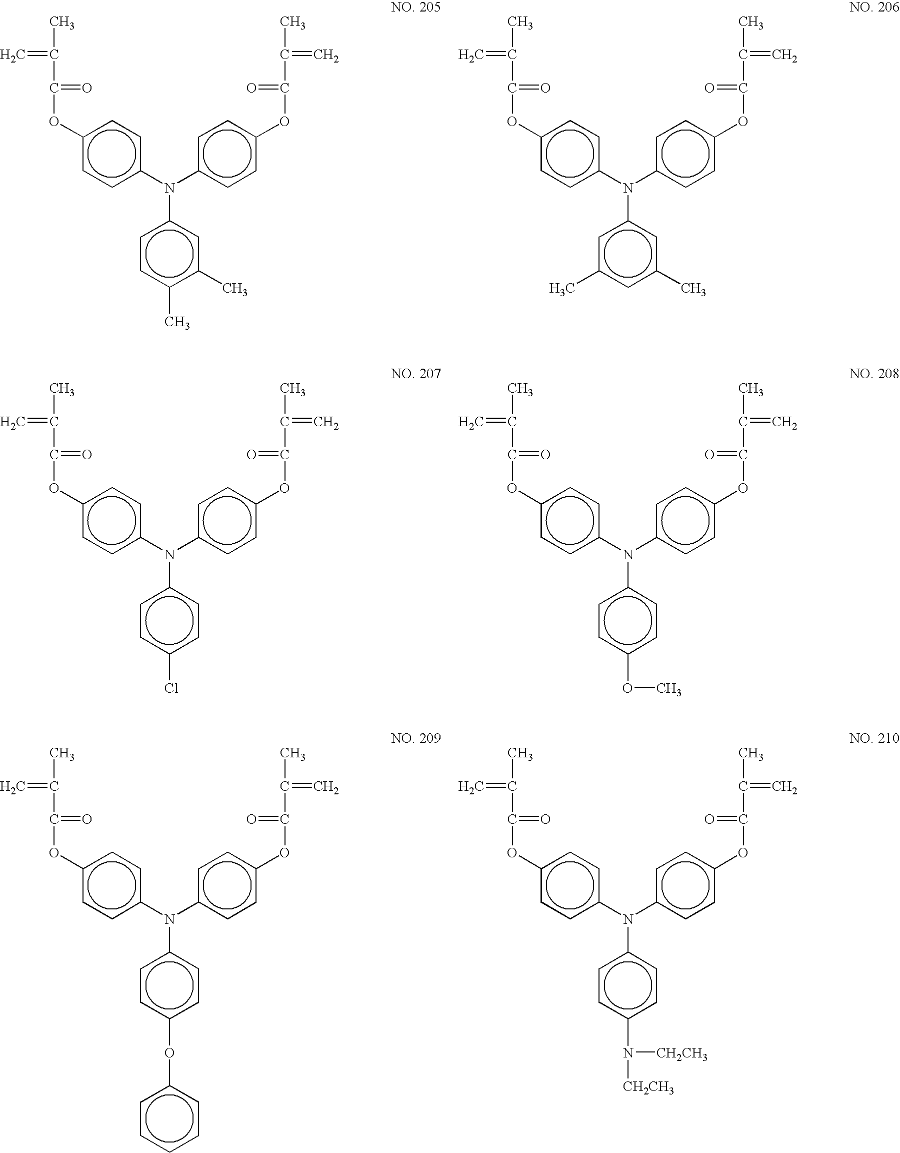

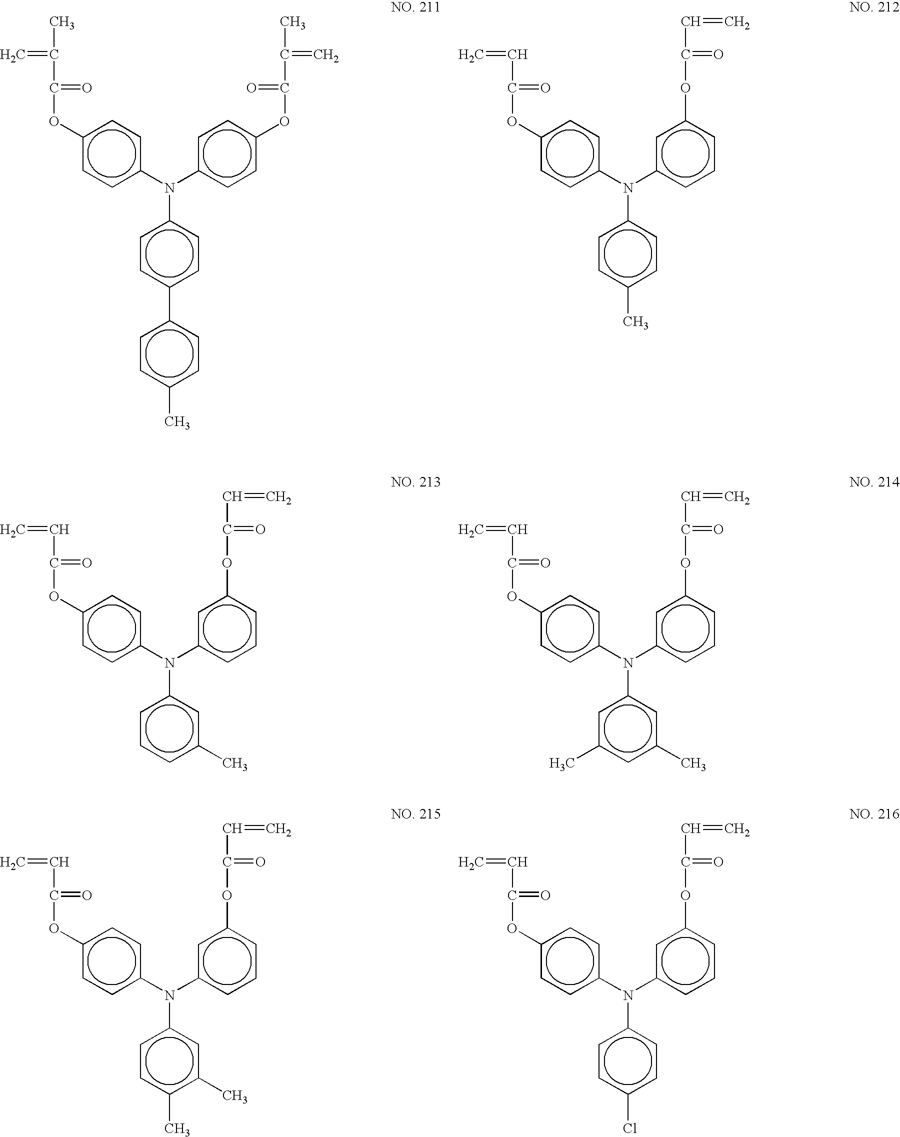

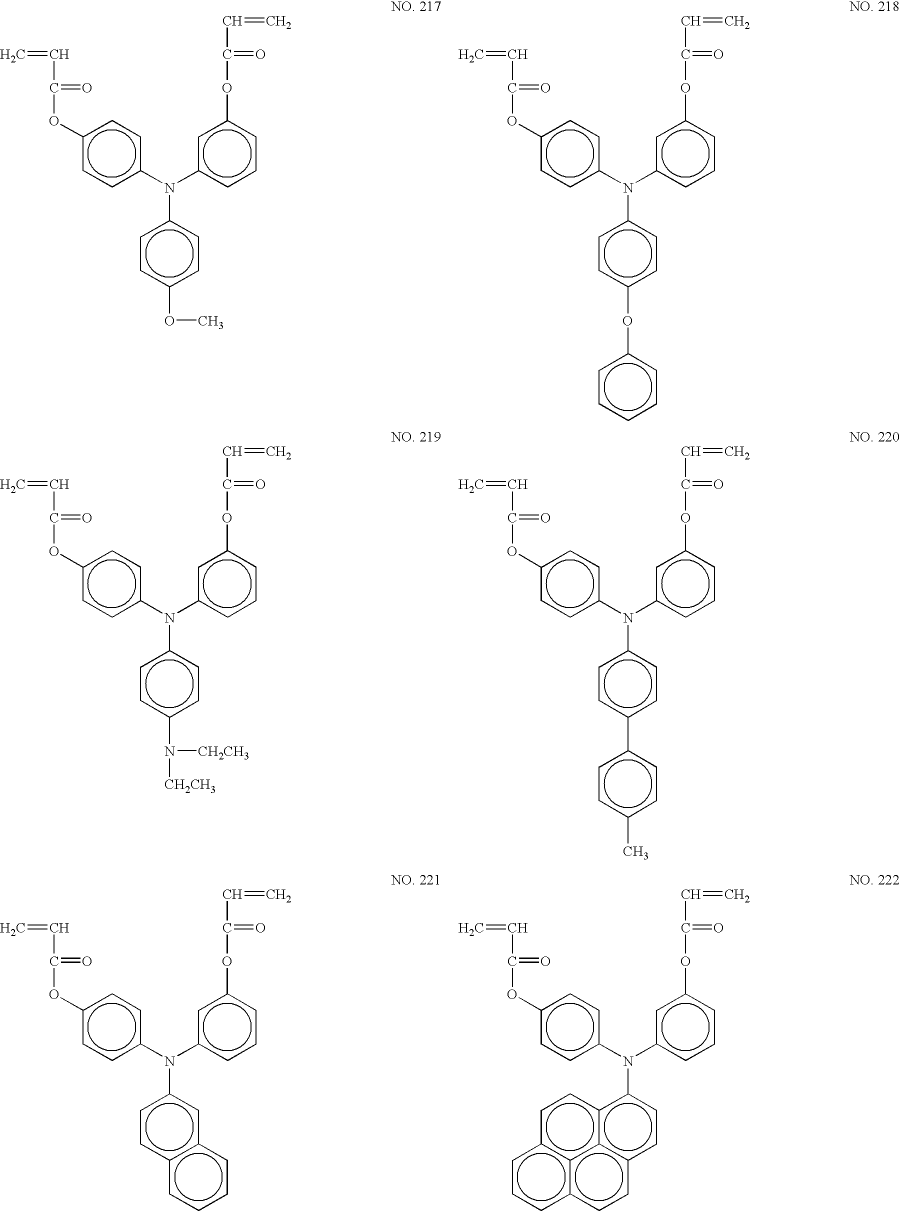

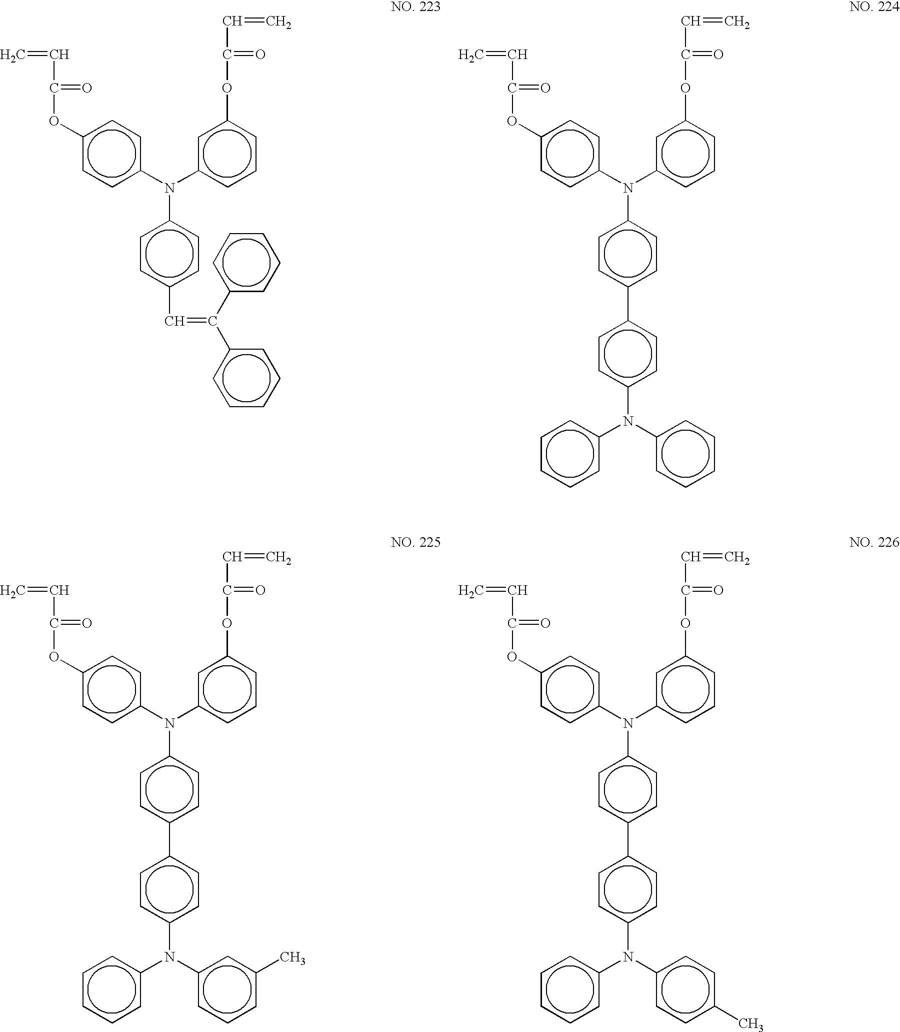

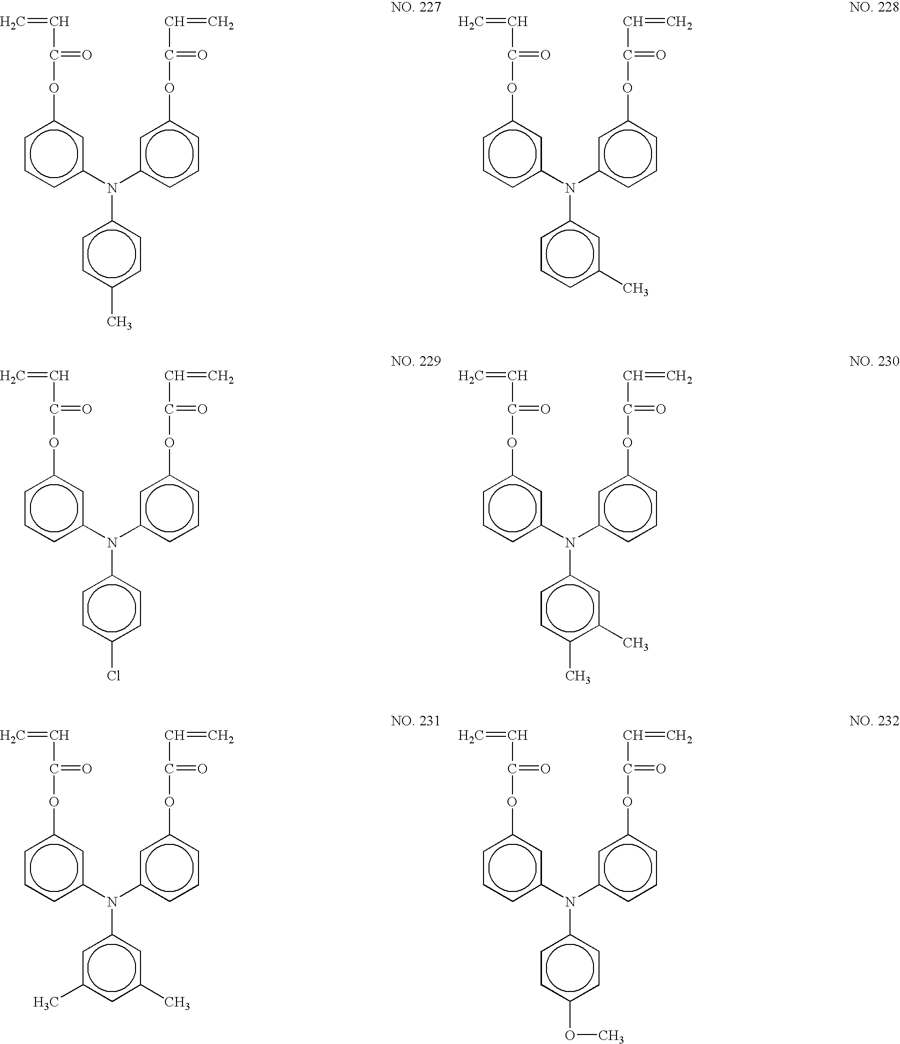

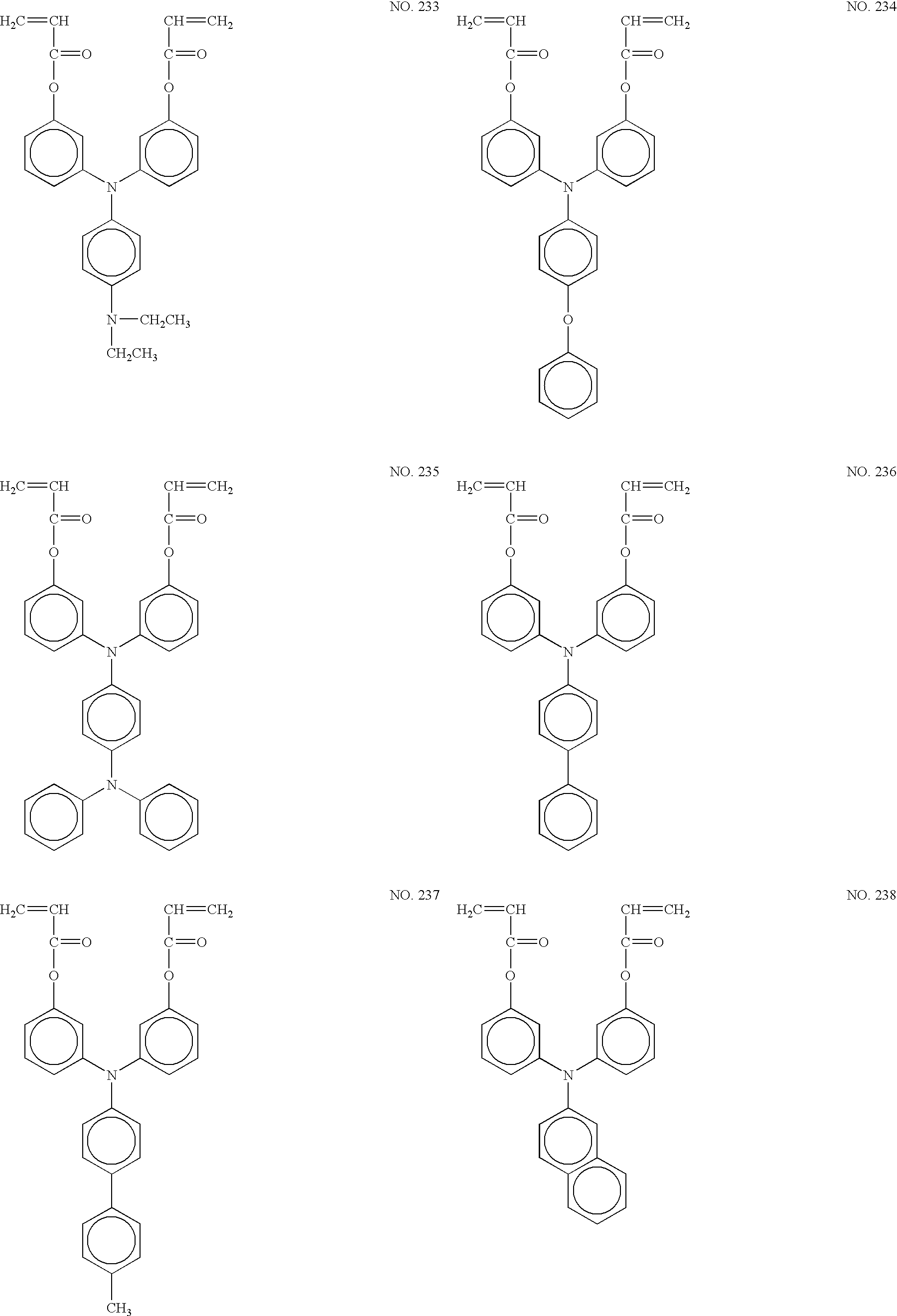

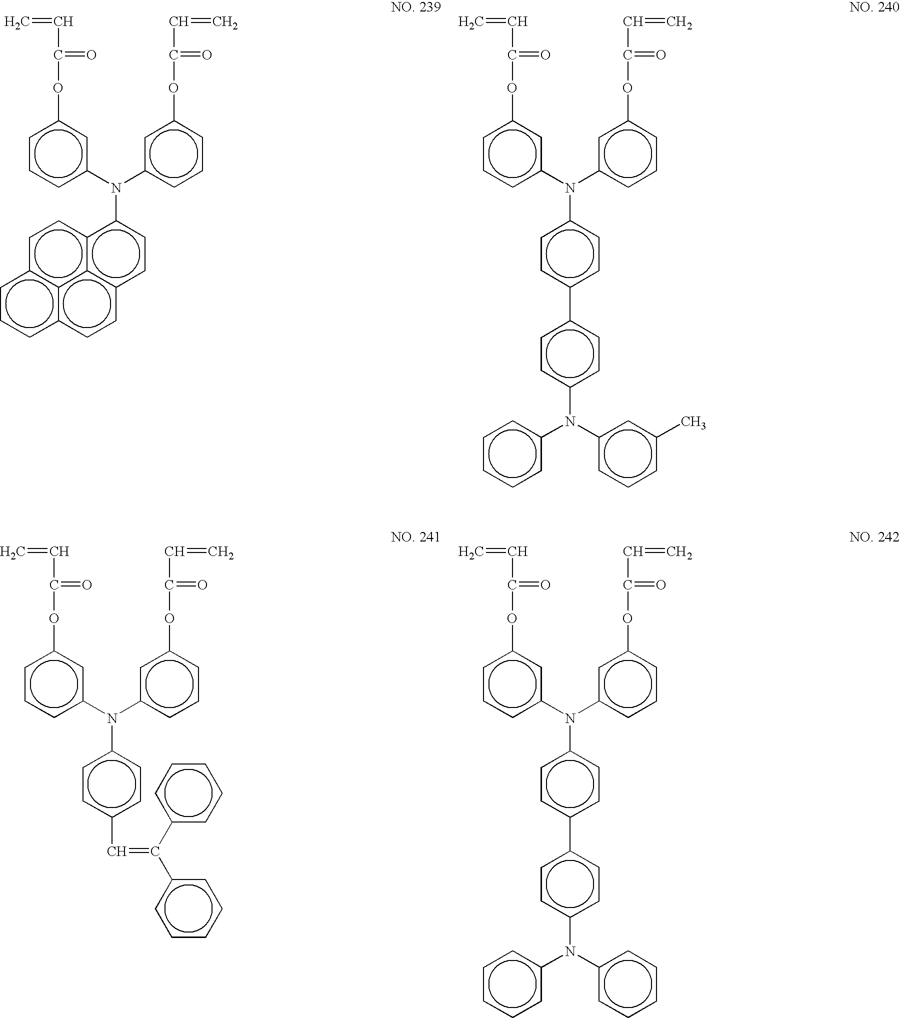

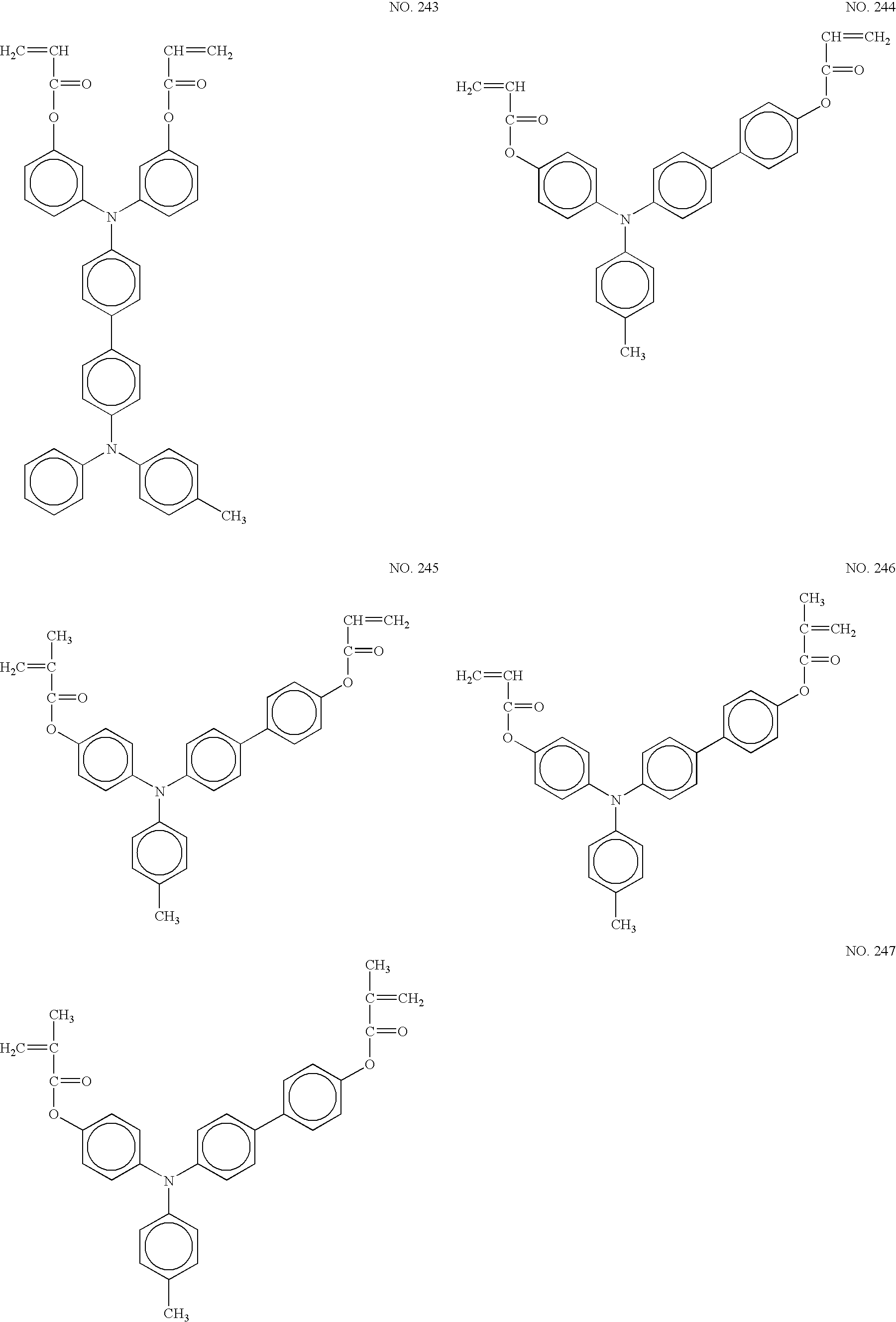

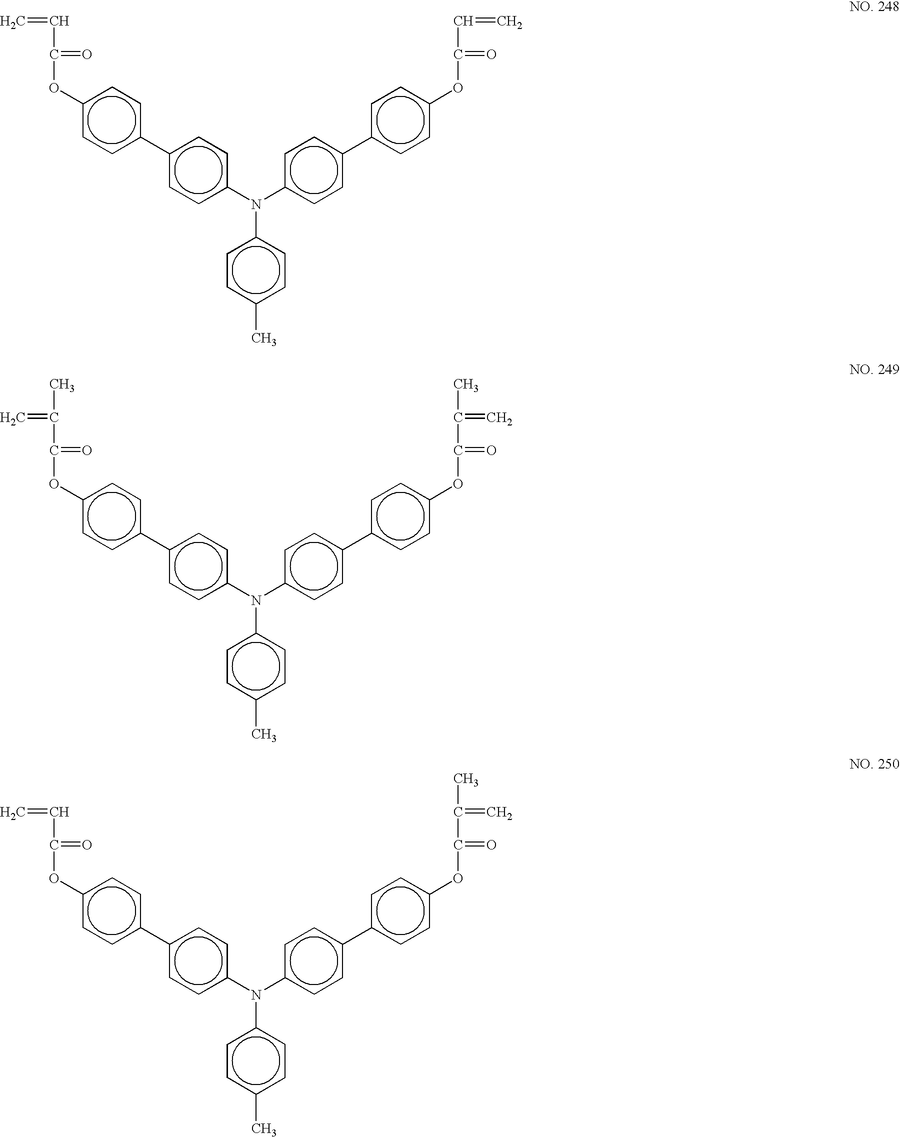

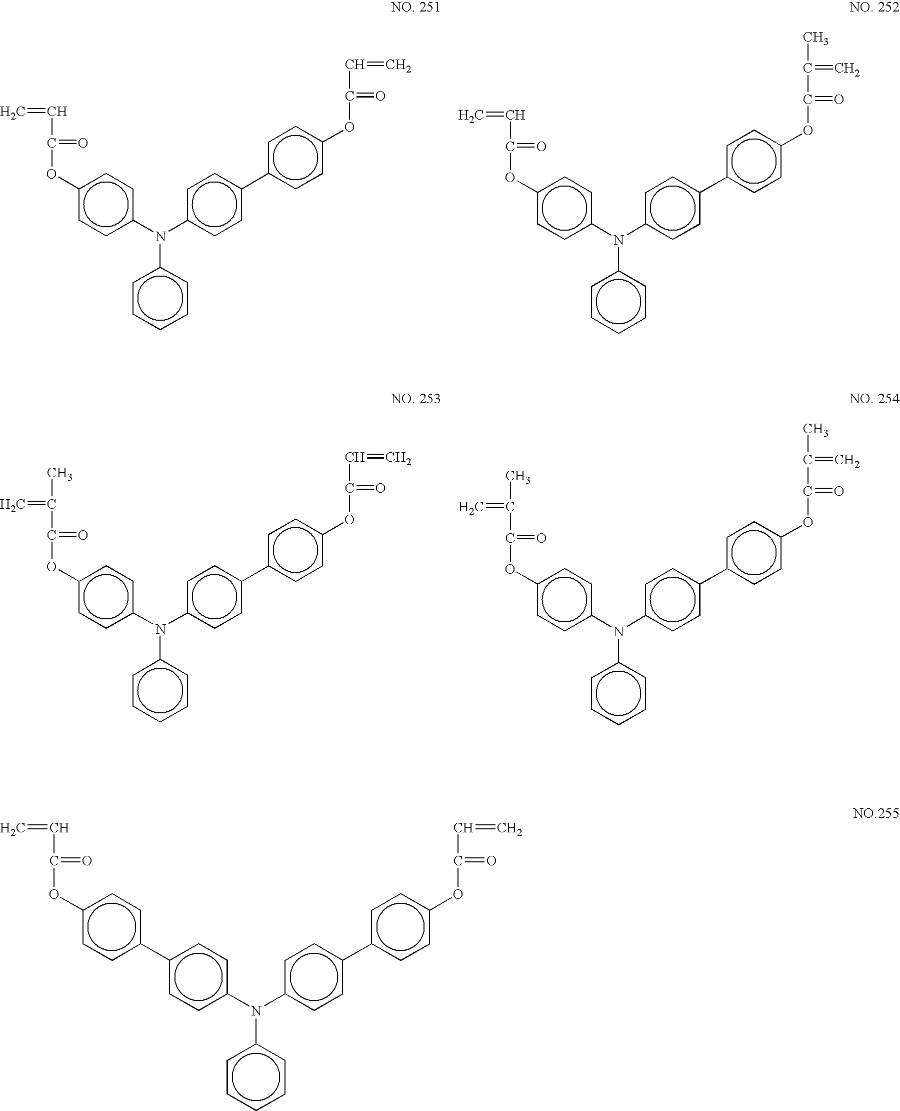

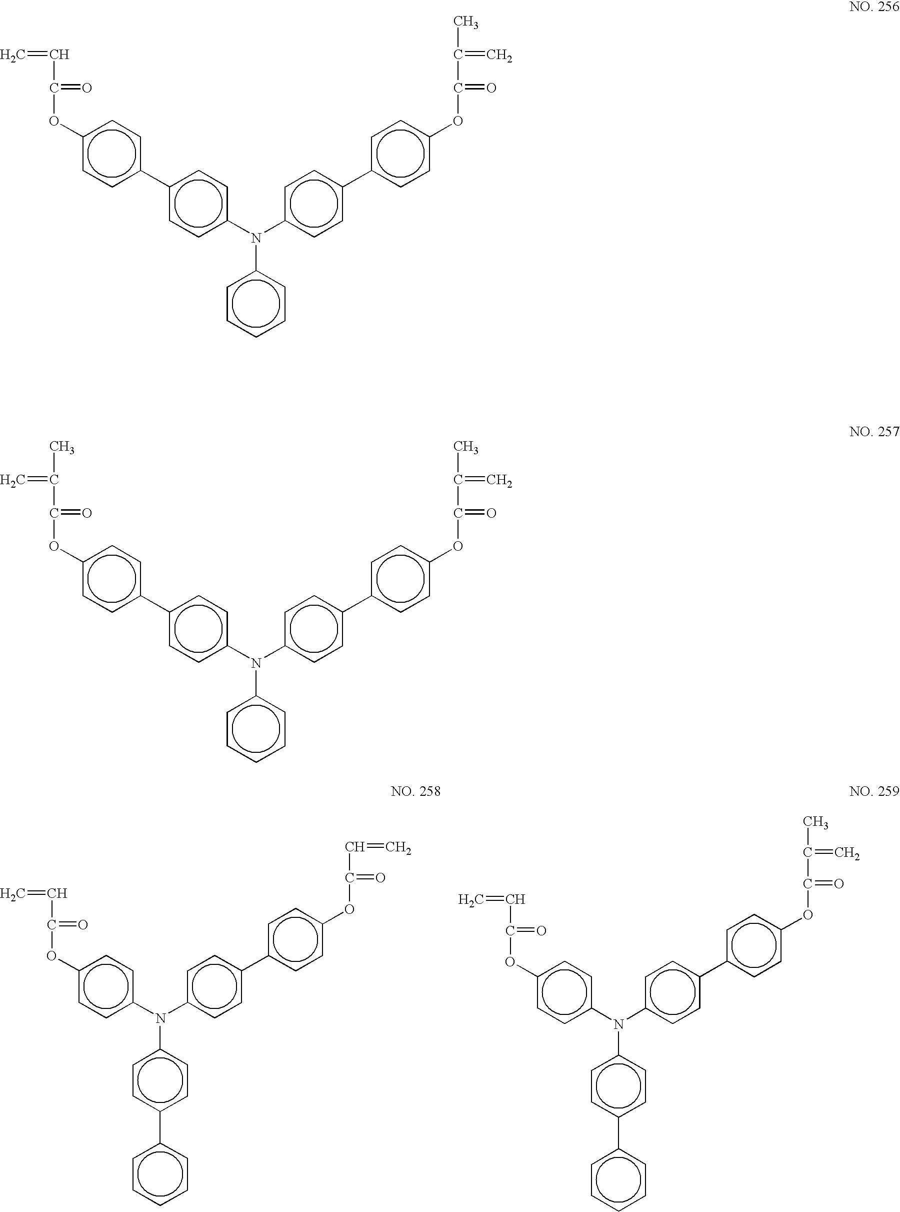

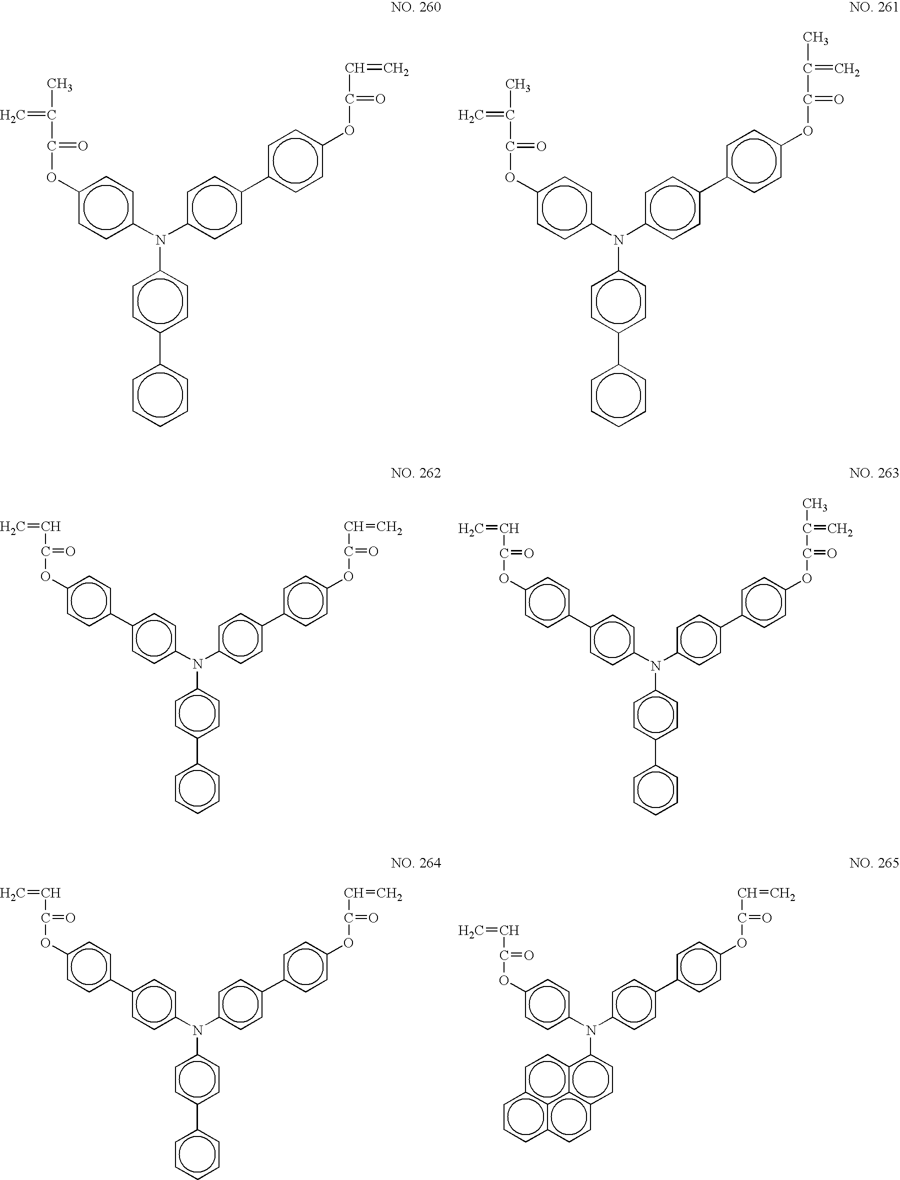

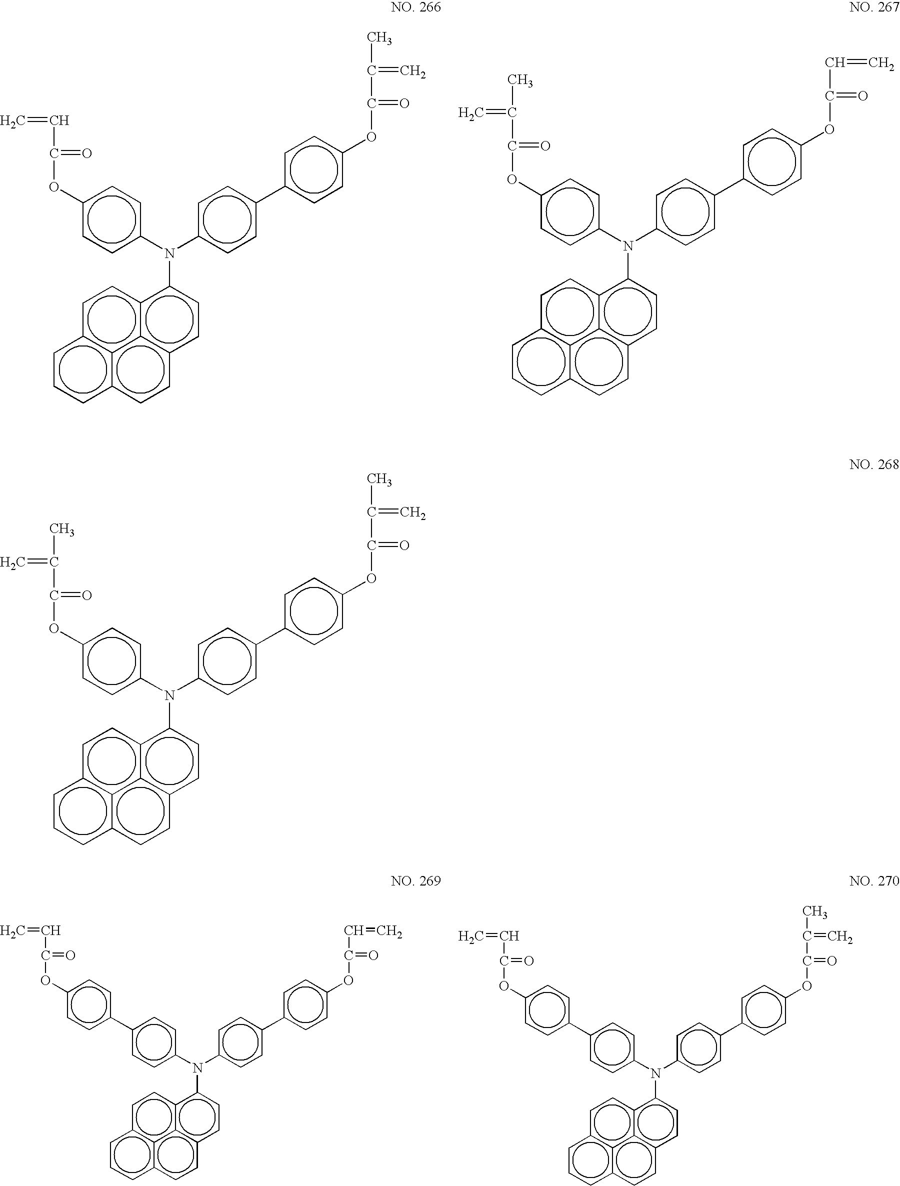

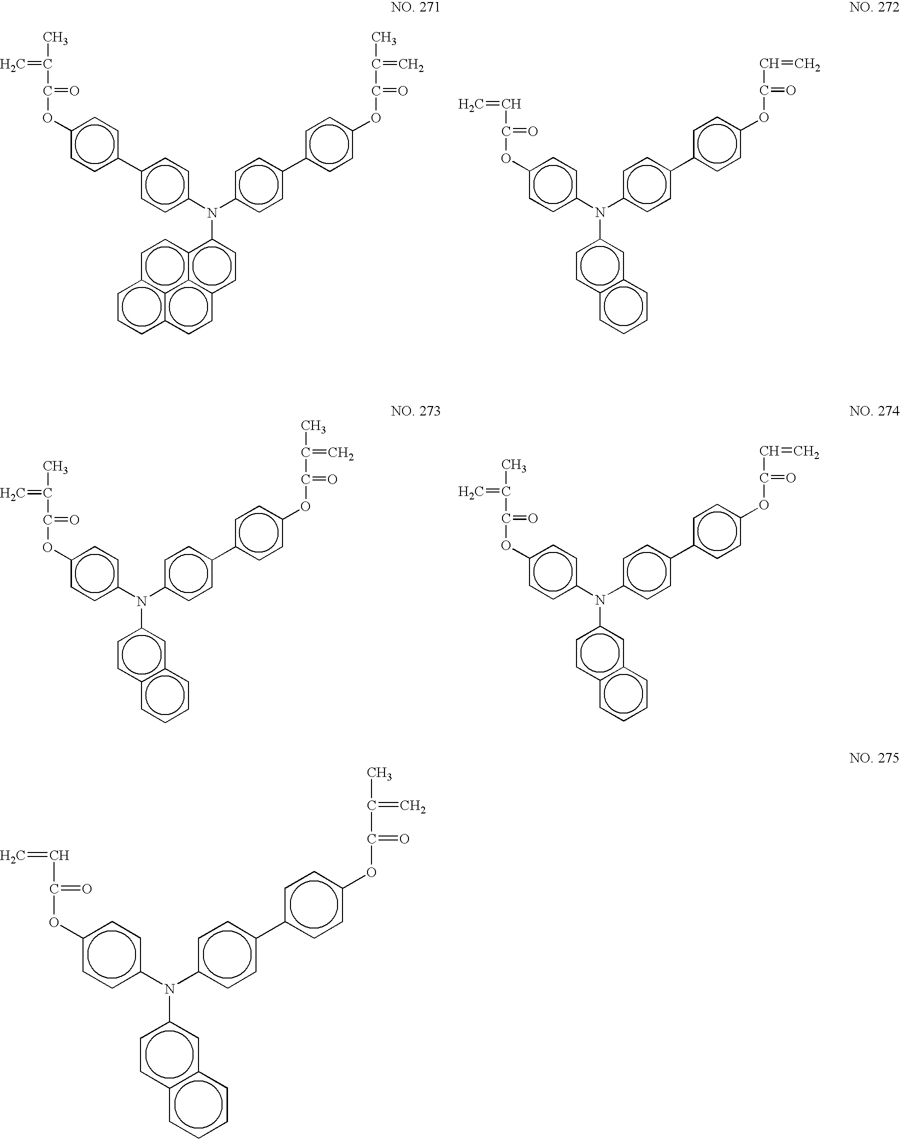

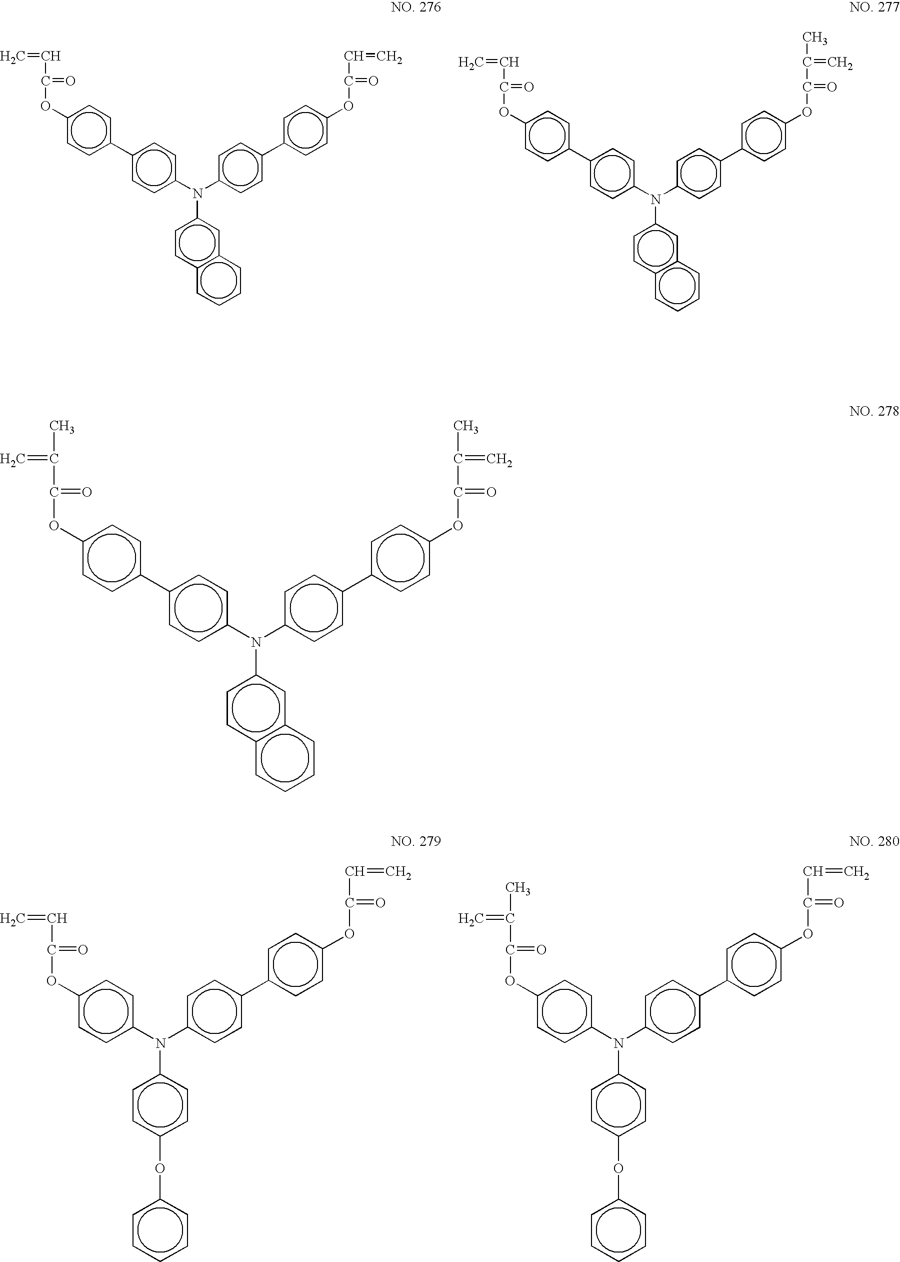

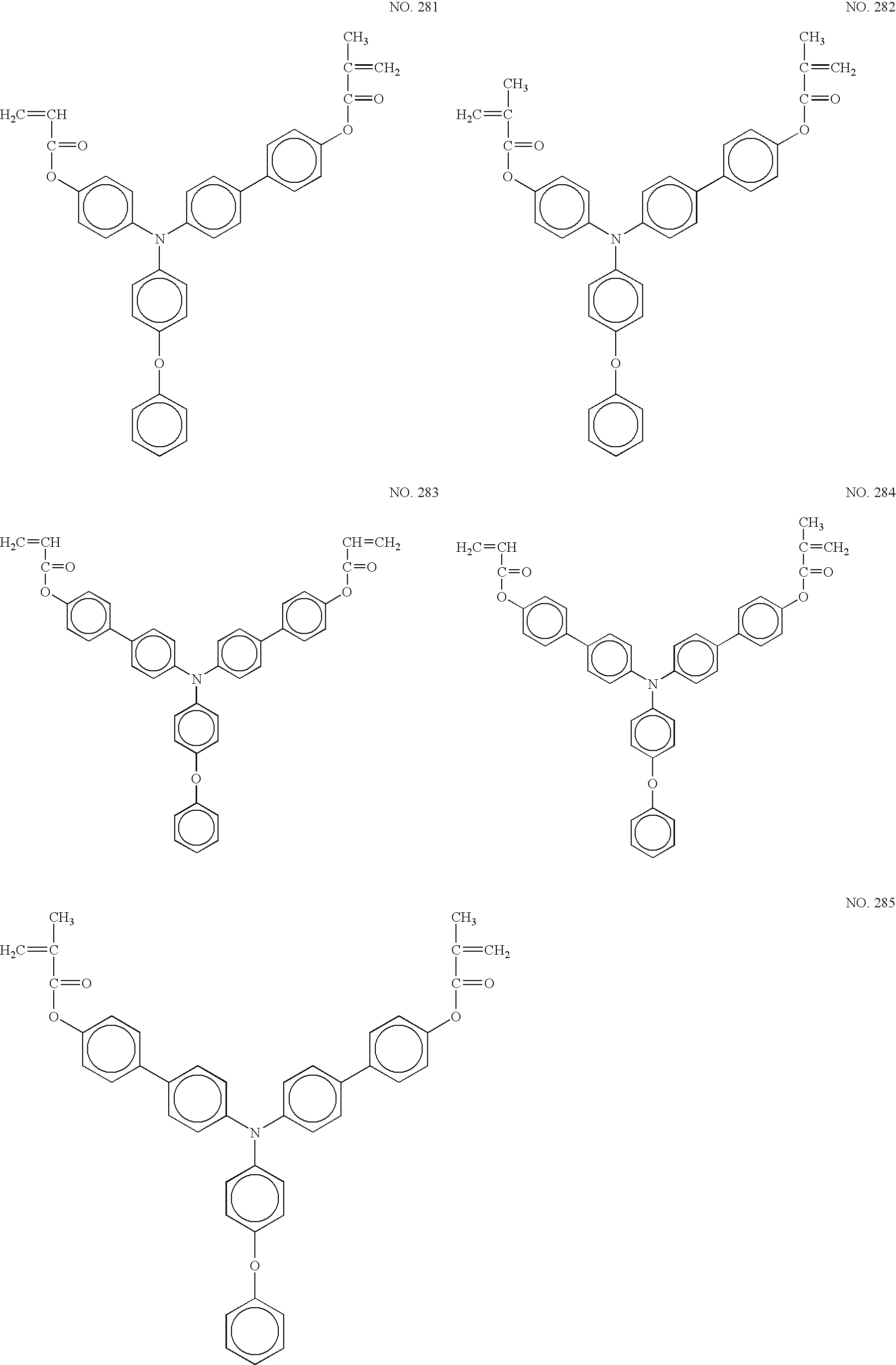

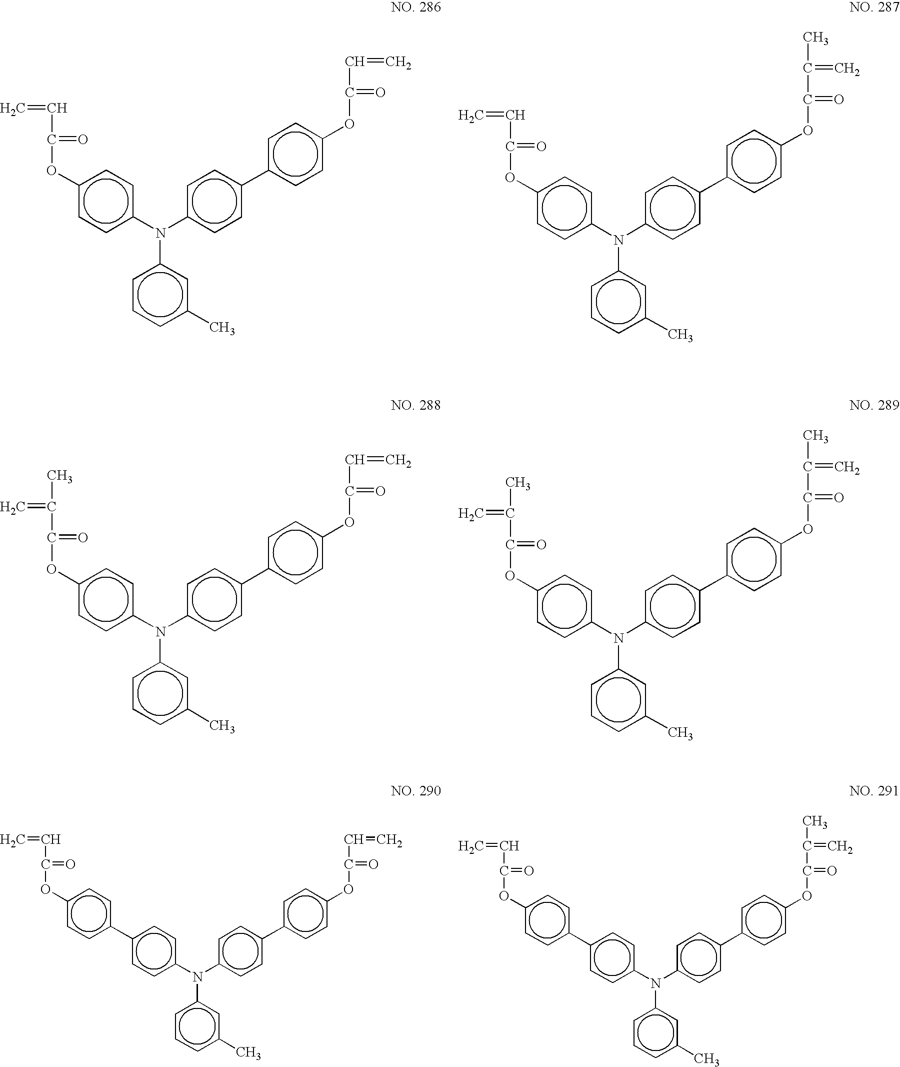

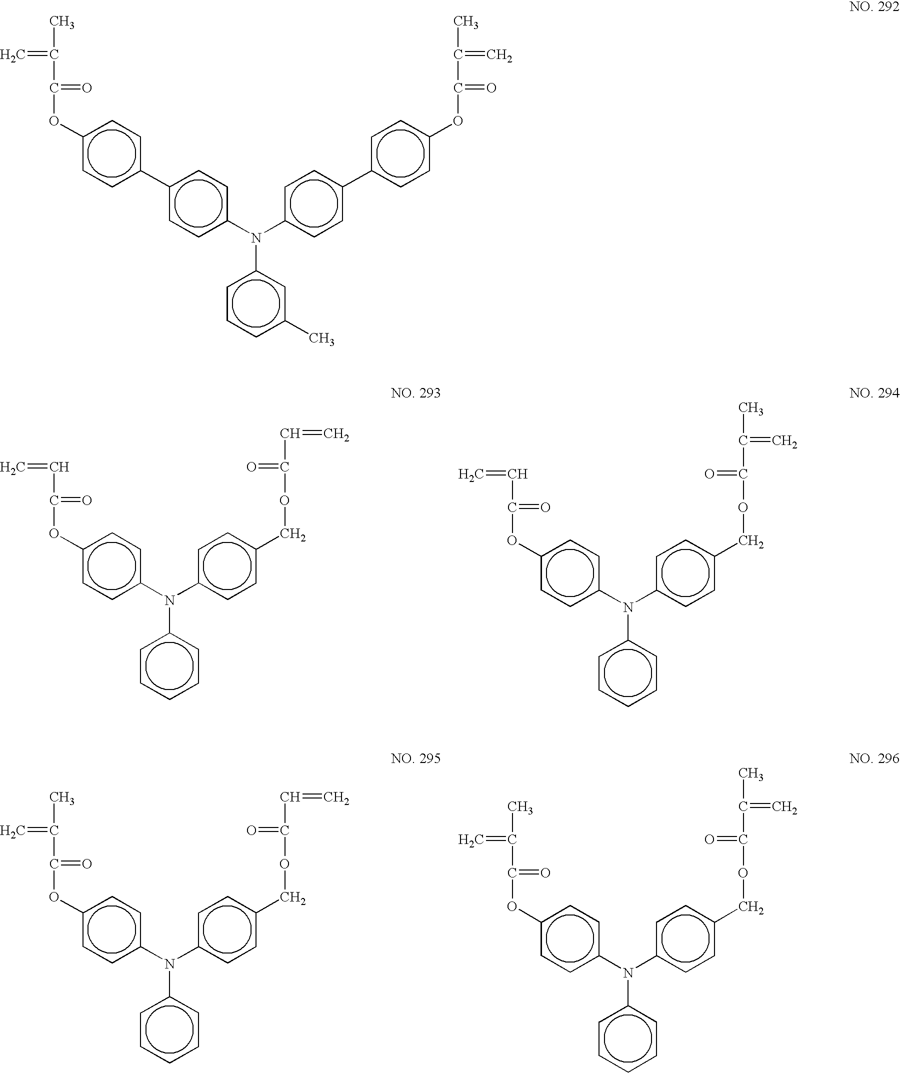

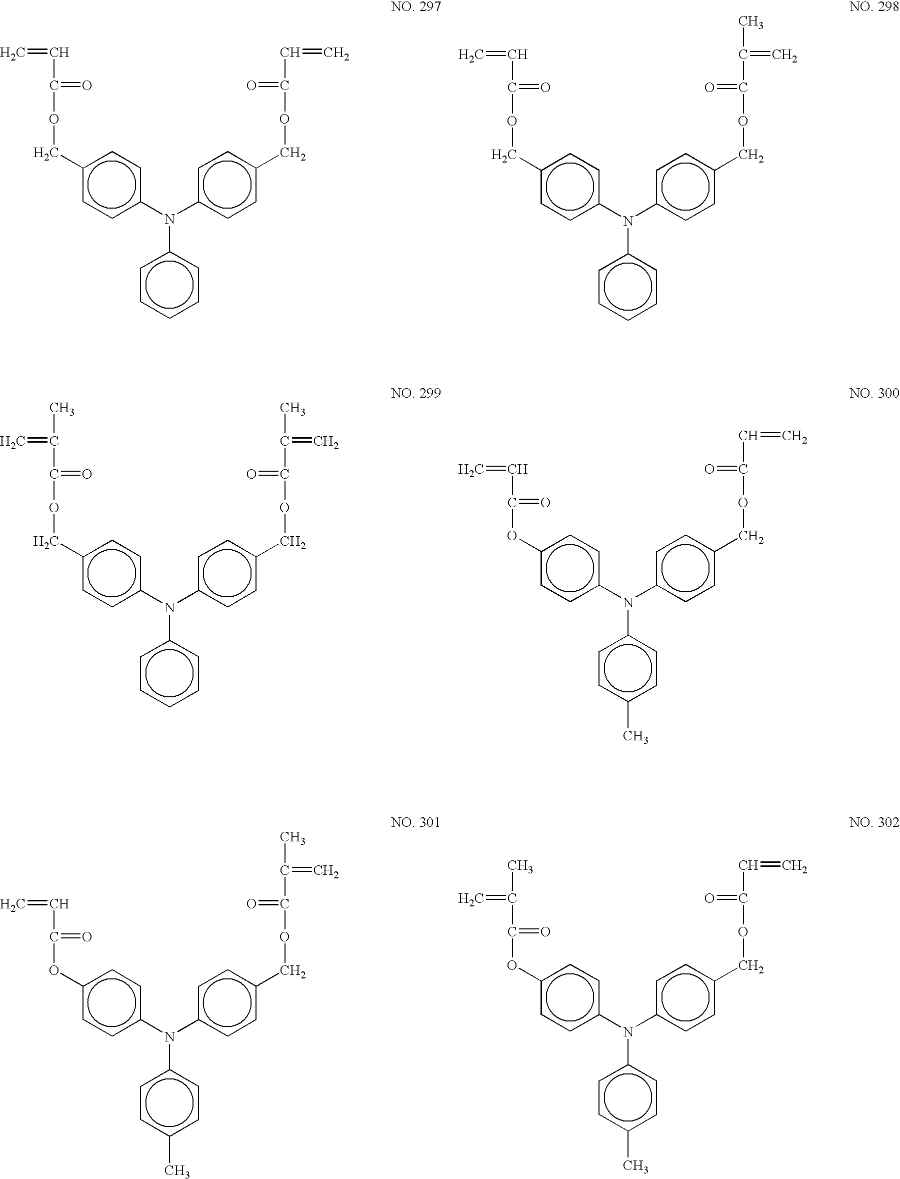

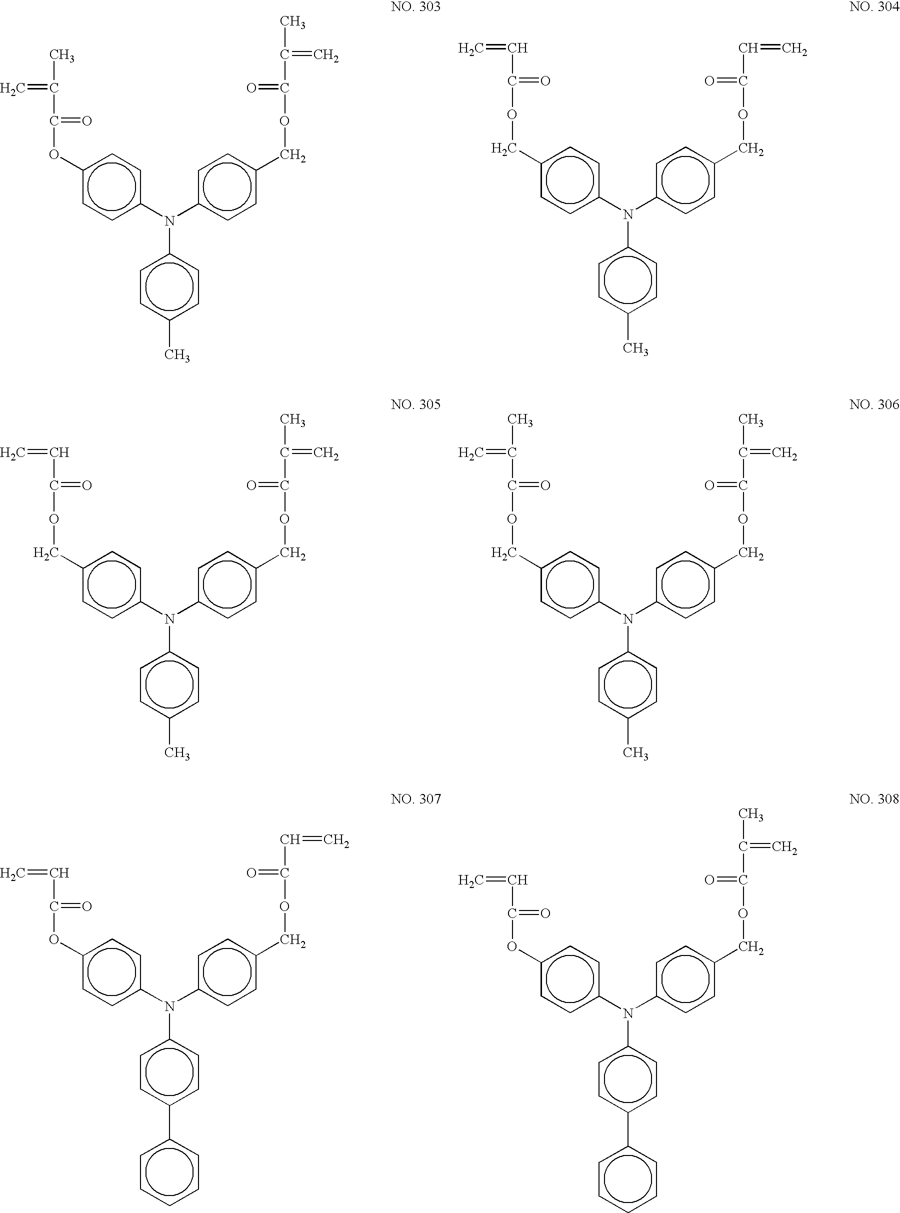

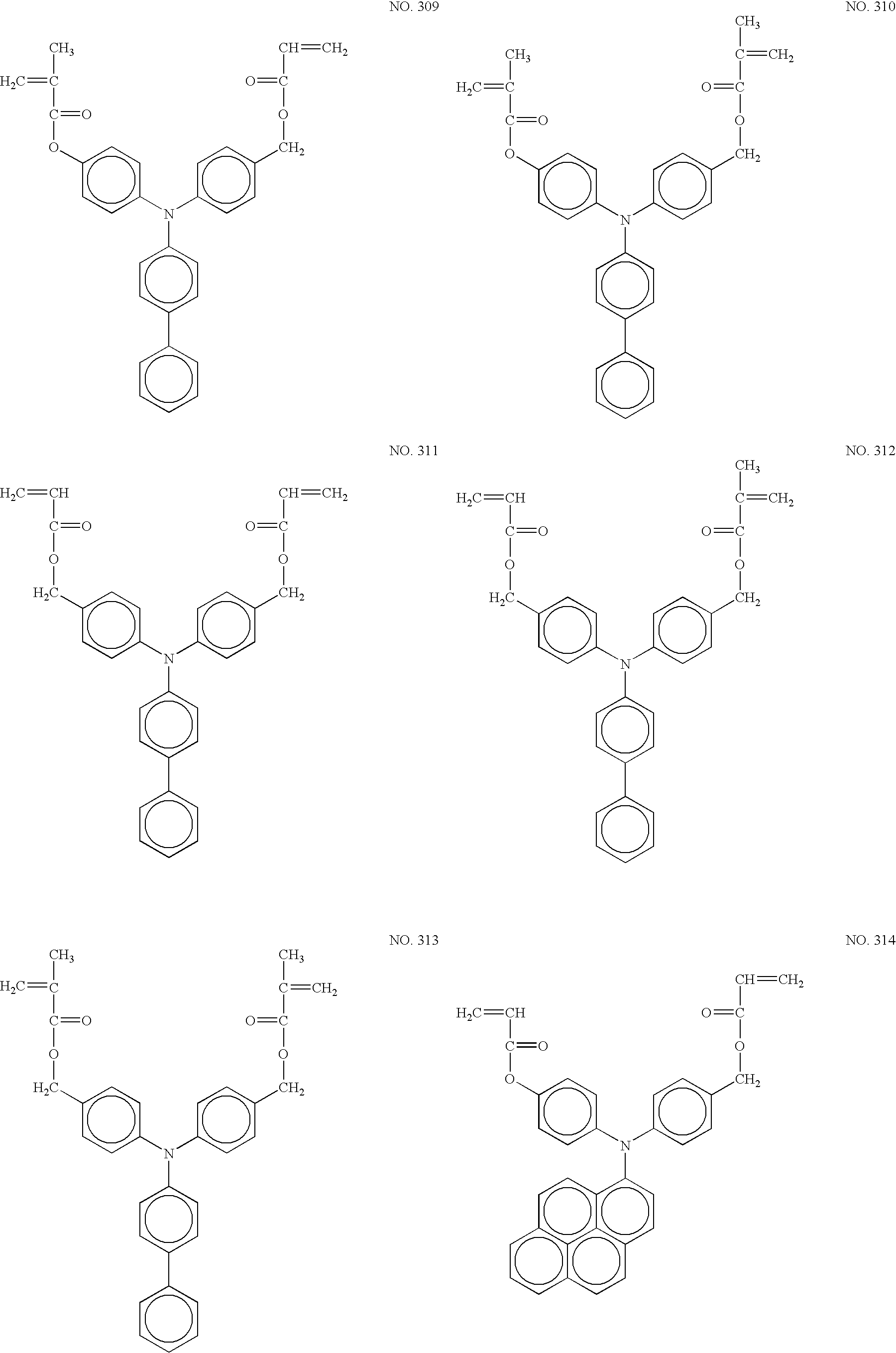

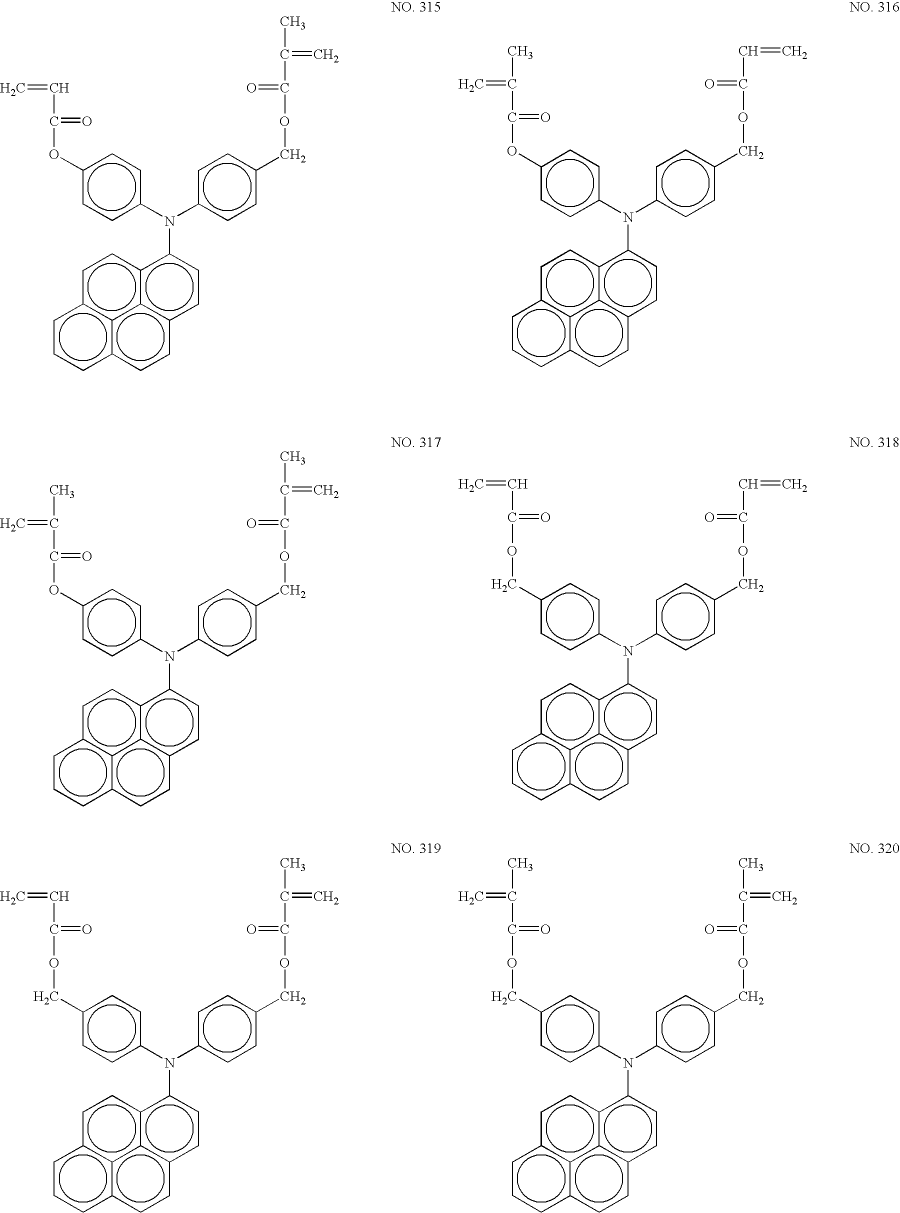

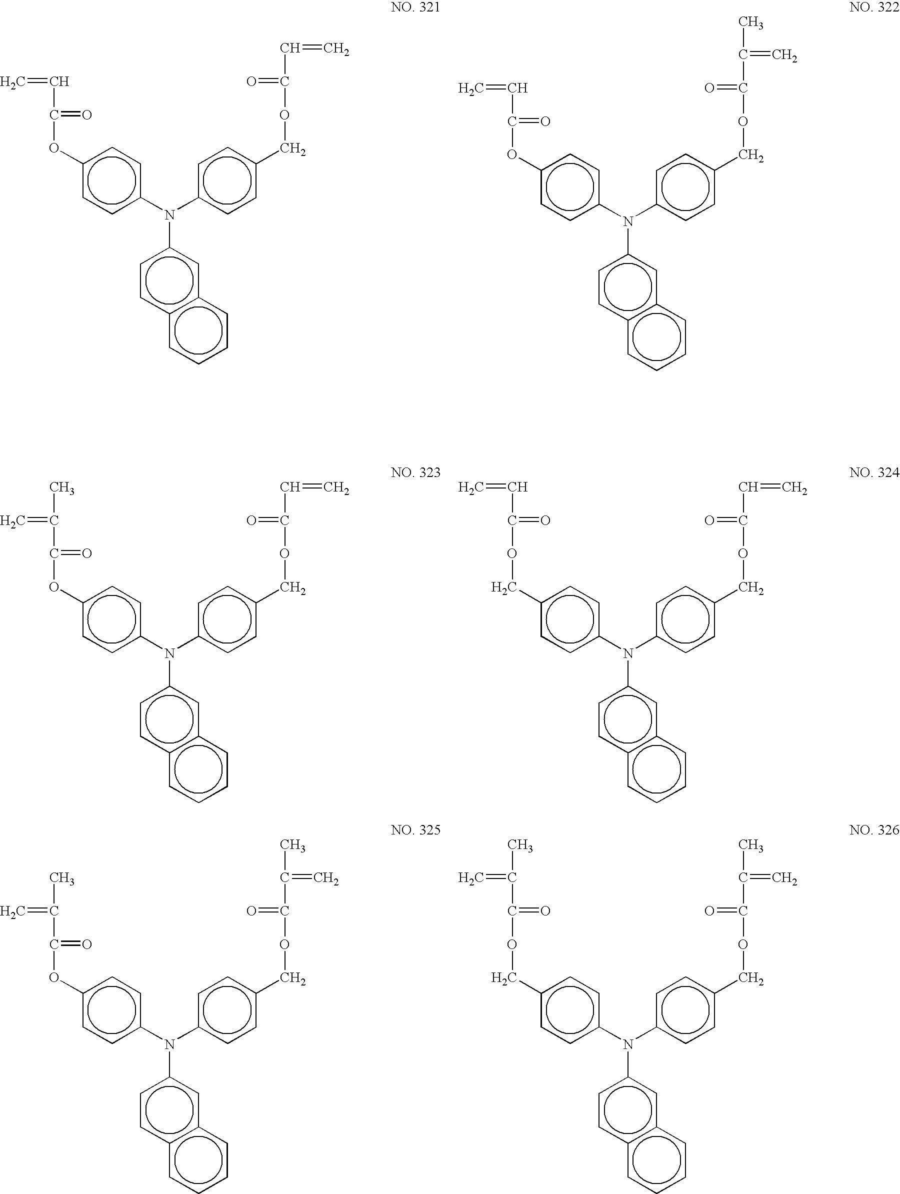

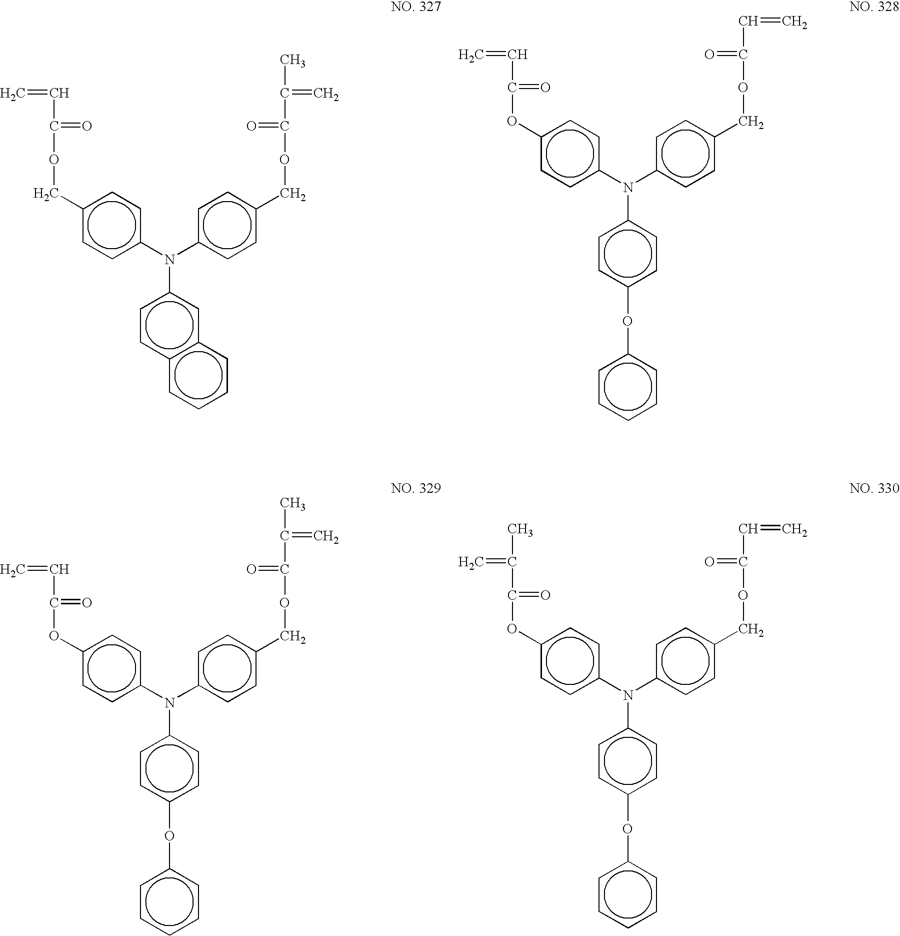

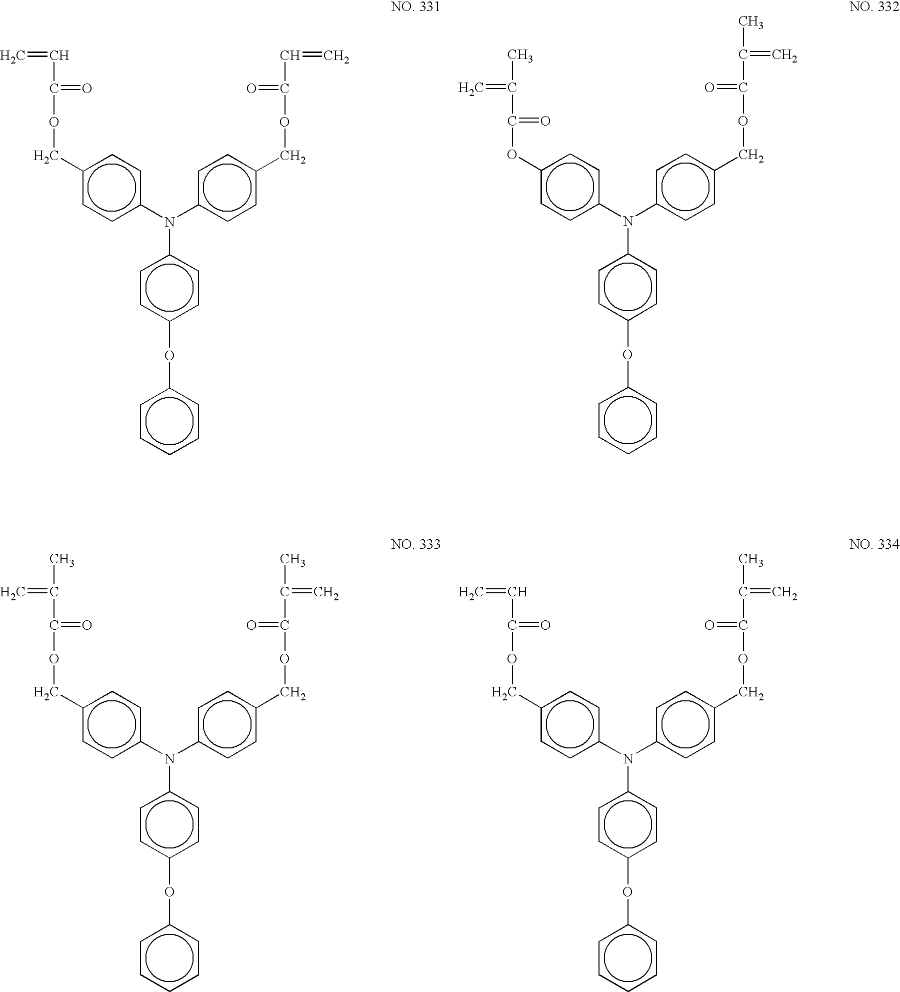

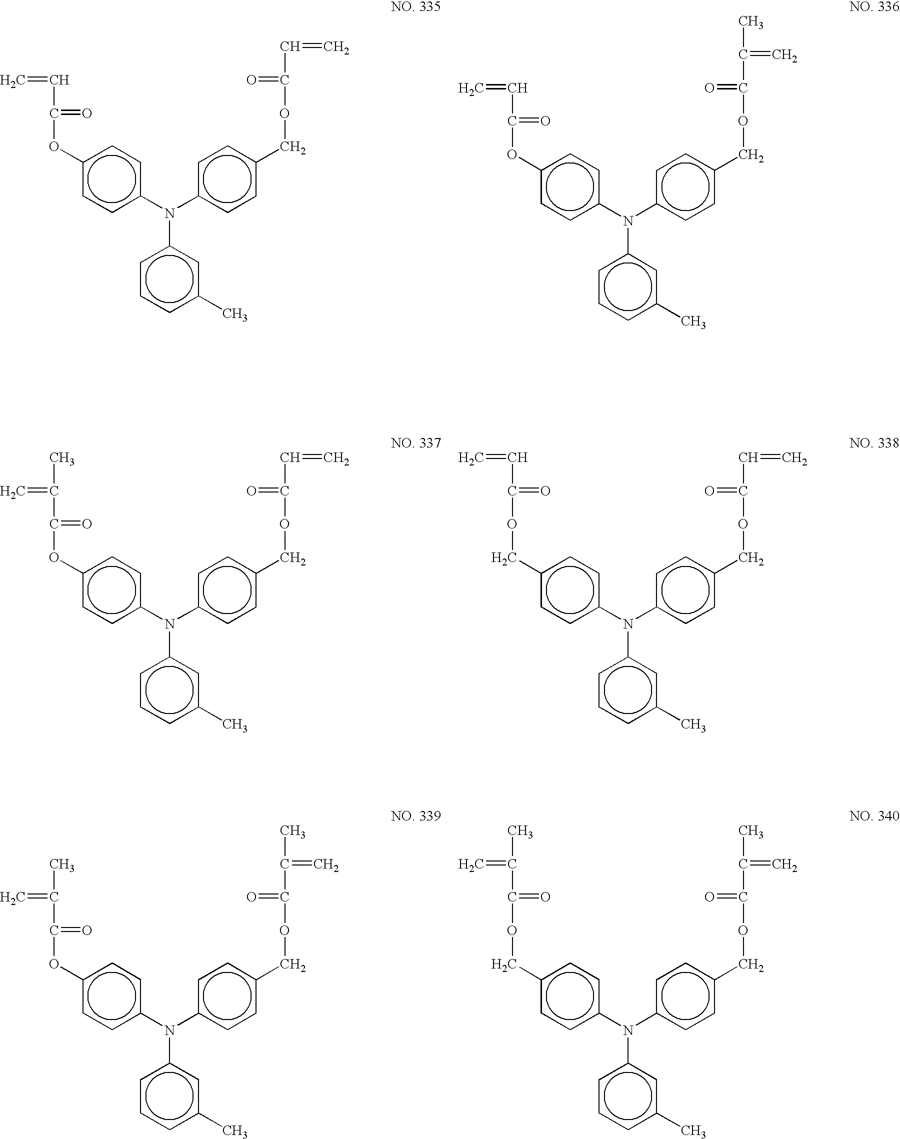

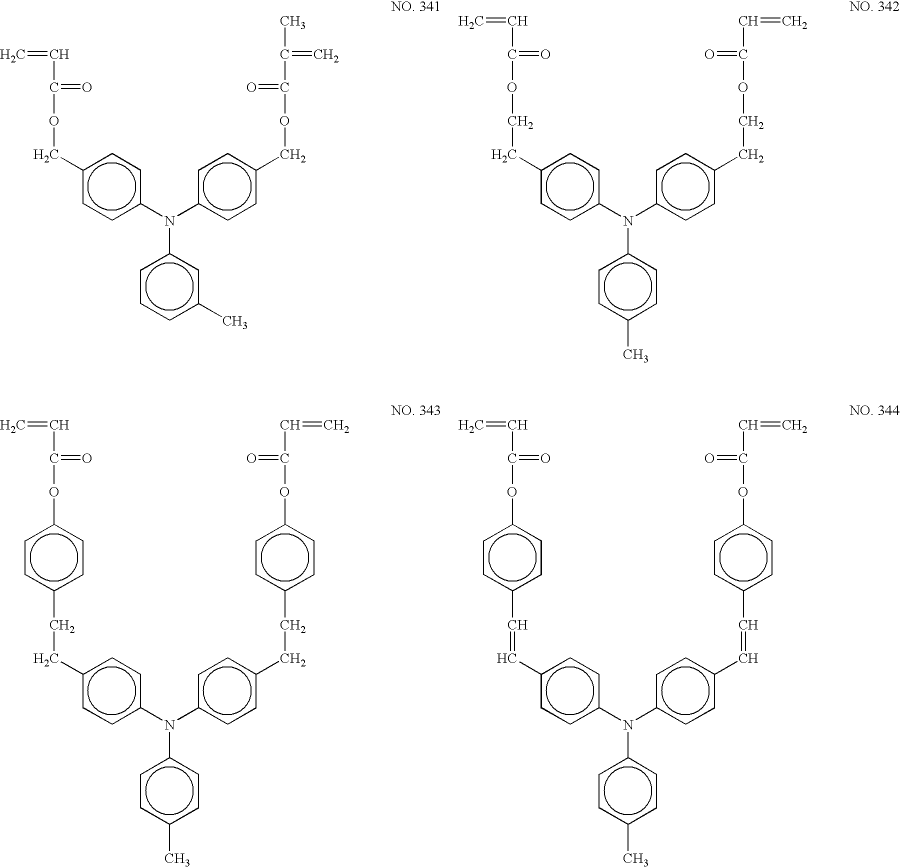

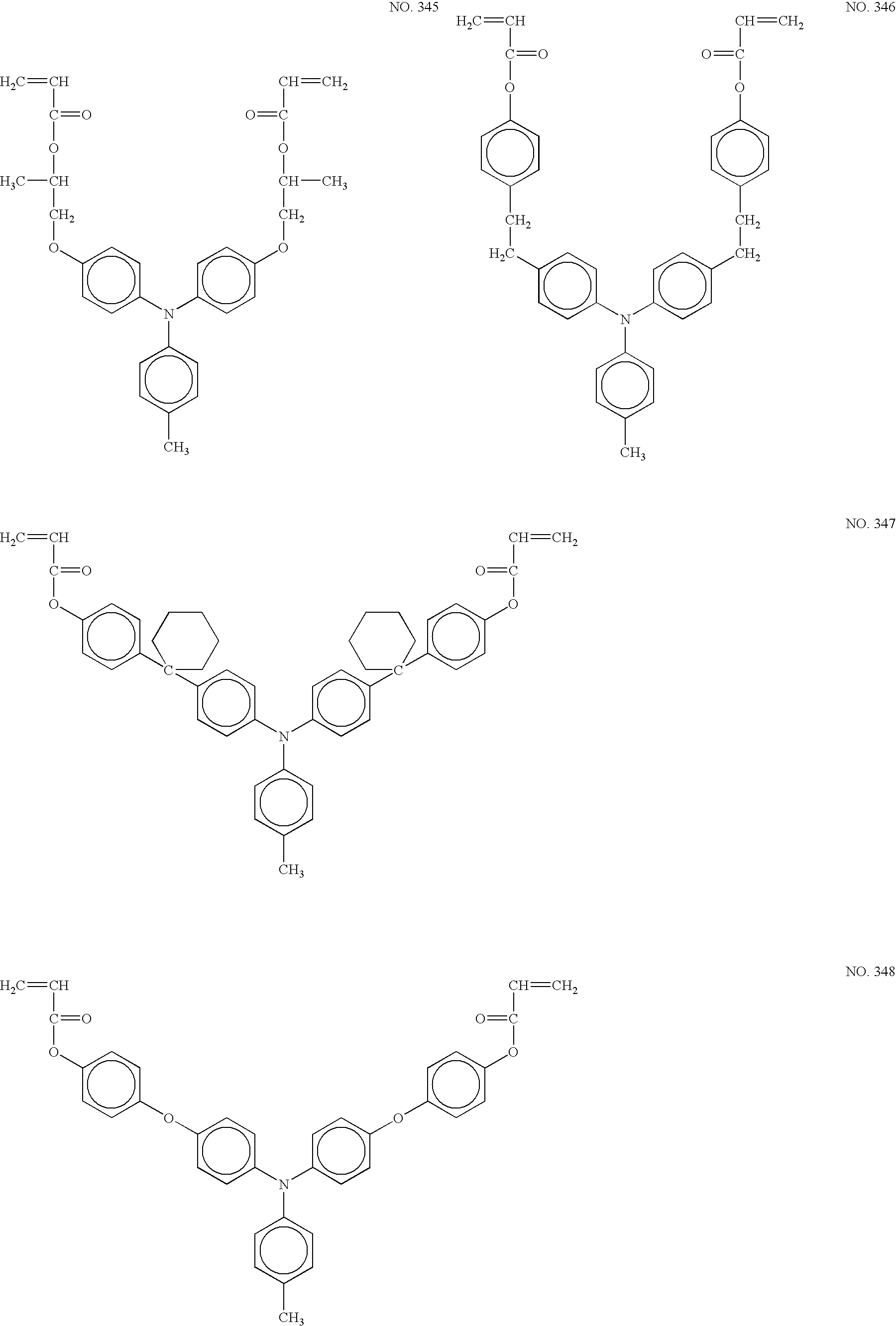

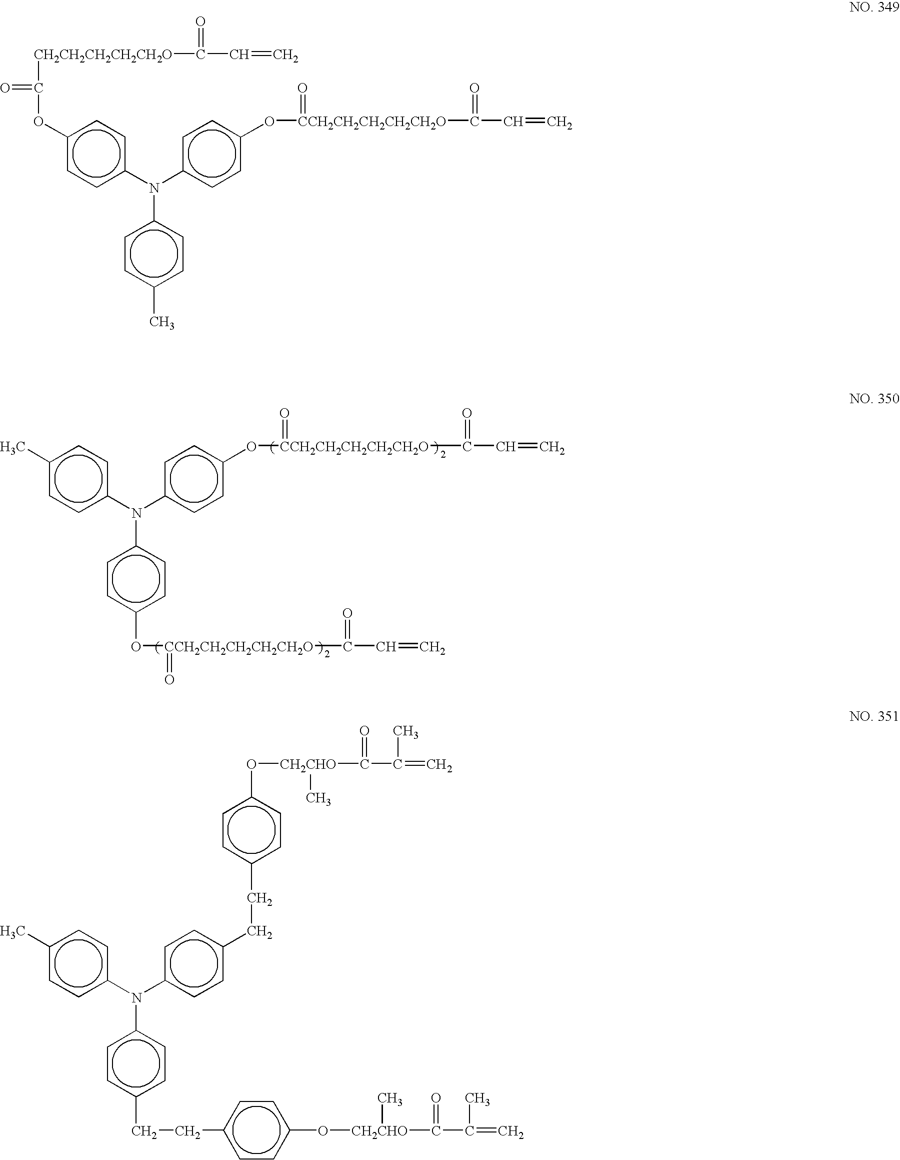

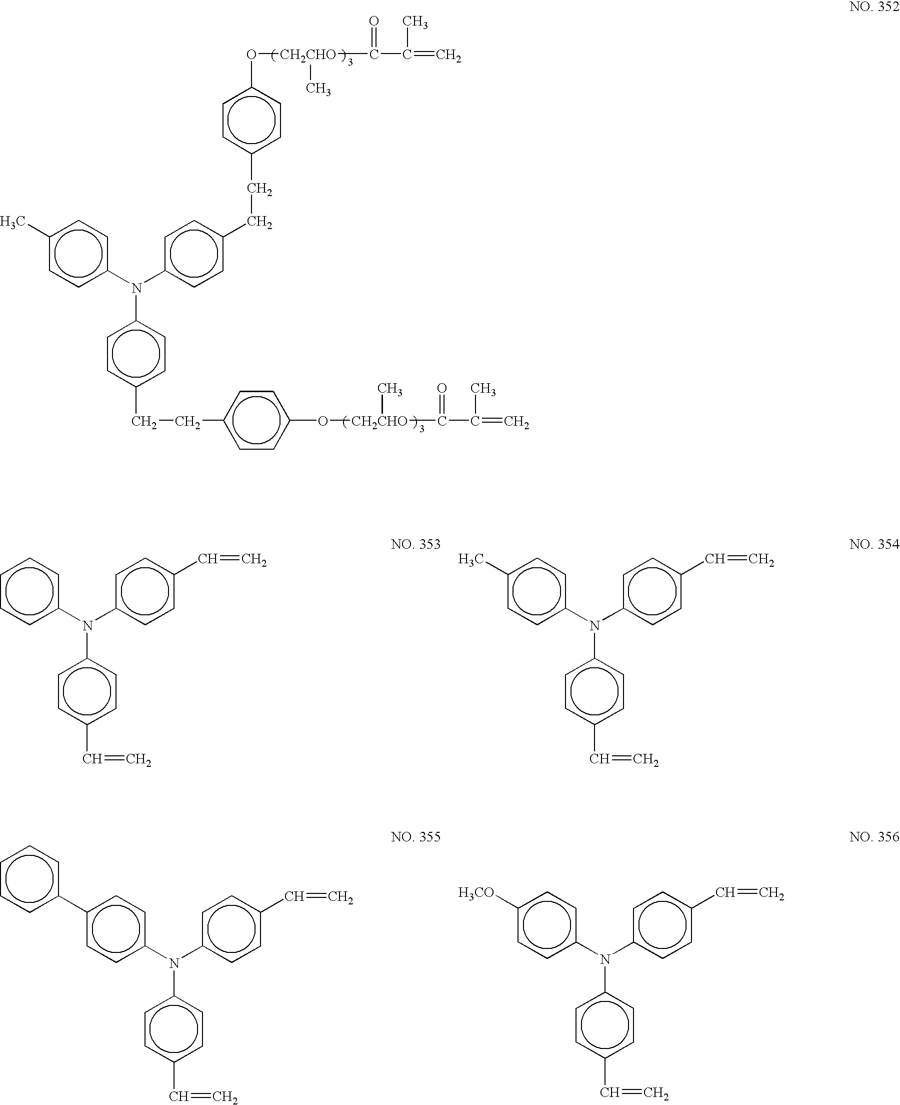

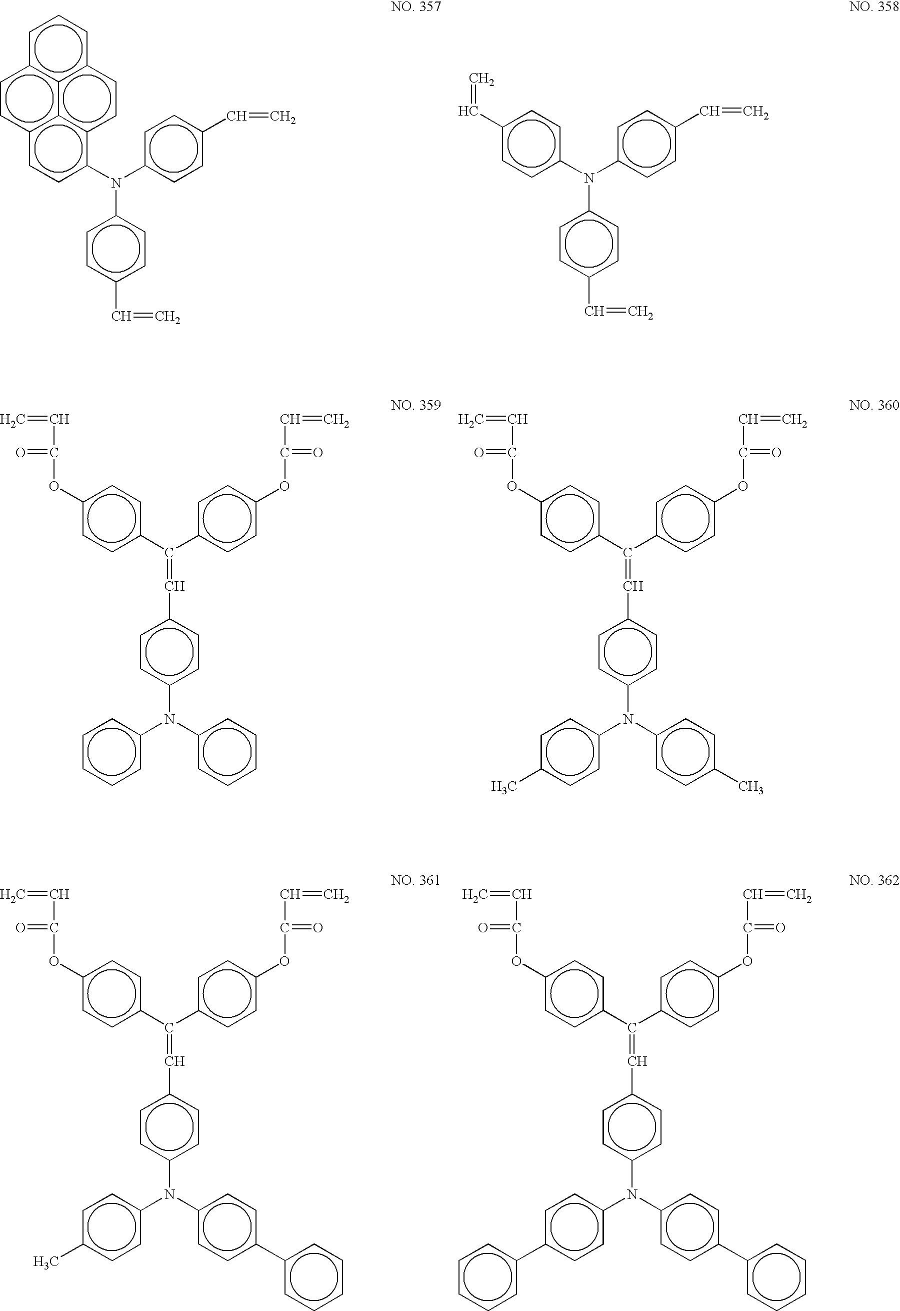

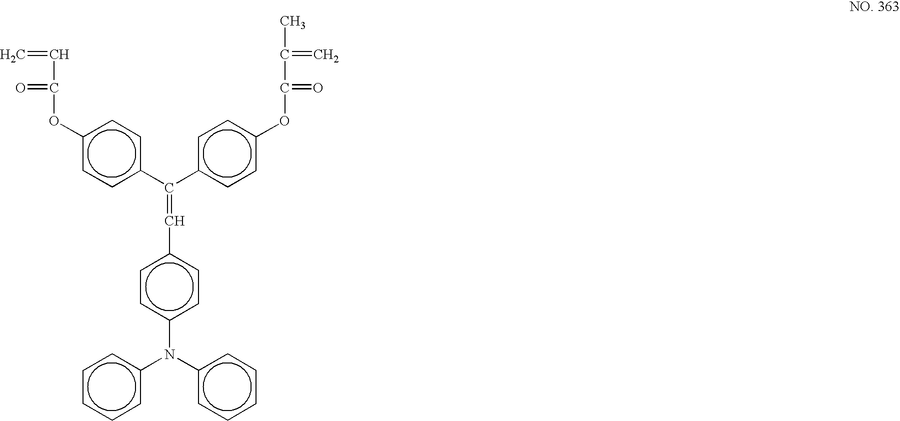

Specific examples of the radical polymerizable compounds having three functional groups with a charge transport structure include, but are not limited to, include the following:

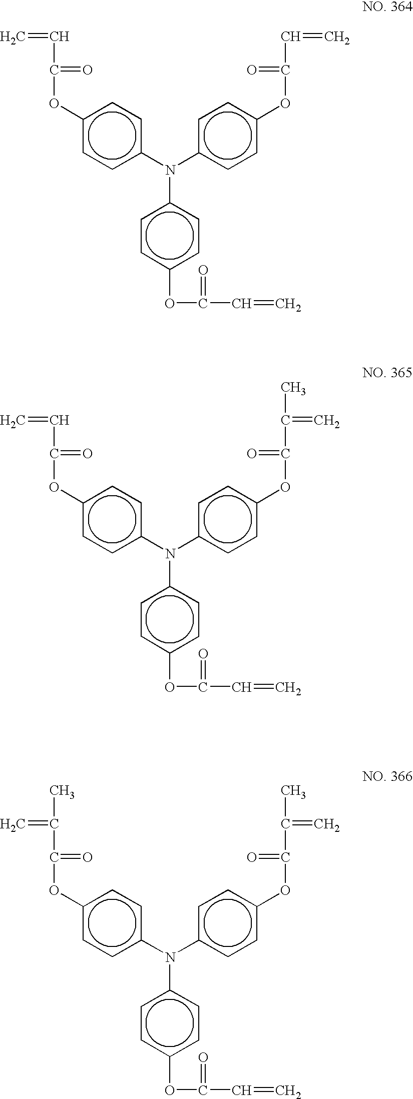

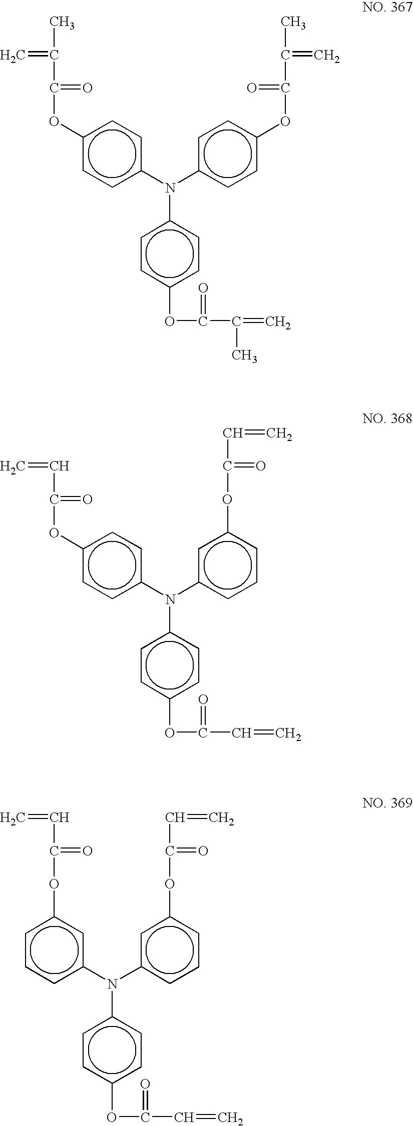

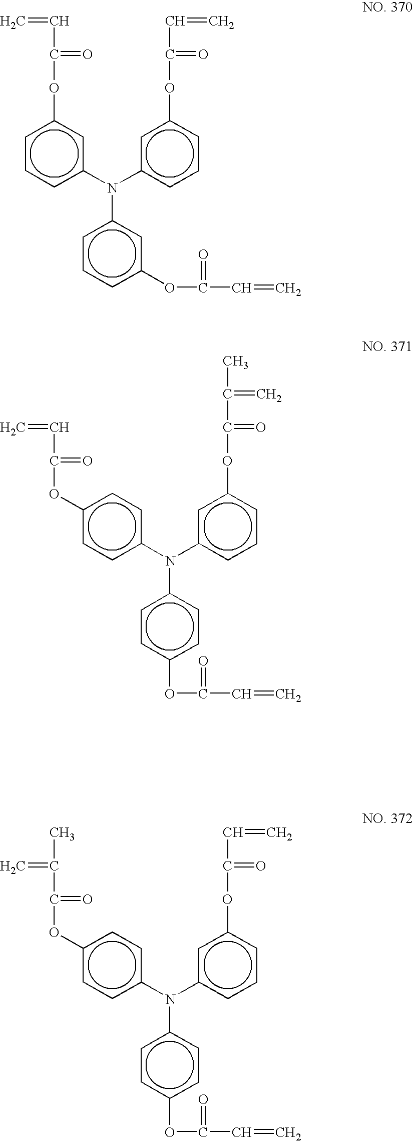

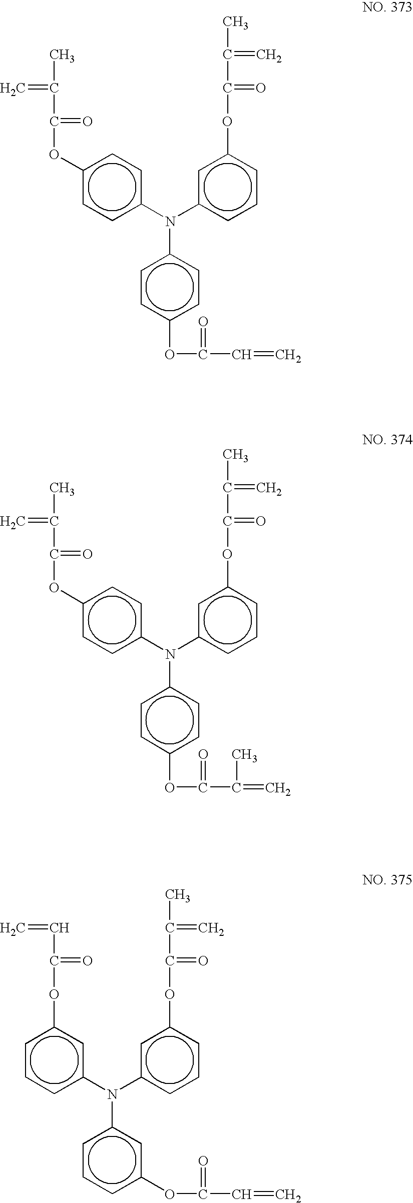

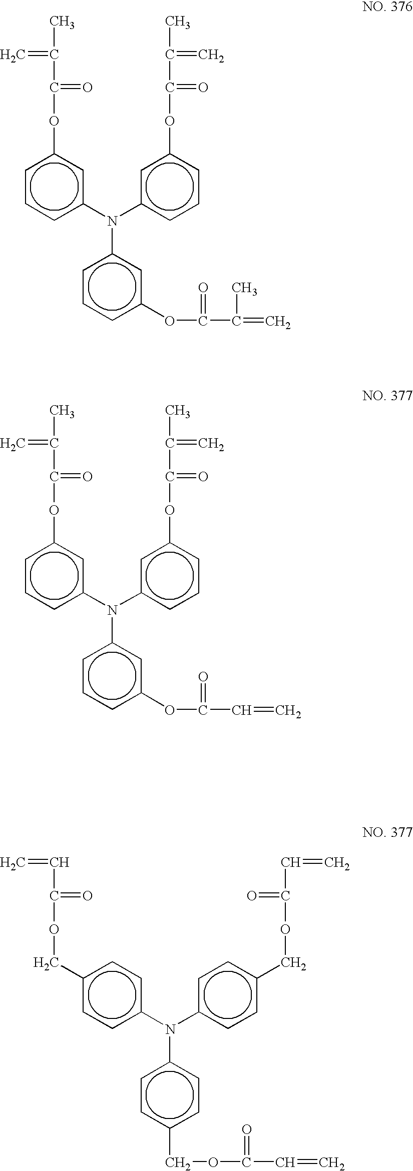

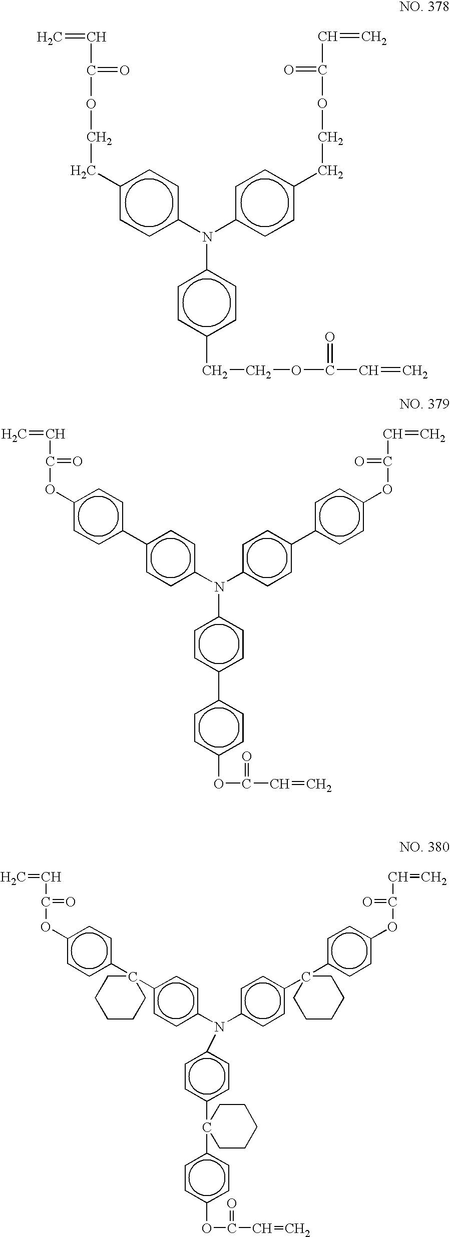

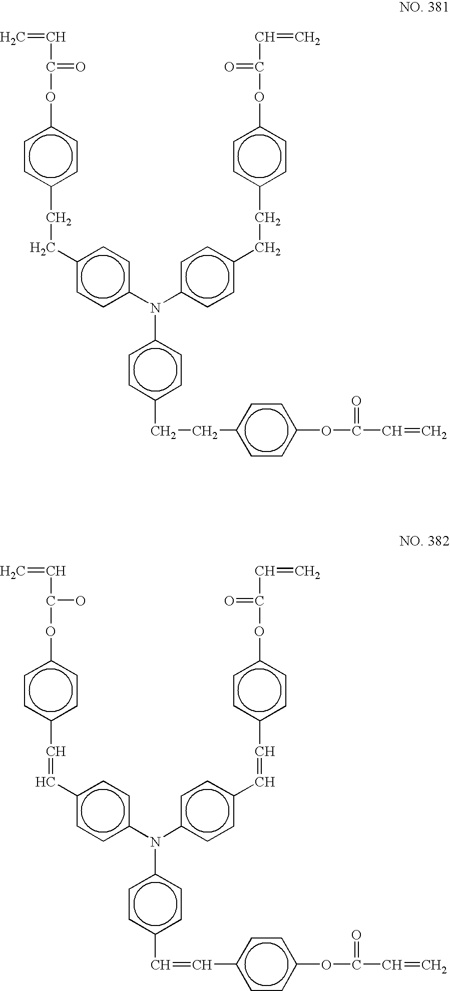

In addition, the radical polymerizable compound having a charge transport structure for use in the present invention is desired to impart charge transport power to a cross-linked protective layer. The content of this component is from 20 to 80% by weight and preferably from 30 to 70% by weight based on the total weight of the cross-linked protective layer. When the content of this component is too small, the charge transport power tends to be not sufficiently demonstrated, which leads to deterioration of the sensitivity during repetitive use and deterioration of the electric characteristics such as a rise in the residual voltage. When the content of this component is too large, the content of the monomer having three functional groups with no charge transport structure decreases, which may invite reduction of the cross-linking density so that a high anti-abrasion property is not demonstrated. It is difficult to jump to any conclusion since the demand for the abrasion resistance and the electric characteristics varies depending on the process but considering a good combination of the abrasion resistance and the electric characteristics, the content of the monomer most preferably ranges from 30 to 70% by weight.

The cross-linked protective layer in the present invention is formed at least by curing a radical polymerizable monomer having three or more functional groups without no charge transport structure and a radical polymerizable compound having a charge transport structure. Furthermore, a radical polymerizable monomer having one or two functional groups, a functional monomer, and/or a radical polymeric oligomer can be used in combination to provide functions, for example, adjusting the viscosity upon coating, relaxing the stress in the protective layer, decreasing the surface energy, and reducing the friction index, etc. Any known radical polymerizable monomers and oligomers can be used.

Specific examples of the radical polymerizable monomer having one functional group include, but are not limited to, monomers of 2-ethylhexyl acrylate, 2-hydroxyethyl acrylate, 2-hydroxypropyl acrylate, tetrahydrofurfuryl acrylate, 2-ethylhexyl carbitol acrylate, 3-methoxybutyl acrylate, benzyl acrylate, cyclohexyl acrylate, isoamyl acrylate, isobutyl acrylate, methoxy triethylene glycol acrylate, phenoxy tetraethylene glycol acrylate, cetyl acrylate, isostearyl acrylate, stearyl acrylate, and styrene.

Specific examples of the radical polymerizable monomer having two functional groups include, but are not limited to 1,3-butandiol diacrylate, 1,4-butane diol diacrylate, 1,4-butane diol dimethacrylate, 1,6-hexane diol diacrylate, 1,6-hexane diol dimethacrylate, diethylene glycol diacrylate, neopentyl glycol diacrylate, bisphenol A—EO modified diacrylate, bisphenol F—EO modified diacrylate and neopentyl glycol diacrylate.

Specific examples of the functional monomer include, but are not limited to, monomers in which a fluorine atom of, for example, octafluoro pentyl acrylate, 2-perfluorooctyl ethyl acrylate, 2-perfluorooctyl ethyl methacrylate and 2-perfluoroisononyl ethyl acrylate is substituted, and vinyl monomers, acrylates and methacrylates having polysiloxane groups, for example, acryloyl polydimethyl siloxane ethyl, methacryloyl polydimethyl siloxane ethyl, acryloyl polydimethyl siloxane propyl, acryloyl polydimethyl siloxane butyl and diacryloyl polydimethyl siloxane diethyl having 20 to 70 siloxane repeating units set forth in examined published Japanese patent applications Nos. (hereinafter referred to as JPP) H05-60503 and H06-45770.

Specific examples of the radical polymeric oligomer include epoxyacrylate based, urethane acrylate based, and polyester acrylate based oligomers.

When a radical polymerizable monomer and/or a radical polymeric oligomer having one or two functional groups are contained in a large amount, the three dimensional cross linking density of the cross-linked protective layer substantially decreases, which invites the deterioration of the anti-abrasion property. Therefore, the content of these monomers and oligomers is not greater than 50 parts by weight and preferably not greater than 30 parts by weight based on 100 parts by weight of the radical polymerizable monomer having three or more functional groups.

The cross-linked protective layer in the present invention is formed at least by curing a radical polymerizable monomer having three or more functional groups without no charge transport structure and a radical polymerizable compound having a charge transport structure. In addition, a polymerization initiator can be suitably used to efficiently conduct the cross-linking reaction in the cross-linked protective layer.

Specific examples of thermal polymerization initiator include, but are not limited to, peroxide-based initiators, for example, 2,5-dimethylhexane-2,5-dihydroperoxide, dicumyl peroxide, benzoyl peroxide, t-butyl cumyl peroxide, 2,5-dimethyl-2,5-di(peroxybenzoyl)hexyne-3,di-t-butyl peroxide, t-butylhydroperoxide, cumene hydroperoxide, and lauroyl peroxide, and azo based initiators, for example, azobis isobutylnitrile, azobiscyclohexane carbonitrile, azobis methyl isobutyric acid, azobis isobutyl amidine hydrochloride salts, and 4,4′-azobis-4-cyano valeric acid.

Specific examples of photo polymerization initiators include acetophenone based or ketal based photo polymerization initiators, for example, diethoxy acetophenone,
2,2-dimethoxy-1,2-diphenylethane-1-one,
1-hydroxy cyclohexyl phenylketone,
4-(2-hydroxyethoxy)phenyl-(2-hydroxy-2-propyl)ketone,
2-benzyl-2-dimethylamino-1-(4-morpholinophenyl)butanone-1,2-hydroxy-2-methyl-1-phenylpropane-1-one,
2-methyl-2-morpholino(4-methylthiophenyl)propane-1-one, and
1-phenyl-1,2-propane dione-2-(o-ethoxycarbonyl)oxime;
   benzoin ether based photo polymerization initiators, for example, benzoine, benzoine methyl ether, benzoin ethyl ether, benzoine isobutyl ether and benzoine isopropyl ether; benzophenone based photo polymerization initiators, for example, benzophenone, 4-hydroxy benzophenone, o-benzoyl benzoic acid methyl, 2-benzoyl naphthalene, 4-benzoyl biphenyl, 4-benzoyl phenyl ether, acrylated benzophenone and 1,4-benzoyl benzene; and thioxanthone based photo polymerization initiators, for example, 2-isopropyl thioxanthone, 2-chloro thioxanthone, 2,4-dimethyl thioxanthone, 2,4-diethyl thioxanthone, and 2,4-dichloro thioxanthone.

Other photo polymerization initiators are, for example, ethylanthraquinone,
2,4,6-trimethyl benzoyl diphenyl phosphine oxide,
2,4,6-trimethyl benzoyl phenyl ethoxy phosphine oxide,
bis(2,4,6-trimethyl benzoyl)phenyl phosphine oxide,
bis(2,4-dimethoxy benzoyl)-2,4,4-trimethyl pentyl phosphine oxide,
   methylphenyl glyoxy esters, 9,10-phenanthrene, acridine based compounds, triadine based compounds, and imidazole based compounds.

In addition, compounds having photo polymerization promotion effect can be used alone or in combination with the photo polymerization initiators mentioned above. Specific examples thereof include, but are not limited to, triethanol amine, methyldiethanol amine, 4-dimethylamino ethyl benzoate, 4-dimethylamino isoamile benzoate, benzoic acid (2-dimethylamino) ethyl, and 4,4′-dimethylamino benzophenone.

These polymerization initiators can be used alone or in combination. The addition amount of the polymerization initiator is from 0.5 to 40 parts by weight and preferably from 1 to 20 parts by weight based on 100 parts by weight of the total weight of the radical polymerizable compound.

Furthermore, a liquid application for use in the present invention can contain additives, for example, various kinds of a plasticizing agent (to relax internal stress or improve adhesiveness), a leveling agent, and a low molecular weight charge transport material which is not radically reactive, if desired. Any known additives can be used. Specific examples of the plasticizing agent include, but are not limited to, dibutyl phthalate and dioctyl phthalate, which are typically used for resins. The addition amount of the plasticizing agent is not greater than 20% by weight and more preferably not greater than 10% by weight based on all the solid portion of the liquid application. Specific examples of the leveling agent include, but are not limited to, silicone oils such as dimethyl silicone oil and methylphenyl silicone oil, and polymers or oligomers having a perfluoroalkyl group in its branch chain. The addition amount of the leveling agent is not greater than 3% by weight based on all the solid portion of the liquid application.

The cross-linked protective layer of the photoreceptor of the present invention is preferably formed by coating and curing a liquid application containing at least a radical polymerizable monomer having three or more functional groups with no charge transport structure and a radical polymerizable compound having a charge transport structure. When the radical polymerizable monomer is liquid, other compositions can be dissolved therein for application or optionally diluted by a solvent before application. Specific examples of the solvent include, but are not limited to, alcohols such as methanol, ethanol, propanol and butanol, ketones such as acetone, methylethylketone, methylisobutylketone, and cyclohexanone, esters such as ethyl acetate and butyl acetate, ethers such as teterhydrofuran, dioxane, and propylether, halogen-based solvents such as dichloromethane, dichloroethane, trichloroethane, and chlorobenzene, aromatic compounds such as benzene, toluene, and xylene, cellosolves such as methylcellosolve, ethylcellosolve, and cellosolve acetate. These solvents can be used alone or in combination. The dilution ratio by such a solvent varies depending on solubility of a composition, application method, target layer thickness. A dip coating method, a spray coating method, a bead coating method, a ring coating method, etc. can be used.

When manufacturing the photoreceptor of the present invention, the liquid application is applied and cured by an external energy to form a cross-linking surface layer. Specific examples of the external energy include, but are not limited to, heat, light and radioactive ray. Heat is provided (irradiated) to a target from the application surface side or the substrate side using air or vapors such as atmosphere or nitrogen, various kinds of heat medium, infrared and electromagnetic wave. The heating temperature is preferably from 100 to 170° C. When the heating temperature is too low, the reaction speed tends to be slow, resulting in incomplete reaction. When the heating temperature is too high, the reaction is not conducted uniformly, resulting in distortion in the cross-linking surface layer, which is not preferred. Heating at a relatively low temperature (lower than 100° C.) first followed by heating at a temperature not lower than 100° C. is also an effective method to complete the curing reaction.

As light energy, a UV irradiation light source, for example, a high pressure mercury lamp or a metal halide lamp having an emission wavelength mainly in the ultraviolet area can be used. A visible light source can be selected according to the absorption wavelength of a radical polymerizable compound and a photopolymerization initiator. The irradiation light amount is preferably from 50 mW/cm² to 1,000 mW/cm². When the irradiation light amount is too small, it tends to take a long time to complete the curing reaction. When the irradiation light amount is too large, the reaction tends to be not uniformly conducted, resulting in the occurrence of wrinkle on the surface of the protective layer. As radiation ray energy, electron beam can be used. Among these forms of energies, heat and/or light energy is suitably used in terms of easiness of reaction speed control and simplicity of a device.

With regard to the diluent solvent for a liquid application, when a solvent that easily dissolves the layer provided under the protective layer is used in a large amount, the composition such as the binder resin and a low molecular weight charge transport material in the layer provided under the protective layer mingles thereinto. This hinders the curing reaction and creates the same state as the case in which a large amount of non-curing material is preliminarily contained in a liquid application, which causes non-uniform curing of the cross-linking surface. In contrast, when a solvent that hardly dissolves the layer provided under the cross-linked protective layer is used, the adhesiveness between the cross-linked protective layer and the layer provided thereunder is low, which leads to formation of a cross-linked protective layer having a surface with a crater like form due to the volume contraction during curing reaction. Thus, the layer having a low elastic variation rate provided under the cross-linked protective layer is partially exposed to the surface. To deal with this problem, there are following methods: using a solvent mixture to control the solubility of the layer provided under the cross-linked protective layer; reducing the amount of the solvent contained in a liquid application by liquid composition or an application method; preventing mingling of the component of the layer provided under the cross-linked protective layer by using a charge transport polymer therein; and/or providing an intermediate layer having a low solubility or a good adhesive intermediate layer between the cross-linked protective layer and the layer provided thereunder. The cross-linked protective layer suitably has a thickness of from about 0.1 to about 10 μm

### Intermediate Layer

In the photoreceptor of the present invention, when the protective layer forms the surface portion of the photosensitive layer, an intermediate layer can be provided between the protective layer and the photosensitive layer. This intermediate layer is to limit mingling of the composition of the layer situated under the protective layer or improve the adhesiveness with the layer situated under the protective layer.

In the intermediate layer, a binder resin is used as the main component. Specific examples of such binder resins include, but are nor limited to, polyamide, alcohol soluble nylon, water soluble polyvinyl butyral, polyvinyl butyral and polyvinyl alcohol. Such an intermediate layer is formed by the typical method described above. The intermediate layer thickness is suitably from about 0.05 to about 2 μm.

### Addition of Anti-Oxidizing Agent to Each Layer

In addition, in the present invention, an anti-oxidizing agent can be added to each layer of the protective layer, the photosensitive layer, the charge generation layer, the charge transport layer, the undercoating layer, the charge blocking layer, the intermediate layer, etc. to improve the anti-environment properties, especially to prevent the reduction in the sensitivity and the rise in the residual voltage,

Specific examples of the anti-oxidizing agents for use in the present invention include, but are not limited to, the following:

### Phenol-based Compounds:

2,6-di-t-butyl-p-cresol, butylated hydroxyl anisole,
2,6-di-t-butyl-4-ethylphenol, stearyl-β
-(3,5-di-t-butyl-4-hydroxyphenyl)propionate, 2,2′
-methylene-bis-(4-methyl-6-t-butylphenol), 2,2′
-methylene-bis-(4-ethyl-6-t-butylphenol), 4,4′
-thiobis-(3-methyl-6-t-butylphenol), 4,4′
-butylidenebis-(3-methyl-6-t-butylphenol),
1,1,3-tris-(2-methyl-4-hydroxy-5-t-butylphenyl)butane,
1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester and tocopherol;

### Paraphenylene Diamines:

N-phenyl-N′-isopropyl-p-phenylene diamine, N,N′
-di-(sec-butyl)-p-phenylene diamine,
N-phenyl-N-sec-butyl-p-phenylene diamine, N,N′-di-isopropyl-p-phenylene diamine, and N,N′-dimethyl-N,N′-di-t-butyl-p-phenylene diamine;

### Hydroquinones:

2,5-di-t-octyl hydroquinone, 2,6-didodecyl hydroquinone, 2-dodecyl hydroquinone, 2-dodecyl-5-chloro hydroquinone, 2-t-octyl-5-methyl hydroquinone, and 2-(2-octadecenyl)-5-methyl hydroquinone;

### Organic Sulfur Compounds:

dilauryl-3,3-thiodipropionate, distearyl-3,3′-thiodipropionate, and ditetradecyl-3,3′-thiodipropionate; and

### Organic Phosphorous Compound:

triphenyl phosphine, tri(nonylphenyl)phosphine, tri(dinonylphenyl)phosphine, tricresyl phosphine, and tri-2,4-dibutylphenoxy)phosphine.

These compounds are known as anti-oxidants for rubber, plastic, oils and products thereof are easily available in the market.

The addition amount of the anti-oxidizing agent in the present invention is from 0.01 to 10% by weight based on the total weight of the layer to which the anti-oxidization is added.

### Image Formation Method and Device

Next, the image formation method and the image forming apparatus of the present invention are described in detail with reference to the accompanying drawings.

The image forming method and the image forming apparatus of the present invention perform image forming processes of, for example, charging the photoreceptor, irradiating the photoreceptor to form a latent electrostatic image thereon, developing the latent electrostatic image with toner, transferring the toner image to an image bearing body (transfer medium), fixing the image and cleaning the surface of the photoreceptor. The method in which a latent electrostatic image is directly transferred to a transfer medium followed by the development thereof does not necessarily have the processes mentioned above relating to the photoreceptor.

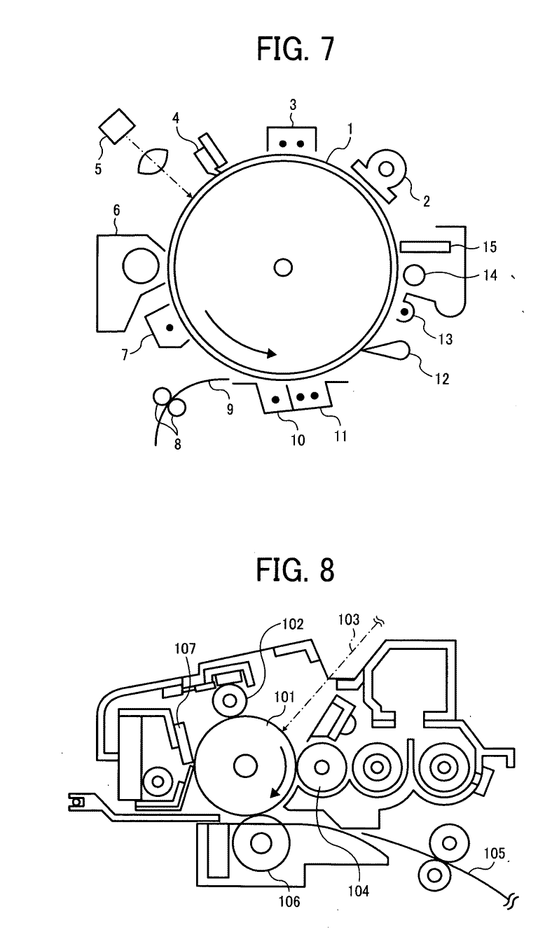

FIG. 7 is a schematic diagram illustrating an example of the photoreceptor. A charging device 3 is used as the charging device to uniformly charge the photoreceptor 1. Also, known charging devices, for example, a corotron device, a scorotron device, a solid discharging element, a needle electrode device, a roller charging device and an electroconductive brush device, can be used.

The structure in the present invention is particularly effective in the case of a charging system located in contact with a photoreceptor or in the vicinity thereof in which a charging device decomposes the composition of the photoreceptor by close discharging. The charging system provided in contact with a photoreceptor represents a charging system in which a charging roller, a charging brush, a charging blade, etc. are directly in contact with a photoreceptor. The charging system provided in the vicinity of a photoreceptor is a system in which, for example, a charging roller is provided not in contact with but in the vicinity of a photoreceptor with a gap of 200 μm or less between the surface of the photoreceptor and the charging roller. When this gap is too large, charging tends to be unstable. When this gap is too small and there is toner remaining on the surface of the photoreceptor, the surface of the charging member may be contaminated by the remaining toner. Therefore, the gap is from 10 to 200 μm and preferably from 10 to 100 μm.

Next, an image irradiation portion 5 is used to form a latent electrostatic image on the photoreceptor 1 which is uniformly charged. As the light source, typical luminescent materials, for example, a fluorescent lamp, a tungsten lamp, a halogen lamp, a mercury lamp, a sodium lamp, a luminescent diode (LED), a semi-conductor laser (LD) and electroluminescence (EL) can be used. Various kinds of filters, for example, a sharp cut filter, a band pass filter, an infrared cut filter, a dichroic filter, a coherency filter and a color conversion filter can be used to irradiate the photoreceptor 1 with light having only a desired wavelength.

Next, to visualize a latent electrostatic image formed on the photoreceptor 1, a developing unit 6 is used. As the developing method, there are a single component development method and a two component development method which use a dry toner and a wet development method which uses a wet toner. When the photoreceptor 1 is positively (negatively) charged and image irradiation is performed, a positive (negative) latent electrostatic image is formed on the surface of the photoreceptor 1. When this positive (negative) latent electrostatic image is developed with a toner (electric detecting particulates) having a negative (positive) polarity, a positive image is obtained. When the image is developed with a toner having a positive (negative) polarity, a negative image is obtained.

Next, a transfer charging device 10 is used to transfer the visualized toner image on the photoreceptor 1 to a transfer medium 9. In addition, to perform a good transferring, a charging device 7 can be used prior to transferring. As these transfer devices, an electrostatic transfer system using a transfer charging device or a bias roller, a mechanical transfer system using an adhesive transfer method or a pressure transfer method, and a magnetic transfer system can be used. As the electrostatic transfer system, the same device as the charging device mentioned above can be used.

Next, as a device to separate the transfer medium 9 from the photoreceptor 1, a separation charging device 11 and a separation claw 12 are used. As other separating devices, electrostatic absorption guiding separation, side end belt separation, front end grip transfer, curvature separation, etc. can be used. As the separation charging device 11, the same device as the charging device mentioned above can be used.

Next, after transferring, to remove the toner remaining on the photoreceptor 1, a fur brush 14 and a cleaning blade 15 are used. In addition, to effectively perform cleaning, a charging device 13 can be used prior to cleaning. Other cleaning devices, for example, a web-system device and a magnet brush system device can be also used. These cleaning devices can be used alone or in combination.

Next, if desired, a discharging device is used to remove the latent electrostatic image on the photoreceptor 1. A discharging lamp 2 and a discharging charger can be used as the discharging device. The same devices as the irradiation light sources and the charging devices can be used therefor. As apparent from the description so far, the photoreceptor of the present invention can be applied not only to electrophotography photocopiers, but also to wide varieties of devices in the application field of the electrophotography such as laser beam printers, CRT printers, LED printers and liquid crystal printers.

In addition to those mentioned above, known devices can be used in the processes of scanning originals, paper feeding, fixing images, discharging recording media, etc., which are performed not in the vicinity of the photoreceptor 1.

The image forming method and the image forming apparatus of the present invention use the photoreceptor of the present invention in the image formation device described above.

This image formation device can be fixedly implemented in a photocopier, a facsimile machine or a printer and also detachably incorporated therein as a form of a process cartridge. FIG. 8 is a diagram illustrating an example of the process cartridge.

A process cartridge for use in the image formation is a device (part) which includes an photoreceptor 101 and at least one of a charging device 102, an irradiation device 103, a development device 104, a transfer device 106, a cleaning device 107 and a discharging device (not shown) and detachably attachable to the main body of an image forming apparatus.

The image formation process by the process cartridge illustrated in FIG. 4 is: while the photoreceptor 101 is rotated in the direction indicated by an arrow, the photoreceptor 101 is charged with the charging device 102 and irradiated by an irradiating device 103 to form a latent electrostatic image corresponding to the irradiation image on the surface of the photoreceptor 101; the latent electrostatic image is developed with toner by the developing device 104; the toner image is transferred to a transfer medium 105 with the transfer device 106; the transferred image is then printed out; On the other hand, the surface of the photoreceptor 101 is cleaned after transfer by the cleaning device 107 and discharged by the discharging device (not shown); and all the operations mentioned above continue in a repeated manner.

According to the present invention, there is provided a process cartridge for use in image formation which integrally includes a photoreceptor having a smooth charge transport cross-linked surface layer and at least one of a charging device, a developing device, a transfer device, a cleaning device and a discharging device.

### Synthesis Example of Compound Having Charge Transport Structure

The compound having one functional group with a charge transport structure for use in the present invention can be synthesized by, for example, the method described in Japanese Patent No. 3164426. One example of the synthesizing method is described below.

(1) Synthesis of Hydroxy Group-Substituted Triarylamine Compound (represented by Chemical Structure B below)

240 ml of sulfolane is added to 113.85 g (0.3 mole) of a methoxy group-substituted triarylamine compound ((represented by the following chemical structure (A)), and 138 g (0.92 mole) of sodium iodide. The resultant is heated to 60° C. in nitrogen gas stream. 99 g (0.91 mole) of trimethyl chlorosilane is dropped to the resultant solution in one hour. Thereafter, the solution is stirred for 4.5 hours at around 60° C. and the reaction is terminated. To the reaction liquid, approximately 1,500 ml of toluene is added, and the reaction liquid is cooled down to the room temperature followed by repetitive washing with water and a sodium carbonate aqueous solution. Then, the solvent is removed from the toluene solution, and the solution is purified by column chromatography (absorption medium: silica gel; developing solvent: toluene:ethyl acetate=20:1). Cyclohexane is added to the obtained cream-colored oil to precipitate crystal. 88.1 g (yield constant: 80.4%) of white-color crystal represented by the following chemical structure (B) is thus obtained.

Melting point: 64.0° C. to 66.0° C.

Element analytical value: (%)

TABLE 1

| | C | H | N |
|---|---|---|---|
| Measured value | 85.06 | 6.41 | 3.73 |
| Calculated value | 85.44 | 6.34 | 3.83 |

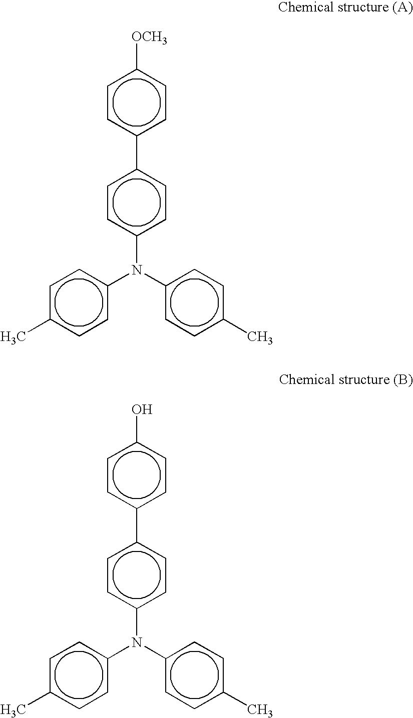

### (2) Synthesis of Triarylamine Group-Substituted Acrylate Compound (Illustrated Compound No. 54)

82.9 g (0.227 mole) of the hydroxy group-substituted triarylamine compound obtained in the (1) (Chemical structure (B)) is dissolved in 400 ml of tetrahydrofuran, and a sodium hydroxide solution (NaOH: 12.4 g, water: 100 ml) is dropped into the dissolved solution in nitrogen gas stream. The solution is cooled down to 5° C., and 25.2 g (0.272 mole) of acrylic acid chloride is dropped thereto in 40 minutes. Thereafter, the solution is stirred for 3 hours at 5° C., and the reaction is terminated. The reaction liquid is poured to water and extracted using toluene. The extract is repetitively washed with a sodium hydrogen carbonate aqueous solution and water. Thereafter, the solvent is removed from the toluene solution, and the solution is purified by column chromatography (absorption medium: silica gel; developing solvent: toluene). Then, n-hexane is added to the obtained colorless oil to precipitate crystal. 80.73 g (yield constant: 84.8%) of white-color crystal of Compound Example No. 54 illustrated above is obtained.

Melting point: 117.5° C. to 119.0° C.

Element analytical value: (%)

TABLE 2

| | C | H | N |
|---|---|---|---|
| Measured value | 83.13 | 6.01 | 3.16 |
| Calculated value | 83.02 | 6.00 | 3.33 |

### No. 54

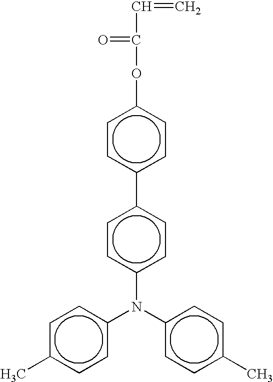

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

First, synthesis examples of titanyl phthalocyanine for use in the charge generation layer are described.

### Synthesis Example 1

Titanyl phthalocyanine crystal is synthesized according to Example 1 described in JOP 2001-19871. 292 parts of 1,3-diamino isoindoline, and 1,800 parts of sulfolane are mixed and 204 parts of titanium tetrabuthoxide is dripped to the mixture in nitrogen atmosphere. After dripping, the system is gradually heated to 180° C. and stirred for 5 hours to conduct reaction while maintaining the reaction temperature between 170 to 180° C. After the reaction, precipitated material obtained after cooling down is filtered and the resultant is washed with chloroform until the powder is blue. Then, the blue powder is washed with methanol several times followed by washing with hot water at 80° C. several times. Subsequent to drying, coarse titanyl phthalocyanine is obtained. 60 parts of the obtained coarse titanyl phthalocyanine pigment finished with hot water washing treatment is dissolved in 1,000 parts of 96% sulfuric acid at 3 to 5° C. while stirring followed by filtration. The obtained sulfuric solution is dripped to 3,500 parts of iced water while stirring to precipitate crystal. The precipitated crystal is filtered followed by water-washing until the washing water is neutralized to obtain water paste of titanyl phthalocyanine pigment. 1,500 parts of tetrahydrofuran is added to the water paste and the resultant is violently stirred (2,000 rpm) at room temperature by a HOMOMIXER (MARK II fModel, manufactured by Kenis Ltd.) and when the navy blue color of the paste is changed to pale blue (20 minutes after stirring starts), stirring is stopped followed by filtration with a reduced pressure immediately. The crystal obtained in the filtration device is washed with tetrahydrofuran and thus 98 parts of wet cake of pigment is obtained. The wet cake is dried under a reduced pressure (5 mmHg) at 70° C. for 2 days and thereafter 78 parts of titanylphthalocyanine is obtained. The obtained titanyl phthalocyanine powder has an X-ray (Cu—Kα: wavelength of 1.542 Å) diffraction spectrum under the following conditions such that the main peak is observed at a Bragg (2θ) angle of 27.2±0.2° and a peak at the minimum angle of 7.3±0.2° with no peak between 7.3° and 9.4° and no peak at 26.3°.

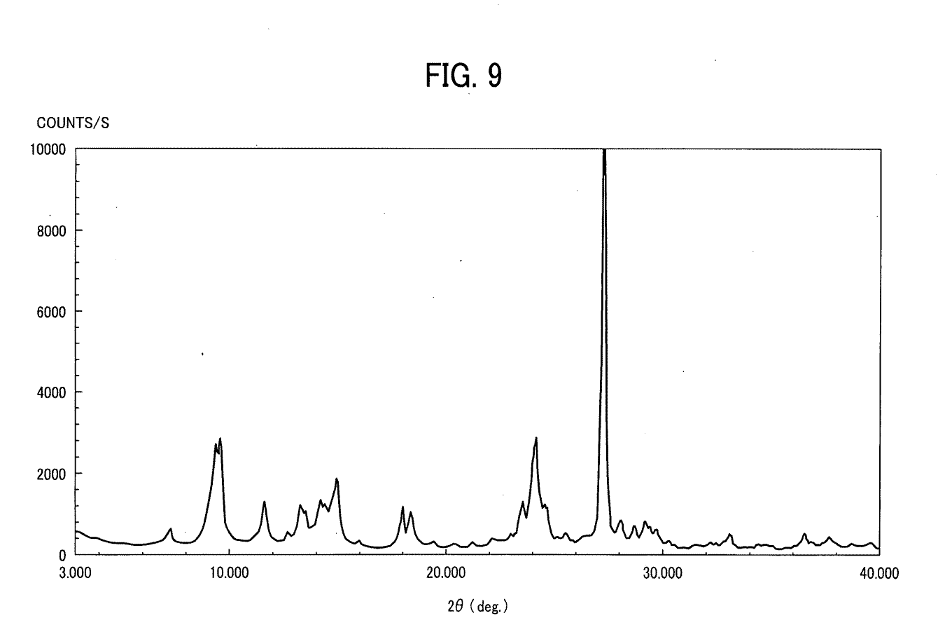

The result is shown in FIG. 9.

### X Ray Diffraction Spectrum Measuring Condition

X ray tube: Cu

### Voltage: 50 Kv

### Current: 30 mA

Scanning speed: 2°/min
Scanning range: 3° to 4°
Time constant: 2 seconds

Methods of manufacturing photoreceptors are specifically described below.

### (1) Manufacturing Example of Photoreceptor

### Preparation of Liquid Application for Charge Blocking Layer

| | |
|---|---|
| Binder resin: N-methoxymethylated nylon (FINE RESIN | 4 parts |
| FR-101, manufactured by Namariichi Co., Ltd.) | |
| Solvent: Methanol | 70 parts |
| Solvent: n-butanol | 30 parts |

The prescription specified above is uniformly dissolved and dispersed to obtain a liquid application for charge blocking layer.

### Preparation of Liquid Application 1 for Undercoating Layer

| | |
|---|---|
| Binder resin (basic resin): Alkyd resin (Beckolite, | 6 parts |
| M-6401-50, manufactured by DIC corporation) | |
| Binder resin (Cross-linking agent): Melamine resin | 4 parts |
| (SUPER BECKAMINE G-821-60, manufactured by DIC | |
| corporation) | |
| Particulate: hydrophilic titanium oxide (CR-EL, | 40 parts |
| average particle diameter: 0.25 μm, manufactured | |
| by Ishihara Sangyo Kaisha) | |
| Additive: Epoxyalkane-based compound: ADEKA | 0.25 parts |
| EPOXIDE 12 (number of carbon atoms in the straight | |
| alkyl chain: 10, Manufactured by Adeka Corporation) | |
| Solvent: 2-butanone | 50 parts |

Zirconia beads having a diameter of 2 mm are placed in the solvent specified above and the solution is stirred at room temperature at 1,500 rpm for 60 minutes by a shaker having a continuous rotation type horizontal system (IKA-VIBRAX VXR basic, manufactured by IKA Japan) to obtain a liquid application 1 for undercoating layer having a 4.37 μm meshpath.

### Preparation of Liquid Application for Charge Generation Layer

| | |
|---|---|
| Charge generation material: oxotitanium phthalocyanine | 15 parts |
| manufactured in Synthsis Example 1 which has an X-ray | |
| diffraction spectrum illustrated in FIG. 9 | |
| Binder Resin: Polyvinyl butyral resin (S-LEC BX-1, | 10 parts |
| manufactured by Sekisui Chemical Co., Ltd.) | |
| Solvent: 2-butanone | 280 parts |

PSZ beads having a diameter of 0.5 mm are placed in the solvent specified above and the solution is stirred at room temperature at 1,200 rpm for 30 minutes by a bead mill in the market to obtain a liquid application for charge generation layer having a 4.37 μm meshpath.

### Preparation of Liquid Application for Charge Transport Layer

| | |
|---|---|
| Charge transport material: triphenyl amine based compound | 7 parts |
| represented by the following chemical formula (C): | |

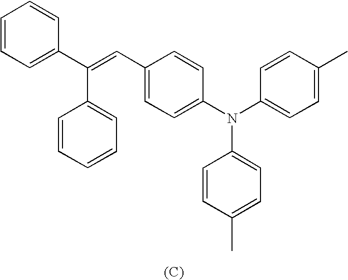

| | |
|---|---|
| Binder resin: polycarbonate resin (PANLITE TS-2050, | 10 parts |
| manufactured by Teijin Chemicals Ltd.) | |
| Leveling agent: Reactive silicone oil (1% by weight solution | 0.2 parts |
| of tetrahydrofuran, (KF50-100CS, manufactured by Shin-Etsu | |
| chemical Co., Ltd.) | |
| Solvent: tetrahydrofuran | 80 parts |

The prescription specified above is uniformly dissolved and dispersed to obtain a liquid application for charge transport layer.

### Preparation of Liquid Application for Protective Layer of Particulate Dispersion Type

| | |
|---|---|
| Charge Transport Material: triphenyl amine based | 3 parts |
| compound represented by the Chemical formula (C) | |
| illustrated above: | |
| Binder resin: Polycarbonate resin (Panlite TS-2050, | 4 parts |
| manufactured by Teijin Chemical Co., Ltd.) | |
| Particulate: Aluminum oxide (SUMICORUNDUM | 0.7 parts |
| AA-3, specific resistance: at least 10¹⁰ Ω cm, | |
| manufactured by Sumitomo Chemical Co., Ltd.) | |
| Solvent: tetrahydrofuran | 280 parts |
| Solvent: cyclohexanone | 80 parts |

The prescription specified above is uniformly dissolved and dispersed to obtain a liquid application for protective layer of particulate dispersion type.

### Preparation of Liquid Application for Cross-Linked Protective Layer

| | |
|---|---|
| Radical polyemrizable compound having three or | 5 parts |
| functional groups with no charge transport structure: | |
| trimethyl propane triacrylate (KAYARAD TMPTA, | |
| molecular weight: 296, number of functional groups: 3, | |
| molecular weight/number of functional groups: 99, | |
| manufactured by Nippon Kayaku Co., Ltd.) | |
| Radical polyemrizable compound having three or functional | 5 parts |
| groups with no charge transport structure: caprolactone | |
| modified dipenta erythritol hexa acrylate, (KAYARAD | |
| DACA-120, molecular weight: 1947, number of functional | |
| groups: 6, molecular weight/number of functional groups = | |
| 325, manufactured by Nippon Kayaku Co., Ltd.) | |
| Radical polymerizable compound having a charge transport | 10 parts |
| structure: Illustrated compound NO. 54 | |
| Optical polymerization initiator: | 1 part |
| 1-hydroxy-cyclohexyl-phenyl-ketone (IRGACURE 184, | |
| manufactured by Chiba Specialty Chemicals)] | |
| Leveling agent: Reactive silicone compound | 0.02 parts |
| (BYK-UV3570, manufactured by BYK-Chemie Japan.) | |
| Solvent: tetrahydrofuran | 120 parts |

The prescription specified above is uniformly dissolved and dispersed to obtain a liquid application for cross-linked protective layer.

### Manufacturing Example 1 of Photoreceptor

An aluminum cylinder having a diameter of 30 mm and a length of 340 mm is used as the substrate. The liquid application 1 for undercoating layer, the liquid application for charge generation layer, and the liquid application for charge transport layer are sequentially applied to the substrate by an dip (immersion) method and then dried. Furthermore, the liquid application for protective layer of particulate dispersion type is applied by spraying under the following conditions followed by ultraviolet curing to obtain Photoreceptor 1. First layer (undercoating layer): the liquid application 1 for undercoating layer in which the powder of titanium oxide is dispersed in the alkyd resin and the melamine resin as the main component: layer thickness: 3.5 μm

Second layer (charge generation layer): the liquid application 1 for charge generation layer in which the oxotitanium phthalocyanine pigment having an absorption peak at 780 nm of wavelength light is dispersed in the polyvinyl butyral resin as the main component: layer thickness 0.2 μm.
Third layer (charge transport layer): the liquid application 1 for charge transport layer in which the triphenyl amine compound having a positive hole transport property is dissolved in the polycarbonate resin with a weight ratio of 7:10 as the main component: layer thickness: 27 μm.
Fourth layer (protective layer): the liquid application 1 for cross-linked protective layer in which the radical polymerizable compound having a charge transport structure is dissolved in the radical polymerizable compound having three or functional groups with no charge transport structure with a weight ratio of 10:10 as the main component: layer thickness: 5 μm.

### Spray Coating Condition

Amount of discharging liquid application: 10 mL/min
Pressure of discharging liquid application: 3.0 kgf/cm²
Number of rotation of material to which liquid application is applied: 168 rpm
Coating speed: 10.7 mm/s
Distance between spray gunhead and material to which liquid application is applied: 50 mm
Number of coating: 1 time

### Ultraviolet Curing Condition

Light source: metal halide lamp
Light source power: 160 W/cm 100%
Distance between light source and material to which liquid application is applied: 110 mm
Number of rotation of material to which liquid application is applied: 25 rpm
Irradiation time: 240 seconds
Temperature control on material to which liquid application is applied: 30° C.

### Manufacturing Example 2 of Photoreceptor

Photoreceptor 2 is manufactured in the same manner as in manufacturing of Photoreceptor 1 except that 1,2-epoxyoctane (Product number: 26,025-8, number of carbon atoms in straight alkyl chain: 6, manufactured by Sigma Aldrich Japan K.K.) is used as the epoxyalkane based compound in Liquid application for undercoating layer 2 instead of Liquid application for undercoating layer 1.

### Manufacturing Example 3 of Photoreceptor

Photoreceptor 3 is manufactured in the same manner as in Photoreceptor 1 except that 1,2-epoxydecane (Product number: 26,033-9, number of carbon atoms in straight alkyl chain: 8, manufactured by Sigma Aldrich Japan K.K.) is used as the epoxyalkane based compound in Liquid application for undercoating layer 3 instead of Liquid application for undercoating layer 1.

### Manufacturing Example 4 of Photoreceptor

Photoreceptor 4 is manufactured in the same manner as in Photoreceptor 1 except that 1,2-epoxytetradecane (Product number: 26,026-6, number of carbon atoms in straight alkyl chain: 12, manufactured by Sigma Aldrich Japan K.K.) is used as the epoxyalkane based compound in Liquid application for undercoating layer 4 instead of Liquid application for undercoating layer 1.

### Manufacturing Example 5 of Photoreceptor

Photoreceptor 5 is manufactured in the same manner as in Photoreceptor 1 except that 1,2-epoxyhexadecane (Product number: 26,021-5, number of carbon atoms in straight alkyl chain: 14, manufactured by Sigma Aldrich Japan K.K.) is used as the epoxyalkane based compound in Liquid application for undercoating layer 5 instead of Liquid application for undercoating layer 1.

### Manufacturing Example 2 of Photoreceptor

Photoreceptor 6 is manufactured in the same manner as in Photoreceptor 1 except that ADEKA EPOXIDE 18 (number of carbon atoms in the straight alkyl chain: 10, manufactured by Adeka Corporation) is used as the epoxyalkane based compound in Liquid application for undercoating layer 6 instead of Liquid application for undercoating layer 1.

### Manufacturing Example 7 of Photoreceptor

Photoreceptor 7 is manufactured in the same manner as in Photoreceptor 1 except that 1,2-epoxyeicosa (Product code: E0311, number of carbon atoms in straight alkyl chain: 18, manufactured by Tokyo kasei kogyo Co., Ltd.) is used as the epoxyalkane based compound in Liquid application for undercoating layer 7 instead of Liquid application for undercoating layer 1.

### Manufacturing Example 8 of Photoreceptor

Photoreceptor 8 is manufactured in the same manner as in Photoreceptor 1 except that 1,2-epoxyhexane (Product number: 37, 717-1, number of carbon atoms in straight alkyl chain: 4, manufactured by Sigma Aldrich Japan K.K.) is used as the epoxyalkane based compound in Liquid application for undercoating layer 8 instead of Liquid application for undercoating layer 1.

### Manufacturing Example 9 of Photoreceptor

Photoreceptor 9 is manufactured in the same manner as in Photoreceptor 1 except that 1,2-epoxyheptane (Product code: E0312, number of carbon atoms in straight alkyl chain: 5, manufactured by Tokyo kasei kogyo Co., Ltd.) is used as the epoxyalkane based compound in Liquid application for undercoating layer 9 instead of Liquid application for undercoating layer 1.

### Manufacturing Example 10 of Photoreceptor

Photoreceptor 10 is manufactured in the same manner as in Photoreceptor 1 except for using Liquid application 10 for undercoating layer having the following recipe.

The layer thickness of the obtained undercoating layer is 3.5 μm.

| | |
|---|---|
| Binder resin (basic resin): Alkyd resin (Beckolite, | 6 parts |
| M-6401-50, manufactured by DIC corporation) | |
| Binder resin (Cross-linking agent): Melamine resin (SUPER | 4 parts |
| BECKAMINE G-821-60, manufactured by DIC corporation) | |
| Particulate: hydrophilic titanium oxide (CR-EL, average | 40 parts |
| particle diameter: 0.25 μm, manufactured by Ishihara | |
| Sangyo Kaisha) | |
| Solvent: 2-butanone | 50 parts |

Zirconia beads having a diameter of 2 mm are placed in the solvent specified above and the solution is stirred at room temperature at 1,500 rpm for 60 minutes by a shaker having a continuous rotation type horizontal system (IKA-VIBRAX VXR basic, manufactured by IKA Japan) to obtain a liquid application for undercoating layer having a 4.37 μm meshpath.

### Manufacturing Example 11 of Photoreceptor

Photoreceptor 11 is manufactured in the same manner as in Manufacturing Example 1 of Photoreceptor except that the liquid application prepared in Preparation of Liquid Application for Charge Blocking Layer is used to provide a charge blocking layer between the electroconductive substrate and the undercoating layer.

The layer thickness of the obtained undercoating layer is 0.75 μm.

### Manufacturing Example 12 of Photoreceptor

Photoreceptor 12 is manufactured in the same manner as in Manufacturing Example 1 of Photoreceptor except that Preparation of Liquid Application for Protective Layer of Particulate Dispersion Type is used as the recipe and the liquid application for protective layer is applied and cured under the following condition.

The layer thickness of the obtained undercoating layer is 5 μm.

### Spray Coating Condition

Amount of discharging liquid application: 15 mL/minute
Pressure of discharging liquid application: 2.0 kgf/cm²
Number of rotation of material to which liquid application is applied: 120 rpm
Coating speed: 7.14 mm/s
Distance between spray gunhead and material to which liquid
application is applied: 50 mm
Number of coating: 2 times

### Thermal Curing Condition

Atmosphere temperature: 150° C.
Curing time: 20 minutes

### Manufacturing Example 13 of Photoreceptor

Photoreceptor 13 is manufactured in the same manner as in Manufacturing Example 12 of Photoreceptor except that Liquid application 2 for undercoating layer prepared in Manufacturing Example 2 of photoreceptor is used as the recipe for liquid application for undercoating layer.

### Manufacturing Example 14 of Photoreceptor

Photoreceptor 14 is manufactured in the same manner as in Manufacturing Example 12 of Photoreceptor except that Liquid application 3 for undercoating layer prepared in Manufacturing Example 3 of photoreceptor is used as the recipe for liquid application for undercoating layer.

### Manufacturing Example 15 of Photoreceptor

Photoreceptor 15 is manufactured in the same manner as in Manufacturing Example 12 of Photoreceptor except that Liquid application 4 for undercoating layer prepared in Manufacturing Example 4 of photoreceptor is used as the recipe for liquid application for undercoating layer.

### Manufacturing Example 16 of Photoreceptor

Photoreceptor 16 is manufactured in the same manner as in Manufacturing Example 12 of Photoreceptor except that Liquid application 5 for undercoating layer prepared in Manufacturing Example 5 of photoreceptor is used as the recipe for liquid application for undercoating layer.

### Manufacturing Example 17 of Photoreceptor

Photoreceptor 17 is manufactured in the same manner as in Manufacturing Example 12 of Photoreceptor except that Liquid application 6 for undercoating layer prepared in Manufacturing Example 6 of photoreceptor is used as the recipe for liquid application for undercoating layer.

### Manufacturing Example 18 of Photoreceptor

Photoreceptor 18 is manufactured in the same manner as in Manufacturing Example 12 of Photoreceptor except that Liquid application 7 for undercoating layer prepared in Manufacturing Example 7 of photoreceptor is used as the recipe for liquid application for undercoating layer.

### Manufacturing Example 19 of Photoreceptor

Photoreceptor 19 is manufactured in the same manner as in Manufacturing Example 12 of Photoreceptor except that Liquid application 8 for undercoating layer prepared in Manufacturing Example 8 of photoreceptor is used as the recipe for liquid application for undercoating layer.

### Manufacturing Example 20 of Photoreceptor

Photoreceptor 20 is manufactured in the same manner as in Manufacturing Example 12 of Photoreceptor except that Liquid application 9 for undercoating layer prepared in Manufacturing Example 9 of photoreceptor is used as the recipe for liquid application for undercoating layer.

### Manufacturing Example 21 of Photoreceptor

Photoreceptor 21 is manufactured in the same manner as in Manufacturing Example 12 of Photoreceptor except that Liquid application 10 for undercoating layer prepared in Manufacturing Example 10 to photoreceptor is used as the recipe for liquid application for undercoating layer.

### Manufacturing Example 22 of Photoreceptor

Photoreceptor 22 is manufactured in the same manner as in Manufacturing Example 12 of Photoreceptor except that the liquid application prepared in Preparation of Liquid Application for Charge Blocking Layer is used to provide a charge blocking layer between the electroconductive substrate and the undercoating layer.

The layer thickness of the obtained undercoating layer is 0.75 μm.

### (2) EXAMPLES AND COMPARATIVE EXAMPLES

The effect of the present invention is demonstrated by comparing Examples with Comparative Examples.

### Example 1

Photoreceptor 1 manufactured as described above is installed in a photocopier (Imagio Neo 271, manufactured by Ricoh Co., Ltd.) and a paper running durability test is performed under the environment of 23° C. and 55% RH. Initial image, 250,000th image, 290,000th image, 310,000th image and 330,000th image are evaluated after the durability test. The detail of the evaluation is as follows. The charging voltage of the photoreceptor is −900 V at dark portions. 330,000 images are printed on A4 paper in full color with a character image print ratio of 6%. After the initial image, 250,000th image, 290,000th image, 310,000th image and 330,000th image are printed, three solid white images and three solid black images are printed for comparison samples.

### 1) Background Fouling

Background fouling on the white solid images is evaluated after the initial image, 250,000th image, 290,000th image, 310,000th image and 330,000th image are printed. Background fouling is observed from the third sample white solid image with naked eyes for evaluation according to the following levels. Images of Levels A to C have no problem with regard to image quality.

A: No background fouling observed
B: Background fouling extremely slightly observed
C: Background fouling slightly observed
D: Background fouling clearly observed
E: Background fouling densely observed
F: Background fouling extremely densely observed

The evaluation results are shown in Table 3.

### 2) Voltage at Light Portions

The surface voltage of the photoreceptor corresponding to the third sample black solid image voltage is used to represent the voltage at light portions.

The results are shown in Table 4.

### Examples 2 to 9, 10 to 19 and 20

Examples 2 to 9, 10 to 19 and 20 are performed and evaluated in the same manner as in Example 1 except that the photoreceptors 2 to 9, 11 to 20 and 22 are used in Examples 2 to 9, 10 to 19 and 20, respectively.

### Comparative Example 1 and 2

Comparative Examples 1 and 2 are performed and evaluated in the same manner as in Example 1 except that the photoreceptors 10 and 21 are used in Comparative Examples 1 and 2, respectively.

TABLE 3

| | Background fouling | | | | |
|---|---|---|---|---|---|
| | Initial | 250,000th | 290,000th | 310,000th | 330,000th |
| Example 1 | A | A | A | A | B |
| Example 2 | A | A | A | A | B |
| Example 3 | A | A | A | A | B |
| Example 4 | A | A | A | A | B |
| Example 5 | A | A | A | A | B |
| Example 6 | A | A | A | B | C |
| Example 7 | A | A | A | B | C |
| Example 8 | A | A | A | B | C |
| Example 9 | A | A | A | B | C |
| Example 10 | A | A | A | A | A |
| Example 11 | A | A | A | A | B |
| Example 12 | A | A | A | A | B |
| Example 13 | A | A | A | A | B |
| Example 14 | A | A | A | A | B |
| Example 15 | A | A | A | A | B |
| Example 16 | A | A | A | B | C |
| Example 17 | A | A | A | B | C |
| Example 18 | A | A | A | B | C |
| Example 19 | A | A | A | B | C |
| Example 20 | A | A | A | A | A |
| Comparative | A | A | B | D | F |
| Example 1 | | | | | |
| Comparative | A | A | B | D | F |
| Example 2 | | | | | |

TABLE 4

| | Voltage at light portion/−V | | | | |
|---|---|---|---|---|---|
| | Initial | 250,000th | 290,000th | 310,000th | 330,000th |
| Example 1 | 135 | 139 | 153 | 169 | 185 |
| Example 2 | 125 | 137 | 154 | 167 | 184 |
| Example 3 | 130 | 136 | 151 | 168 | 183 |
| Example 4 | 135 | 138 | 151 | 166 | 186 |
| Example 5 | 140 | 135 | 154 | 167 | 183 |
| Example 6 | 140 | 148 | 165 | 178 | 196 |
| Example 7 | 145 | 147 | 168 | 181 | 194 |
| Example 8 | 144 | 151 | 165 | 183 | 195 |
| Example 9 | 145 | 153 | 167 | 181 | 193 |
| Example 10 | 130 | 131 | 143 | 157 | 173 |
| Example 11 | 140 | 139 | 153 | 169 | 185 |
| Example 12 | 145 | 137 | 154 | 167 | 184 |
| Example 13 | 135 | 136 | 151 | 168 | 183 |
| Example 14 | 135 | 138 | 151 | 166 | 186 |
| Example 15 | 140 | 135 | 154 | 167 | 183 |
| Example 16 | 145 | 148 | 165 | 178 | 196 |
| Example 17 | 145 | 147 | 168 | 181 | 194 |
| Example 18 | 155 | 151 | 165 | 183 | 195 |
| Example 19 | 150 | 153 | 167 | 181 | 193 |
| Example 20 | 130 | 131 | 143 | 157 | 173 |
| Comparative | 145 | 173 | 184 | 197 | 225 |
| Example 1 | | | | | |
| Comparative | 150 | 175 | 187 | 199 | 230 |
| Example 2 | | | | | |

In Examples, occurrence of background fouling is reduced by causing the undercoating layer to contain a compound having an epoxy resin and straight chain alkyl skeleton for an extended period of time and thus quality images are obtained with a thick density.

### Examples 2 to 5 and 11 to 15

Results of Examples 2 to 5 and 11 to 15 are evaluated in the same manner as in Example 1 except that the photoreceptors 2 to 5 and 12 to 16 are used for Examples 2 to 5 and 11 to 15, respectively. As seen in Table 3, quality images having no or slight background fouling are obtained. As seen in Table 4, Examples 2 to 5 and 11 to 15 have no problem with regard to the voltage at light portions.

### Examples 6 to 9 and 16 to 19

Results of Examples 6 to 9 and 16 to 19 are evaluated in the same manner as in Example 1 except that the photoreceptors 6 to 9 and 17 to 20 are used for Examples 6 to 9 and 16 to 19, respectively. As seen in Tables 3 and 4, the results are slightly inferior to those for Examples 1 to 5 and 11 to 15 having a straight chain alkyl skeleton having 6 to 15 carbon atoms but generally good.

### Comparative Examples 1 and 2

Results of Comparative Examples 1 and 2 are evaluated in the same manner as in Example 1 except that the photoreceptors 10 and 21 are used for Comparative Examples 1 and 2, respectively. As seen in Tables 3 and 4, good results are not obtained because the particular epoxyalkane compounds for use in the present invention are not used.

### Examples 10 and 20

Results of Examples 10 and 20 are evaluated in the same manner as in Example 1 except that the photoreceptors 11 and 22 are used for Examples 10 and 20, respectively. As seen in Tables 3 and 4, quality images having slight background fouling are obtained with no problem with regard to the voltage at light portions.

This document claims priority and contains subject matter related to Japanese Patent Application No. 2008-067930, filed on Mar. 17, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A photoreceptor comprising:
an electroconductive substrate;
an undercoating layer provided overlying the electroconductive substrate that comprises a compound comprising an epoxy group and a straight chain alkyl skeleton, a cross-linked resin, and a hydrophilic particulate; and
a photosensitive layer provided overlying the undercoating layer.

2. The photoreceptor according to claim 1, wherein the compound comprising an epoxy group and a straight chain alkyl skeleton is represented by the following Chemical structure 1: 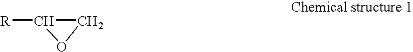
wherein R represents a straight chain alkyl skeleton.

3. The photoreceptor according to claim 2, wherein R in the Chemical structure 1 has 6 to 15 carbon atoms.

4. The photoreceptor according to claim 1, wherein the cross-linked resin is formed by curing at least one of a water soluble resin, an alcohol soluble resin and a curable resin capable of forming a three dimensional network structure.

5. The photoreceptor according to claim 4, wherein the curable resin capable of forming a three dimensional network structure is at least one of an alkyd resin and a melamine resin.

6. The photoreceptor according to claim 1, wherein the hydrophilic particulate is a first inorganic particulate.

7. The photoreceptor according to claim 6, wherein the first inorganic particulate is at least one compound selected from the group consisting of zinc oxide, tin oxide and titanium oxide.

8. The photoreceptor according to claim 1, wherein a charge blocking layer is provided between the electroconductive substrate and the undercoating layer.

9. The photoreceptor according to claim 8, wherein the charge blocking layer comprises N-alkoxymethylated nylon.

10. The photoreceptor according to claim 1, wherein a protective layer is provided on the photosensitive layer.

11. The photoreceptor according to claim 10, wherein the protective layer comprises a second inorganic particulate.

12. The photoreceptor according to claim 11, wherein the second inorganic particulate is at least one compound selected from the group consisting of aluminum oxide, silicon oxide, and titanium oxide.

13. The photoreceptor according to claim 10, wherein the protective layer is a cross-linked protective layer formed by curing a radical polymerizable monomer having three or more functional groups with no charge transport structure and a radical polymerizable compound having a charge transport structure.

14. The photoreceptor according to claim 13, wherein the radical polymerizable monomer having three or more functional groups with no charge transport structure has at least one of an acryloyloxy group and a methacryloyloxy group.

15. The photoreceptor according to claim 13, wherein the radical polymerizable compound having a charge transport structure has an acryloyloxy group or a methacryloyloxy group.

16. The photoreceptor according to claim 13, wherein the radical polymerizable compound having a charge transport structure has a triarylamine structure.

17. The photoreceptor according to claim 13, wherein the radical polymerizable compound having a charge transport structure comprises a compound represented by the following Chemical structure 2 or a compound represented by the following Chemical structure 3: 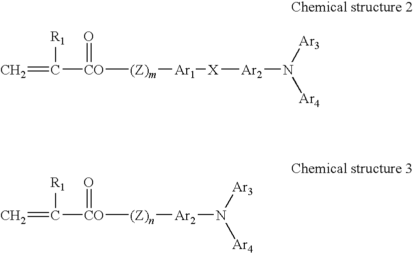
C1 where R₁ represents hydrogen atom, a halogen atom, an alkyl group, an aralkyl group, an aryl group, a cyano group, a nitro group, an alkoxy group, —COOR₇, wherein R₇ represents hydrogen atom, a substituted or non-substituted alkyl group, a substituted or non-substituted aralkyl group or a substituted or non-substituted aryl group, a halogenated carbonyl group or CONR₈R₉, wherein R₈ and R₉ independently represent hydrogen atom, a halogen atom, a substituted or non-substituted alkyl group, a substituted or non-substituted aralkyl group or a substituted or non-substituted aryl group, Ar₁ and Ar₂ independently represent a substituted or non-substituted arylene group, Ar₃ and Ar₄ independently represent a substituted or non-substituted aryl group, X represents a single bond or a substituted or non-substituted alkylene group, a substituted or non-substituted cycloalkylene group, a substituted or non-substituted alkylene ether group, oxygen atom, sulfur atom or vinylene group, Z represents a substituted or non-substituted alkylene group, a substituted or non-substituted alkylene ether divalent group or an alkyleneoxy carbonyl divalent group, and m and n represent 0 or an integer of from 1 to 3.

18. The photoreceptor according to claim 17, wherein the radical polymerizable compound having a charge transport structure comprises a compound represented by the following structure 4: 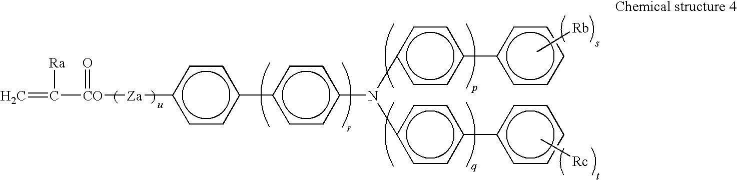
wherein, u, r, p, q independently represent 0 or 1, s and t independently represent 0 or an integer of from 1 to 3, Ra represents hydrogen atom or methyl group, each of Rb and Rc independently represents an alkyl group having 1 to 6 carbon atoms, and Za represents methylene group, ethylene group, —CH₂CH₂O—, —CHCH₃CH₂O—, or —C₆H₅CH₂CH₂—.

19. An image forming apparatus comprising:
the photoreceptor of claim 1;
a charging device configured to charge the photoreceptor;
an irradiation device configured to irradiate the photoreceptor with light to form a latent electrostatic image thereon;
a developing device configured to develop the latent electrostatic image with a developing agent to form a developed image; and
a transferring device configured to transfer the developed image to a recording medium.

20. A process cartridge detachably attachable to an image forming apparatus comprising:
the photoreceptor of claim 1, and
at least one device selected from the group consisting of a charging device, an irradiation device, a developing device, a cleaning device and a transfer device.
